(19) United States
(12) Patent Application Publication
(10) Pub. No.: US 2024/0185717 A1
(43) Pub. Date: Jun. 6, 2024

(54) DATA-DRIVEN AUTONOMOUS COMMUNICATION OPTIMIZATION SAFETY SYSTEMS, DEVICES, AND METHODS

(71) Applicant: Spoke Safety, LLC, Denver, CO (US)

(72) Inventors: Jarrett Wendt, Denver, CO (US); Robert Sigety, Milford, MI (US); Angelo Monteleone, Val della Torre (IT); Lutz Kucher, Grahovo (SI); Matthew Austin Maczuzak, Pine, CO (US); David Bartlett, Walnut Creek, CA (US); David Brodie, Penzberg (DE); Domenico Actis Grosso, Torrazza Piemonte (IT); Andrea Tomatis, Sant'Albano Stura (IT)

(21) Appl. No.: 18/555,086

(22) PCT Filed: Apr. 12, 2022
(86) PCT No.: PCT/US2022/024342

§ 371 Date: Oct. 12, 2023

Related U.S. Application Data
(60) Provisional application No. 63/173,593, filed on Apr. 12, 2021.
(60) Provisional application No. 63/296,620, filed on Jan. 5, 2022.

(51) Int. Cl. G08G 1/16; B62J 6/24; B62J 45/41; B62J 50/22; H04W 4/44

(52) U.S. Cl. CPC G08G 1/162; B62J 6/24; B62J 45/41; B62J 50/22; G08G 1/166; H04W 4/44

(57) ABSTRACT

The present disclosure relates to safety systems, devices, and methods. In one example, a safety system includes a safety device in communication with a server. The safety device includes a processing element and a connectivity module configured to receive object data from a connectivity device within a short-distance range. The processing element is configured to analyze the object data to determine one or more safety risks and to transmit one or more alerts or safe routes based on the one or more safety risks. The server is configured to receive entity data from the safety device, receive safety-related data from one or more data sources, compare the entity data to the safety-related data to determine relevant safety-related data, and transmit the relevant safety-related data to the safety device. The processing element is further configured to incorporate the relevant safety-related data into the determination of the one or more safety risks.

### CROSS REFERENCE TO RELATED APPLICATIONS

The present application claims the benefit of priority to U.S. Provisional Patent Application No. 63/173,593, entitled “Collision Prevention Systems, Devices, and Methods,” filed Apr. 12, 2021, and U.S. Provisional Patent Application No. 63/296,620, entitled “Data-Driven Autonomous Communication Optimization Safety Systems, Devices, and Methods,” filed Jan. 5, 2022, the entireties of both of which are hereby incorporated by reference herein for all purposes.

### TECHNICAL FIELD

The technology described herein relates generally to safety systems, devices, and methods, specifically integrating data-driven autonomous communication optimization for mobility, travel, and road user safety.

### BACKGROUND

Micromobility vehicles are becoming increasingly popular means of commuting, exercising, and touring. Micromobility vehicles are small, lightweight vehicles that operate at speeds typically below 15 mph, and include bicycles, scooters, skateboards, electric bikes (or Ebikes), electric scooters, electric skateboards, and the like. Such micromobility vehicles are often required to be driven on the road, which increases the likelihood of collision with automotive vehicles, such as cars, vans, trucks, buses, and the like.

Automotive vehicle crashes with micromobility vehicles are common and often result in fatalities. According to a report by the National Highway Traffic Safety Administration, there were 857 bicyclists killed in traffic crashes in the U.S. in 2018. There is currently no safe, effective, or comprehensive way for micromobility vehicle users to be alerted of approaching vehicles or effective way for vehicles to receive sufficient notice of approaching micromobility vehicles to avoid a collision.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes data-driven autonomous communication optimization safety systems, devices, and methods. Embodiments of the present disclosure may include a safety device for a micromobility vehicle. The safety device may include a housing configured to couple to the micromobility vehicle, a connectivity module positioned within the housing, and a processing element positioned within the housing and in communication with the connectivity module. The connectivity module may include a first connectivity device configured to receive first entity data from one or more first entities, the one or more first entities including one or more first compatible connectivity devices compatible with the first connectivity device, and to transmit outgoing entity data to the one or more first entities. The processing element may be configured to determine one or more locations of the one or more first entities relative to the micromobility vehicle and one or more first entity trajectories based on the received first entity data, determine whether one or more of the one or more first entity trajectories conflict with a trajectory of the micromobility vehicle based on the received first entity data and the outgoing entity data, and transmit an alert indicative of one or more first entity conflicts when the one or more first entity conflicts are determined.

Additionally or separately, the connectivity module may include a second connectivity device configured to receive second entity data from one or more second entities, the one or more second entities including one or more second compatible connectivity devices compatible with the second connectivity device, and to transmit the outgoing entity data to the one or more second entities. The processing element may be further configured to determine one or more locations of the one or more second entities relative to the micromobility vehicle and one or more second entity trajectories based on the received second entity data, determine whether one or more of the one or more second entity trajectories conflict with a trajectory of the micromobility vehicle based on the received second entity data and the outgoing entity data, and transmit an alert indicative of one or more second entity conflicts when the one or more second entity conflicts are determined.

Additionally or separately, the processing element may be in communication with a second connectivity device that is separate from the safety device, and the processing element may be configured to receive safety-related data from one or more disparate data sources via the second connectivity device. Additionally or separately, the second connectivity device may be a cellular modem. Additionally or separately, the one or more disparate data sources may include a cellular modem coupled to a second entity and the safety-related data may include second entity data related to the second entity.

Additionally or separately, the first connectivity device may be a V2X chipset or C-V2X modem. Additionally or separately, the first connectivity device may be a cellular modem. Additionally or separately, the second connectivity device may be a cellular modem.

Additionally or separately, the housing of the safety device may have a housing form factor that is compatible with a form factor of a component or system of the micromobility vehicle to couple to the component or system. Additionally or separately, the micromobility vehicle may be a bicycle. Additionally or separately, the component of the micromobility vehicle may be a seat post, a light, a down tube, or a handlebar. Additionally or separately, the housing form factor may be compatible with a form factor of a water bottle holder configured to couple to the micromobility vehicle. The water bottle holder may include a safety device compartment for receiving the safety device.

Additionally or separately, the safety device may include a display coupled to the housing and the processing element may be configured to transmit the alert to the display as a visual indicator of the one or more first entity conflicts. The safety device may also include a power source. The alert may override a third-party application interface displayed on the display. Additionally or separately, the alert may be illumination of a light that is in communication with the processing element and coupled to the micromobility vehicle. Additionally or separately, the housing may include a waterproof material.

Other examples or embodiments of the present disclosure may include a safety system including a user device, a safety device in communication with the user device and coupled to a micromobility vehicle, and a remote processing element in communication with the safety device and the user device. The safety device may include a connectivity module and a local processing element in communication with the connectivity module. The connectivity module may be configured to receive incoming entity data from an automotive vehicle or a second micromobility vehicle within a short-distance range, and transmit entity data of the micromobility vehicle to the automotive vehicle or the second micromobility vehicle. The local processing element may be configured to determine a safety risk based on the incoming entity data and the entity data of the micromobility vehicle, and transmit an alert to the user device when the safety risk is high. The remote processing element may be configured to receive entity data of the micromobility vehicle from the safety device, receive third-party entity data from one or more entities, compare the entity data of the micromobility vehicle to the third-party entity data to determine one or more nearby entities within a long-distance range of the micromobility vehicle, and transmit feedback to the user device indicative of a location of the one or more nearby entities relative to the micromobility vehicle.

Additionally or separately, the system may include one or more databases in communication with the remote processing element, wherein the local processing element is further configured to transmit real-time safety-related data to the remote processing element for storage in the one or more databases when the safety risk is high. The high safety risk may be a high collision probability that is indicative of an actual or near collision and the real-time safety-related data may include an actual or near collision location and time. Additionally or separately, the remote processing element may be configured to receive micromobility vehicle data and/or user data from an application on the user device and environmental data from a third-party database, and to aggregate the real-time collision data, micromobility vehicle data and/or user data, and environmental data into stored safety-related data. Additionally or separately, the remote processing element may be configured to determine one or more high safety risk areas based on real-time safety-related data stored over time, and to transmit feedback to the user device when the micromobility vehicle is within a proximity to the one or more high safety risk areas.

Additionally or separately, the system may include one or more other user devices in communication with the remote processing element, wherein the remote processing element is configured to transmit an alert to the one or more other user devices when the one or more other user devices are within the proximity to the one or more high safety risk areas. Additionally or separately, the remote processing element may be configured to calculate an alternate route based on an original route and the one or more high safety risk areas, and transmit the alternate route to the one or more other user devices.

Additionally or separately, the third-party entity data may be from one or more third-party applications of one or more other user devices in communication with the remote processing element, wherein the comparison of the entity data of the micromobility vehicle to the third-party entity data determines one or more other user devices within a long-distance range of the micromobility vehicle. Additionally or separately, the system may include one or more sensors coupled to the micromobility vehicle and in communication with the local processing element. The one or more sensors may be configured to detect one or more of objects, motion, acceleration, and deceleration. The local processing element may be configured to receive sensor data, wherein determining the safety risk may be further based on the sensor data. Additionally or separately, the one or more sensors may include a camera coupled to the micromobility vehicle. Additionally or separately, the safety system is functionally safe.

Additional examples or embodiments of the present disclosure may include a method of providing safety-related feedback for a network of interconnected entities. The method may include receiving, by a processing element, entity data from a plurality of entities. The plurality of entities may include one or more micromobility vehicles, one or more user devices, and one or more automotive vehicles, wherein the entity data from the one or more user devices may include third-party entity data from a third-party application installed on a user device of the one or more user devices that tracks a location of the user device. The method may further include aggregating, by the processing element, the entity data; comparing, by the processing element, a position of an entity of the plurality of entities to the aggregated entity data to determine a relative position of the entity relative to other entities of the plurality of entities; and transmitting, by the processing element, feedback to the entity related to the relative location. Additionally or separately, the third-party application may be a navigational, fitness, health, or training application.

Additional examples or embodiments of the present disclosure may include a method of leveraging comprehensive safety-related data from disparate data sources to enhance traveler safety. The method may include aggregating, by a processing element, safety-related data received from disparate data sources, and receiving, by the processing element, entity data from a user device or a safety device. The safety device may include a connectivity device configured to exchange entity data with one or more other connectivity devices within a short-distance range. The method may further include determining, by the processing element, relevant safety-related data based on the entity data received; analyzing, by the processing element, the relevant safety-related data to determine one or more safe actions or a safe route; and transmitting, by the processing element, the one or more safe actions or safe route to the user device or safety device.

Additionally or separately, analyzing the relevant safety-related data may include determining whether one or more safety risk factors are present, and determining the one or more safe actions or safe route based on the one or more safety risk factors. Additionally or separately, the disparate data sources may include one or more third-party databases storing data for fitness software or navigational software applications. Additionally or separately, the disparate data sources may include one or more safety devices coupled to one or more micromobility vehicles, wherein the one or more safety devices transmit data related to position and movement of the one or more micromobility vehicles. Additionally or separately, the safety device may be portable and the connectivity device may be a CV-2X modem.

Other examples or embodiments of the present disclosure may include a method of improving accuracy of safety-related output for traveler safety. The method may include receiving, by a local processing element, safety-related data; analyzing, by the local processing element, the safety-related data to determine one or more safety risk factors; receiving, by the local processing element, other safety-related data related to the safety-related data, wherein the other safety-related data is from one or more disparate data sources; comparing the safety-related data to the other safety-related data to determine accuracy of the locally determined one or more safety risk factors; and correcting errors in the locally determined one or more safety risk factors when the locally determined one or more safety risk factors are inaccurate.

Additionally or separately, analyzing the safety-related data may include determining one or more variables are present in the safety-related data, and determining the one or more safety risk factors based on prior learned associations between the presence of the one or more variables and the one or more safety risk factors, wherein when the locally determined one or more safety risk factors is inaccurate, adjusting the prior learned association to associate the presence of the one or more variables with the corrected one or more safety risk factors. Additionally or separately, the one or more disparate data sources may include a safety device comprising a C-V2X chip configured to transmit the other safety-related data to the local processing element, wherein the other safety-related data comprises entity data. Additionally or separately, the one or more disparate data sources may include one or more third-party databases storing data for fitness or navigational software applications.

Further examples or embodiments of the present disclosure may include a data-driven autonomous communication safety system. The system may include a safety device and a server in communication with the safety device. The safety device may include a connectivity module configured to receive object data from a connectivity device within a short-distance range, and a local processing element in communication with the connectivity module. The local processing element may be configured to analyze the object data to determine one or more safety risks and to transmit one or more alerts or one or more safe routes based on the one or more safety risks. The server may be configured to receive entity data from the safety device, receive safety-related data from one or more distinct data sources, compare the entity data to the safety-related data to determine relevant safety-related data, and transmit the relevant safety-related data to the safety device. The local processing element may be further configured to incorporate the relevant safety-related data into the determination of the one or more safety risks. Additionally or separately, the safety device may be coupled to a light mobility vehicle. Additionally or separately, the one or more distinct data sources may include one or more third-party fitness or navigational software applications. Additionally or separately, the safety-related data may include data related to one or more of weather, road conditions, environment, and traffic.

Additional examples or embodiments of the present disclosure may include a portable safety device. The portable safety device may include a housing defining a display configured to display safety-related information, a C-V2X modem positioned within the housing, and a local processor in communication with the C-V2X modem. The C-V2X modem may be configured to transmit and receive local entity data from one or more nearby entities, and the local processor may be configured to receive the local entity data and determine whether a nearby entity of the one or more nearby entities is a threat. Additionally or separately, a cellular modem may be in communication with the local processor and configured to receive safety-related data from a remote server and to transmit the safety-related data to the local processor. The local processor may be configured to determine whether another threat exists based on the safety-related data. Additionally or separately, the portable safety device may include an internal power source positioned within the housing. Additionally or separately, the housing may be coupled to a micromobility vehicle battery. Additionally or separately, a light and/or a speaker may be coupled to the housing. Additionally or separately, the housing may be configured to couple to a micromobility vehicle. Additionally or separately, the portable safety device may be positioned within a compartment of or coupled to a component of a light mobility vehicle.

Further examples or embodiments of the present disclosure may include a micromobility vehicle safety system. The micromobility vehicle safety system may include one or more feedback components coupled to the micromobility vehicle, a safety device coupled to the micromobility vehicle and in communication with the one or more feedback components, and a sensor device coupled to the micromobility vehicle and in communication with the one or more feedback components. The safety device may include a first connectivity device configured to transmit and receive entity data, and a processing element configured to receive the entity data from the first connectivity device, analyze the entity data to determine whether a threat exists, and transmit an alert to the one or more feedback components when a threat exists. The sensor device may include one or more sensors configured to detect safety-related data and transmit the safety-related data to the one or more feedback components.

Additionally or separately, the one or more feedback components may be coupled to a dedicated user device that is coupled to the micromobility vehicle and in communication with the safety device and the sensor device. Additionally or separately, the one or more feedback components may be coupled to the safety device. Additionally or separately, the one or more feedback components may include a display with capacitive and resistive touch features. Additionally or separately, the alert may override a graphical user interface of a third-party application. Additionally or separately, the one or more sensors may include a camera and the safety-related data transmitted to the one or more feedback components may be streaming video data of an environment around the micromobility vehicle. Additionally or separately, the one or more feedback components may include a light.

Other examples or embodiments of the present disclosure may include a method of generating a safe route for a micromobility vehicle user. The method may include receiving, by a processing element, safety-related data, including user data, micromobility vehicle data, and collision-related data, from an internal database in communication with the processing element, and environmental data from a third-party database in communication with the processing element, and determining, by the processing element, a safe route based on the safety-related data received, wherein the safe route is personalized based on the user data. Additionally or separately, the user data may include health data and the micromobility vehicle data may include data on a condition or state of the micromobility vehicle. Additionally or separately, the user data may include user fitness goals and the safe route may be personalized based on the user fitness goals. Additionally or separately, the method may further include adjusting, by the processing element, the safe route based on changes in safety-related data. Additionally or separately, the safety-related data may include entity data from a safety device in communication with the processing element.

Further examples or embodiments of the present disclosure may include a method of determining travel safety risks performed by a processing element. The method may include receiving safety-related data, wherein the safety-related data may include data related to one or more of object or entity data, road condition, user data, vehicle data, and environmental data; aggregating the safety-related data over time; determining one or more trends in the safety-related data; associating one or more travel safety risks with the one or more trends; and storing the one or more travel safety risks as trend data in a database in communication with the processing element. Additionally or separately, the one or more travel safety risk may be associated with a particular location. Additionally or separately, the one or more travel safety risks are one or more of high collision risk, a road obstacle, and a poor road condition.

Further examples or embodiments of the present disclosure may include a method of providing safety solutions for a traveler. The method may include receiving, by a processing element, safety-related data from one or more data sources, wherein the safety-related data is associated with an area and time; analyzing, by the processing element, the safety-related data to determine one or more safety risks or safe actions, wherein the safe actions relate to the traveler's movement; and transmitting, by the processing element, an alert related to the one or more safety risks or safe actions. The one or more data sources may include a safety device coupled to a micromobility vehicle. The safety device may include a connectivity device configured to receive entity data from a nearby entity, and a sensor configured to determine entity data of the micromobility vehicle, wherein the connectivity device and sensor are in communication with the processing element. Additionally or separately, analyzing the safety-related data may include analyzing the received entity data and the micromobility vehicle entity data to determine an SAE deployment profile specific to the micromobility vehicle. Additionally or separately, the connectivity device may be a C-V2X modem.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a block diagram illustrating an example of a data-driven autonomous communication optimization safety system.

FIG. 2A is a simplified block diagram of an exemplary safety device that can be used with the system of FIG. 1.

FIG. 2B is an image of the exemplary safety device of FIG. 2A.

FIG. 3 is a simplified block diagram of an exemplary connectivity module of the safety device of FIG. 2A.

FIGS. 4A-B are simplified block diagrams of a safety micromobility vehicle and safety light mobility vehicle, respectively.

FIGS. 5A-F are images of exemplary safety device positioning relative to safety bicycles and their components.

FIGS. 6A-S are images showing an exemplary safety application and features thereof.

FIG. 7 is a flow chart illustrating a method for preventing real-time collisions.

FIG. 8 is a flow chart illustrating a method for determining a safe route.

FIG. 9 is a flow chart illustrating a method for adjusting routes based on real-time collision data.

FIG. 10 is a flow chart illustrating a method for providing comprehensive safety data.

FIG. 11 is a flow chart illustrating a method for generating comprehensive collision-related data.

FIG. 12 is a flow chart illustrating a method for providing real-time micromobility collision alerts to emergency providers.

FIG. 13 is a flow chart illustrating a method for identifying groups of micromobility vehicles.

FIG. 14 is an illustration of short-distance range and long-distance range capabilities of the system of FIG. 1.

FIG. 15 is images illustrating data points analyzed by the system to determine whether they are indicative of a group of riders or an individual rider.

FIG. 16 is a flow chart illustrating a method for determining safety-related data trends.

FIG. 17 is a flow chart illustrating a method of providing real-time safety-related solutions.

FIG. 18 is a flow chart illustrating a method of leveraging relevant safety-related data from one or more disparate data sources to provide comprehensive road safety for a road user.

FIG. 19 is a flow chart illustrating a method of improving accuracy of locally determined safety risk factors.

FIG. 20 is a flow chart or diagram showing data flow through the safety system of FIG. 1.

FIGS. 21A-B show images of an exemplary safety device that can be used with the system of FIG. 1.

FIG. 22 is a simplified diagram of exemplary safety device hardware architecture of a safety device that can be used with the system of FIG. 1.

FIGS. 23A-B show a diagram of exemplary safety device hardware architecture of a safety device that can be used with the system of FIG. 1.

FIGS. 24A-B show images of an exemplary dedicated user device that can be used with the system of FIG. 1.

FIGS. 25A-C show images of an exemplary dedicated user device with simplified housing that can be used with the system of FIG. 1.

FIG. 26 is a simplified diagram of exemplary dedicated user device hardware architecture of a user device that can be used with the system of FIG. 1.

FIGS. 27A-B show a diagram of exemplary dedicated user device hardware architecture of a user device that can be used with the system of FIG. 1.

FIGS. 28A-C show images of an exemplary sensor device that can be used with the system of FIG. 1.

FIGS. 29A-E show images of an exemplary sensor device that omits a camera and can be used with the system of FIG. 1.

FIG. 30 is a simplified diagram of exemplary sensor device hardware architecture of a sensor device that can be used with the system of FIG. 1.

FIG. 31 is a diagram of exemplary sensor device hardware architecture of a sensor device that can be used with the system of FIG. 1.

FIG. 32 shows an image of an exemplary positioning of the sensor device of FIGS. 29A-E on a bicycle.

FIG. 33 shows an image of an exemplary micromobility vehicle safety system integrated with a bicycle.

FIG. 34 is a simplified block diagram of a safety system that can be integrated with a micromobility vehicle.

FIG. 35 is a flow chart illustrating a method of tracking vehicle usage to estimate equipment failure.

FIG. 36 is a simplified block diagram of a computing device that can be used by one or more components of the system of FIG. 1.

### DETAILED DESCRIPTION

The disclosed technology includes data-driven autonomous communication optimization safety systems, devices, and methods. Disclosed safety systems, devices, and methods may receive data from various data sources and provide real-time, autonomous, context-specific, and personalized safety-related output. Disclosed safety systems, devices, and methods may receive, determine, aggregate, store, predict, and/or analyze safety-related data, including safety risks (or threats or safety risk factors) and/or safe actions, and generate one or more real-time alerts, notifications, and/or routes for a user to move or travel safely. In several embodiments, disclosed safety systems, devices, and methods leverage safety-related data, as described below, from various Internet of things (IOT) devices, including the safety devices described herein, third-party connectivity devices, systems, and databases, user devices, and third-party applications to provide safe movement or travel for a user or traveler. In these embodiments, by leveraging large amounts of data from disparate sources, disclosed safety systems, devices, and methods improve the amount of safety information available and the accuracy of the safety-related output relayed to users or travelers, thereby improving user or traveler safety. A user (or traveler) described herein may be any user in motion or planning to move or travel, including for example, drivers of vehicles, users of micromobility vehicles (e.g., electronic or non-electronic bicycle, electric or non-electric scooter, electric or non-electric skateboard, etc.), users of other light mobility vehicles (e.g., motorcycles, two wheelers, three wheelers, four wheelers, mopeds, etc.), pedestrians, hikers, trail runners, and the like. As used herein, light mobility vehicles include micromobility vehicles.

It is contemplated that the safety systems, devices, and methods may be used for road or off-road (e.g., trails or other natural environments) travel. For example, various conditions may exist for road users, particularly for a vulnerable road user (VRU), that pose a risk to the road users' safety. A VRU may be a user of a micromobility vehicle or light mobility vehicle, a pedestrian, or the like. Safety risk factors, variables, or conditions or threats may include, for example, collision risks with other users (e.g., varying based on type, grouping, spacing, movement, etc. of other users), road or trail (surface) hazards or obstacles, changes in road/surface conditions, weather, crime, user's physical ability and health, vehicle condition (e.g., brake performance), and the like. As an example, automotive vehicles, such as cars, vans, trucks, buses, and the like, may pose a danger to VRUs, as operators of these vehicles, unaware of a VRU's location and/or route, may need to make real-time instantaneous decisions to avoid colliding with a VRU. In several embodiments, disclosed safety systems, devices, and methods optimize safety-related data and communication pathways or protocols to provide autonomous feedback to users for accident and collision avoidance and prevention, thereby creating a seamless travel experience for the user that is absent of safety concerns.

In several embodiments, disclosed safety systems, devices, and methods improve safety and visibility for micromobility and other light mobility vehicle users. For example, there are currently no micromobility vehicle-specific safety devices, systems, or methods to provide relevant and appropriate safety messages to micromobility users. While certain safety protocols exist for pedestrians and cars, these safety protocols may not be adequately applied to micromobility vehicles. The safety systems, devices, and methods described herein collect, aggregate, and analyze safety-related data that is relevant to a micromobility user and provide customized safety messages to micromobility users that have not previously been available.

Disclosed safety systems, devices, and methods are data-driven. In several embodiments, disclosed safety systems, devices, and methods collect, receive, cleanse, aggregate, interpret, predict, and otherwise manipulate safety-related data from numerous data sources. Safety-related data may include data that relates to safety risks and/or real-time circumstances, conditions, and/or situations, including those that may pose a threat to a user's safety. The safety-related data may include, for example, data related to the type, location, motion, and/or route of other users, traffic, collision risk, road/surface conditions and obstacles, weather, crime, and the like. The safety-related data may be leveraged to create a safe zone around a user, enabling a user to have a safe and seamless travel experience (e.g., a safe bike ride or walk).

In several embodiments, the safety-related data received and/or determined is comprehensive. For example, safety-related data may be received from various sources, both local and remote. Safety-related data may be received from one or more Internet of Things (IOT) device(s) (e.g., disclosed safety devices, automotive vehicle connectivity devices, etc.), sensor(s), user device(s) (e.g., safety applications discussed in more detail below), third-party application(s) and/or database(s) (e.g., fitness wearables, navigational applications, fitness, health, wellness, or training applications, etc.), third-party connectivity system(s) (e.g., traffic light systems, crosswalk systems, or other intelligent infrastructure systems), and the like. For example, safety-related data may be exchanged locally or directly between two or more connectivity devices (e.g., those associated with different users or third-party connectivity systems). As another example, disclosed safety systems, devices, and methods may be configured to collect information through application programming interfaces (APIs) of third-party software/applications. As another example, the system may receive user input of safety-related data, e.g., to alert other users of a particular situation encountered by a user (e.g., location of a pothole, location of no shoulder, bad or erratic behavior of other users, collisions or accidents, crime, etc.). In some embodiments, safety-related data may be determined by machine learning. For example, trends in safety-related data received over time may be determined that are indicative of risks or actions associated with a particular circumstance or situation.

In several embodiments, disclosed systems, devices, and methods optimize safety information exchange by leveraging various connectivity devices and systems, communication protocols, and third-party software and databases to create a safe travel experience for any user. Such safety information or safety-related data is ordinarily maintained in separate databases and/or processed by separate processing elements, or limited data is exchanged between entities (e.g., IoT devices with similar connectivity devices or users with the same third-party application), and accordingly, such data has limited utility. By aggregating this data, disclosed systems, devices, and methods expand the utility of the individual data sets by applying such data to the safety context, creating a greater understanding of road and off-road safety that extends beyond the typical information that is readily available to the average traveler.

By aggregating such large amounts of data from disparate sources in a unique and novel manner, disclosed safety systems, devices, and methods can increase interoperability between heterogenous devices and systems and provide more accurate and comprehensive safety-related data, alerts, and notifications for a seamless travel experience. As one example, disclosed safety systems, devices, and methods can leverage the large amount of data to correct errors in interpreting smaller data inputs. As a specific example, a car may include a processing element that is trained, via an artificial intelligence algorithm, to recognize a truck. However, such data is limited based on prior data received. For example, the processing element may not be trained to recognize a truck coming from a certain angle and may incorrectly identify the truck as another object. In this example, disclosed safety systems, devices, and methods can leverage other safety-related data to improve the artificial intelligence analytics and correct such errors. For example, disclosed safety systems, devices, and methods may receive data identifying the vehicle as a truck and correct the processing element's interpretation of the data. In turn, the processing element may be trained to interpret the same data in the future as identifying a truck. In this manner, disclosed safety systems, devices, and methods, by leveraging large amounts of data, can improve the accuracy of artificial intelligence processing and other processing systems to enhance mobility or travel safety.

In several embodiments, disclosed safety systems and methods expand the safety-related data available and user connectivity by leveraging disclosed IoT safety devices. Disclosed safety devices may be portable or coupled to light mobility vehicles (e.g., micromobility vehicles) to extend connectivity and safety to a more expansive number of users. In several embodiments, safety systems, devices, and methods include a safety device coupled to a light mobility vehicle (e.g., a micromobility vehicle) that enables connectivity between the light mobility vehicle and other vehicles and pedestrians. The safety device may receive, determine, analyze, store, and/or transmit safety-related data, including, for example, object data (e.g., data related to the identity and relative position or movement of one or more objects, such as, for example, entities, animals, traffic lights, traffic signs, etc.) and collision data (e.g., collision probabilities or likelihood). Object data may include entity data, e.g., data related to an entity's location or position, motion, orientation, and the like, including, for example, data related to geographic coordinates, speed, heading, direction, proximity to others, acceleration, deceleration, and the like. Entity data may also include data related to entity type or identity (e.g., micromobility vehicle, other light mobility vehicle, car, truck, bus, pedestrian, etc.). As used herein, an entity may refer to a micromobility vehicle, a light mobility vehicle (e.g., motorcycle), an automotive vehicle, or user device (e.g., carried by a pedestrian). As used herein, automotive vehicles refer to vehicles other than micromobility vehicles and light mobility vehicles. The safety-related data may be used and/or stored by safety systems or methods described herein.

In some embodiments, the safety device enables the micromobility vehicle or light mobility vehicle or user (e.g., pedestrian) to connect locally (e.g., direct) and remotely (e.g., via a network) with other users (e.g., cars, vans, trucks, and other automotive vehicles, light mobility vehicles, and micromobility vehicles), thereby providing the micromobility vehicle or light mobility vehicle or user with comprehensive connectivity capabilities. In some embodiments, the safety device enables the micromobility vehicle or light mobility vehicle or user to connect remotely with one or more user devices (e.g., smartphones, wearables, etc.), such as those used by pedestrians, hikers, rollerbladers, and the like. By increasing connectivity between micromobility vehicles, light mobility vehicles, automotive vehicles, and other users, systems, devices, and methods described herein provide increased visibility and awareness of others, providing a more comprehensive landscape of potential safety risks and helping to prevent collisions and other dangerous situations.

Some automotive vehicles have integrated connectivity systems, including, for example, 3G and LTE modems for Vehicle-to-cellular-Network (V2N) communications, Dedicated Short Range Communication (DSRC), Intelligent Transport Systems (ITS)-5G, and Cellular Vehicle to Everything (C-V2X). However, these systems often require other automotive vehicles to be within a short-distance range and to be enabled with the same technology to communicate. Further, the data exchanged by these systems is limited.

As one example, C-V2X follows standards set out by the Third Generation Partnership Project (3GPP) for Long Term Evolution (LTE) and 5G networks and uses the 5.9 GHz frequency band for direct communication. C-V2X technology provides high-speed and high-frequency data exchange up to 10 times per second within millisecond latency. However, as with other current automotive vehicle connectivity systems, the C-V2X technology requires other automotive vehicles be equipped with C-V2X technology and within a short-distance range, up to a few or several hundred meters (e.g., 300 m, 400 m, 500 m, etc.), to communicate. Such systems cannot detect oncoming vehicles outside the local short-distance communication range or those that are not equipped with the same connectivity technology.

Several of the current systems that connect vehicles to cyclists or pedestrians, called Vehicle-to-Pedestrian (V2P) communication systems, require the cyclist or pedestrian to have a smartphone or tablet. Using a smartphone for such connectivity with bicycles is not ideal, as it can be dangerous for cyclists to pull out their phone while biking or otherwise requires purchasing and installing additional components for the bicycle to hold the smartphone, so it is hands-free. Further, the information shared between vehicles and smartphones is limited and communication is limited to a local short-distance communication range. Additionally, the information related to the V2P communication may not be adequately or effectively relayed to a user through a smartphone due to interference by other third-party applications. For example, if a user has a navigational application open, the user may not receive the information from the V2P communication.

Current systems enable limited short-range communication between vehicles but fail to provide a bigger picture of the road conditions and safety-risk landscape (e.g., dangerous areas or high safety risk areas such as accident locations, heavy traffic areas, high crime areas, high risk collision areas, dangerous road/surface conditions or obstacles, speeding vehicles approaching from a further distance away, etc.), to account for cyclists or other micromobility vehicle users or pedestrians without smartphones, to provide comprehensive, real-time, and effective safety-related data to users, and to provide a seamless travel experience absent from safety hazards.

In several embodiments, the systems, devices, and methods of the present disclosure aim to resolve the problems of current connectivity systems by integrating connectivity with VRUs (e.g., light mobility vehicles and/or pedestrians) and increasing the safety-related data available to VRUs and other users.

In several embodiments, a safety device described herein exchanges entity data (e.g., location, speed, heading, acceleration, etc.) with one or more connectivity devices of one or more other entities (e.g., an automotive vehicle connectivity device or other safety device), thereby increasing contextual awareness between the entities. For example, a safety device may be coupled to a micromobility vehicle or other light mobility vehicle and may receive and/or determine entity data of the micromobility vehicle or other light mobility vehicle and/or a trajectory of the micromobility vehicle or other light mobility vehicle, receive entity data of one or more other entities from one or more other connectivity devices (e.g., automotive vehicle connectivity devices and/or safety devices), determine a proximity/distance or path or trajectory of the one or more other entities and/or a collision probability between the entities or conflict based on the entity data or determined trajectories, and provide real-time feedback to a user of the micromobility vehicle or other light mobility vehicle. In this manner, the user of the micromobility vehicle or other light mobility vehicle can be informed of whether a vehicle is approaching (and from where), on the same path, too close, on a collision course with the micromobility vehicle or other light mobility vehicle, or the like, and avoid a collision. In several embodiments, the safety device is able to exchange entity data with multiple entities in an area (e.g., with hundreds of other entities within a 500 m radius) and determine whether any of those entities pose a safety risk or threat (e.g., pose a risk of collision based on their trajectory and that of the safety device). The safety device may provide selective information to the user based on the one or more entities that pose a threat.

In some embodiments, a safety device described herein may be portable and may be carried by a user, e.g., in a purse or backpack. For example, a disclosed safety device may be placed in a child's backpack to increase the child's awareness of others and others' awareness of the child. As another example, a safety device may be placed in a vehicle (e.g., car or bus) that has no embedded connectivity devices (e.g., is not C-V2X or modem equipped). In this example, the safety device may be in communication with the vehicle's sensors (e.g., via wireless communication). In this example, the non-embedded or portable safety device enables the vehicle to connect with other system IoT devices. Further, the driver could take the safety device out of the vehicle and carry it to remain connected to the system 100, enabling others to remain aware of the driver even when the driver is not in the car. Current systems do not allow for such expansive connectivity.

In several embodiments, a safety device includes a housing, a connectivity module within the housing, and a local processing element in communication with the connectivity module. In some embodiments, the housing has a form factor that is compatible with a form factor of a component or system of a micromobility vehicle or other light mobility vehicle to couple to the component or system. As one example, the housing may have a cylindrical form factor to couple to a seat post of a bicycle. As another example, the housing may have a form factor that is compatible with a form factor of a water bottle holder, such as, for example, a rectangular form factor. The connectivity module may include one or more connectivity devices configured to receive and transmit signals (e.g., entity data) to and from connectivity devices of automotive vehicles and/or other safety devices. For example, the connectivity module may include a C-V2X chip and/or a cellular modem configured to communicate with other vehicles having a C-V2X chip and/or a cellular modem. The connectivity module (e.g., C-V2X chip and/or cellular modem) may be configured to exchange Basic Safety Messages (BSM) (which include entity data) and/or personal safety messages (PSM) with other entities. In this manner, a safety device described herein may enable a micromobility vehicle or other light mobility vehicle to exchange safety messages with other entities. The local processing element may be configured to determine a proximity, distance, or path/approach of automotive vehicles and/or other light mobility vehicles relative to the micromobility vehicle or other light mobility vehicle and/or a collision probability between vehicles, and provide real-time feedback to a user of the micromobility vehicle or other light mobility vehicle.

Disclosed systems, devices, and methods may enable both short-range and long-range communication between entities (e.g., automotive vehicles, micromobility vehicles, and pedestrians), and provide a detailed and comprehensive landscape of safety risk factors or potential threats, including, for example, entity locations and routes, groupings, traffic, real-time collisions, high risk collision areas, collision risk factors, road/surface conditions, danger zones, and the like. Areas of high safety risk, such as danger zones, high risk collision areas, high traffic areas, areas with poor road/surface conditions, areas with high crime, construction areas, and the like, may be referred to herein as high safety risk areas. In several embodiments, a system disclosed herein is capable of local and/or remote processing to determine locations, proximity, distance, path, and/or number of other entities; collision-related data (e.g., real-time collisions, near-collisions, high risk collision areas, etc.); high traffic areas; presence/absence/width of pedestrian or bicycle paths or road shoulders; road/surface conditions; and the like. For example, local processing may be initiated when entities are within a short-distance range of one another (e.g., within 2 or 3 miles or several hundred meters), and remote processing may be initiated when entities are within a long-distance range (e.g., within 5 miles or more, within 500 miles, or further away). In other words, local processing may determine data related to entities within a short-distance range and remote processing may determine data related to entities within a long-distance range. It is contemplated that the long-distance range my be inclusive of the short-distance range and the remote processing may determine data related to entities within a short-distance range. It is contemplated that the information received locally may be from a source other than another entity, such as another nearby connectivity device or system (e.g., a traffic light system, a crosswalk system, or other intelligent infrastructure systems).

The remote processing element may determine a long-distance range safety risk landscape, including, for example, data related to entities, traffic, danger zones, real-time collisions, high-risk collision areas, road/surface obstacles, and the like. The remote processing element may have greater lag/latency in data transfer than the local processing element. To reduce the lag in data transfer when entities are close (e.g., within a short-distance range), the system may switch to using the local processing element for quicker data transfer between the entities. For example, if entities are so close they are near collision, reducing lag in data transfer by using the local processing element instead of the remote processing element can provide the entities with timely information so they can avoid the collision. By leveraging both local and remote processing capabilities, disclosed systems are able to provide both improved data transfer (e.g., with reduced latency/lag and improved responsiveness) and create visibility and contextual awareness over a larger range.

In several embodiments, the system includes a safety device coupled to a micromobility vehicle or other light mobility vehicle, the safety device including a local processing element configured to determine a proximity of, distance of, path of/trajectory, and/or collision probability with one or more other entities (e.g., an automotive vehicle, other light mobility vehicle, and/or other user device) within a short-distance range. In these embodiments, the system includes a server or remote processing element in communication, via a network, with the micromobility vehicle or other light mobility vehicle (e.g., via the safety device) and the one or more other entities (e.g., via an automotive vehicle connectivity device and/or other safety device), and configured to determine a proximity, distance, or path/trajectory of the one or more other entities relative to the micromobility vehicle or other light mobility vehicle and/or collision probability between the entities within a long-distance range. In these embodiments, the safety device or a user device in communication with the local processing element and the remote processing element may receive safety-related data and/or alerts (e.g., entity data and/or collision-related data, such as, for example, data related to real-time collisions, high risk collision areas, etc.) from the remote processing element when the one or more other entities are within the long-distance range, and receive safety-related data and/or alerts (e.g., entity data and/or collision alerts) from the local processing element when the one or more other entities are within a short-distance range.

Disclosed safety systems, devices, and methods may include sentient enhanced intelligence. For example, disclosed safety systems, devices, and methods may include contextual awareness, autonomous processes, personalization, and continuous learning. For example, disclosed safety systems, devices, and methods may receive data related to sight (e.g., visual inputs), sound (e.g., auditory inputs), smell or odor (e.g., olfactory inputs), and touch (e.g., haptic inputs). Visual inputs may be analyzed to determine object proximity, movement, and/or identification. Auditory inputs may be analyzed to interpret the sound (e.g., based on patterns in the sound), for example, to differentiate between sirens, horns, trucks reversing, bicycle bells, children playing, crashes, braking, gun shots, and the like. Auditory inputs may also be analyzed to interpret entity or object proximity, acceleration, deceleration, type, number, and the like. Olfactory inputs may be analyzed to assess air quality or to interpret context. For example, certain odors may be indicative of air pollution, braking (e.g., rubber odor), oil leaks, smoke, and the like. Haptic inputs could be interpreted to determine context as well. For example, a sudden jolt could be indicative of a bump or pothole in the road, a hard impact could be indicative of a collision, and the like. These sensory inputs may be received via IoT sensors (e.g., camera, infrared sensor, microphone, an electronic nose, motion sensor, ultrasonic sensor, jolt sensor, accelerometer, etc.) and included as part of the comprehensive safety-related data utilized by the safety systems, devices, and methods described herein.

Disclosed safety systems, devices, and methods may be contextually aware. With the vast amount of safety-related data received, aggregated, analyzed, and interpreted, disclosed safety systems, devices, and methods can determine, understand, and react to real-time circumstances, conditions, and/or situations, including those that may pose a threat to a user's safety. Due to the large amounts of data aggregated, the contextual awareness of the disclosed safety systems, devices, and methods is heightened over current contextually aware systems and devices, increasing the level of safety provided for users.

Disclosed safety systems, devices, and methods may include autonomous processes. For example, when certain data is received, or certain variables are present, certain autonomous processes may be triggered to determine safety risks and/or actions in real time. For example, an IoT device within range of another IoT device may trigger communication between the devices and activate certain autonomous processes, e.g., to determine whether the other IoT device is a safety risk or threat (e.g., if there is a likelihood of collision). As another example, an IoT device entering a certain area (e.g., based on GPS coordinates) may trigger certain autonomous processes, e.g., interpreting the area is dangerous and transmitting a warning. As demonstrated by these examples, disclosed safety systems, devices, and methods may leverage one or more communication protocols (e.g., different communication protocols) to execute one or more autonomous processes to keep a user safe. By optimizing use of multiple communication protocols or channels, disclosed safety systems, devices, and methods increase the exchange of safety information and thus the safety information available to the average user. In several embodiments, disclosed safety systems, devices, and methods can analyze and interpret this safety-related data to provide a seamless travel experience (e.g., without the user knowing any safety hazards were present).

Disclosed safety systems, devices, and methods may be personalized. For example, a disclosed safety device or user device may be associated with a particular user. User data may be received (e.g., via user input) or determined by the system (e.g., via sensors, trends in data collected overtime, etc.), including, for example, user age, weight, height, biometrics, experience (e.g., years driving or biking), fitness level or goals, prior performance metrics and trends, and the like. Disclosed safety systems, devices, and methods may adjust data analysis or data output based on user data. For example, the safety-related data may be analyzed differently to assess risk for an elderly user or a user with increased health problems, as the level of risk tolerance for such individuals may be lower than for a younger or healthy individual. The determined action(s) or data output may incorporate user data. For example, a different optimal route may be determined for a user with a heart condition than a healthy user (e.g., the optimal route may be a longer route with less elevation gain and/or less sustained high levels of exertion). As another example, the data output may be tailored differently for a child versus an adult to facilitate understanding of the data (e.g., warnings or alerts). Disclosed safety systems, devices, and methods may learn overtime optimal actions or circumstances (e.g., optimal routes, optimal travel times, etc.) based on user data. In some embodiments, disclosed safety systems, devices, and methods may share these optimal actions or circumstances with other users with similar user data.

In several embodiments, the actions, routes, and other data output by disclosed safety systems, devices, and methods may factor in other considerations besides safety to provide a personalized user experience. For example, a user's fitness level and/or fitness goals may be factored into the analysis to determine optimal actions or routes. For example, there may be various routes that are optimal based on safety considerations. One or more of the optimal routes may include terrain to achieve a particular level of fitness or exercise (e.g., with a certain number of inclines, particular elevation gain, distance, etc.). Disclosed safety systems, devices, and methods may provide an optimal route for a user based on safety and desired fitness outcome.

Disclosed safety systems, devices, and methods may leverage machine learning and artificial intelligence to further improve the accuracy, comprehensiveness, and personalization of safety-related data utilized, interpreted, and output by such systems, device, and methods. For example, with the large amount of data collected and analyzed over time, a disclosed system may learn safe routes or optimal ride times for a particular user, dangerous areas or high safety risk areas, and other safety risks or optimal safe actions that can be taken. Any of the various system or device components described herein may include artificial intelligence for understanding safety-related data trends and associated actions and safety responses.

### Systems Overview

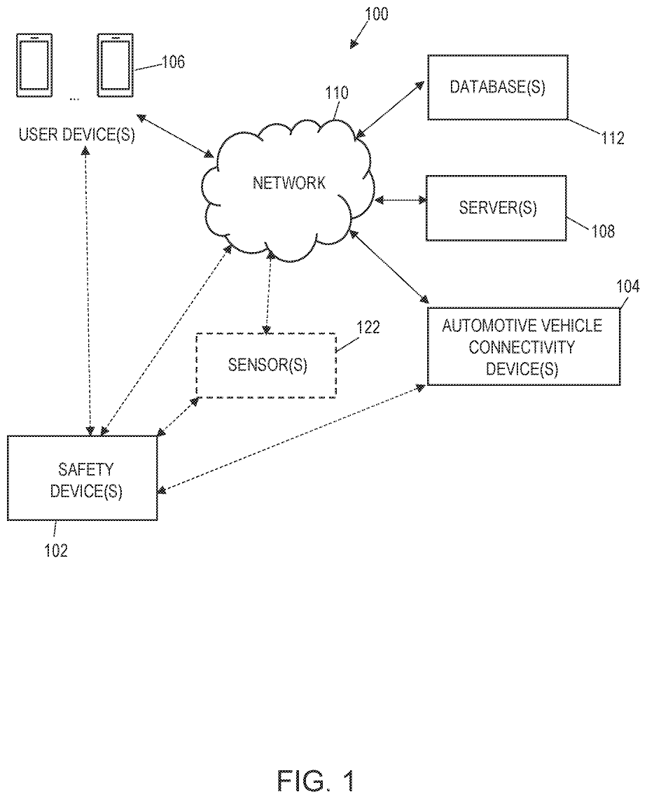

Turning now to the figures, systems of the present disclosure will be discussed in more detail. FIG. 1 is a block diagram illustrating an example of a safety system 100. The system 100 may include one or more safety devices 102. The safety devices 102 may be portable or coupled to one or more micromobility vehicles 132 (e.g., see FIG. 4A) or other light mobility vehicles 253 (e.g., see FIG. 4B). For example, the one or more micromobility vehicles 132 may be a bicycle, unicycle, tricycle, quadricycle, electric bicycle, scooter, electric scooter, skateboard, electric skateboard, and the like. The one or more light mobility vehicles 253 may include micromobility vehicles, motorcycles, e-motorcycles, two wheelers, three wheelers, four wheelers, ATVs, mopeds, light electric vehicles, and the like. The one or more safety devices 102 may be in communication with each other and/or with one or more automotive vehicle connectivity devices 104. In some embodiments, the safety device(s) 102 are in communication with one or more user devices 106, which in turn are in communication with one or more servers or remote processing element(s) 108, via a network 110. In some embodiments, the safety device(s) 102 and automotive vehicle connectivity device(s) 104 are in communication with one or more servers 108, via network 110, which in turn may be in communication with one or more user devices 106. The one or more servers 108 may be in communication with one or more databases 112, via network 110. Each of the various components of the safety system 100 may be in communication directly or indirectly with one another, such as through the network 110. In this manner, each of the components can transmit and receive data from other components in the system 100. In many instances, the one or more servers 108 may act as a go between for some of the components in the system 100.

The network 110 may be substantially any type or combination of types of communication systems for transmitting data either through wired or wireless mechanism (e.g., Wi-Fi, Ethernet, Bluetooth, ANT+, cellular data, radio, or the like). In some embodiments, certain components of the safety system 100 may communicate via a first mode (e.g., Cellular) and others may communicate via a second mode (e.g., Wi-Fi or Bluetooth). Additionally, certain components may have multiple transmission mechanisms and may be configured to communicate data in two or more manners. The configuration of the network 110 and communication mechanisms for each of the components may be varied as desired and based on the needs of a particular location.

The safety device(s) 102 may include connectivity and processing capabilities to receive and/or determine, process, and transmit safety-related data. Safety-related data may include data related to one or more objects or entities (e.g., Basic Safety Messages, such as SAE J2735, location, proximity, speed/velocity, acceleration, deceleration, heading, distance, path/route/trajectory, movement changes, type, etc.), SAE deployment profiles (e.g., related to blind spot detection, right turn assist, left turn assist, do not pass, etc.), personal safety messages (PSM), time, power (e.g., battery life of safety device and/or micromobility vehicle), collisions and collision risk, road/surface conditions (e.g., elevation changes, turns, surface type, surface state, etc.), road/surface hazards or obstacles (e.g., potholes, traffic cones, bumps, etc.), traffic or congestion, weather (including weather probabilities and expected times of weather events), environment (e.g., altitude, air quality, heat index, humidity, temperature, visibility, etc.), traffic intersections, traffic lights, traffic signs (e.g., speed limit signs, stop signs, warning signs, etc.), laws or ordinances, criminal activity (including locations and time of day), user data (e.g., biometrics, health, age, weight, height, gender, energy exertion, fitness and/or wellness goals, etc.), vehicle data (e.g., type, size, age, condition, etc.), and the like. As used herein, safety may encompass physical safety (e.g., collision avoidance), mental/emotional well-being (e.g., crime avoidance), health (e.g., maintaining safe heart rate/blood pressure levels, limiting exposure to toxins, etc.), vehicle safety (e.g., safe maintenance/condition for risk prevention), and the like.

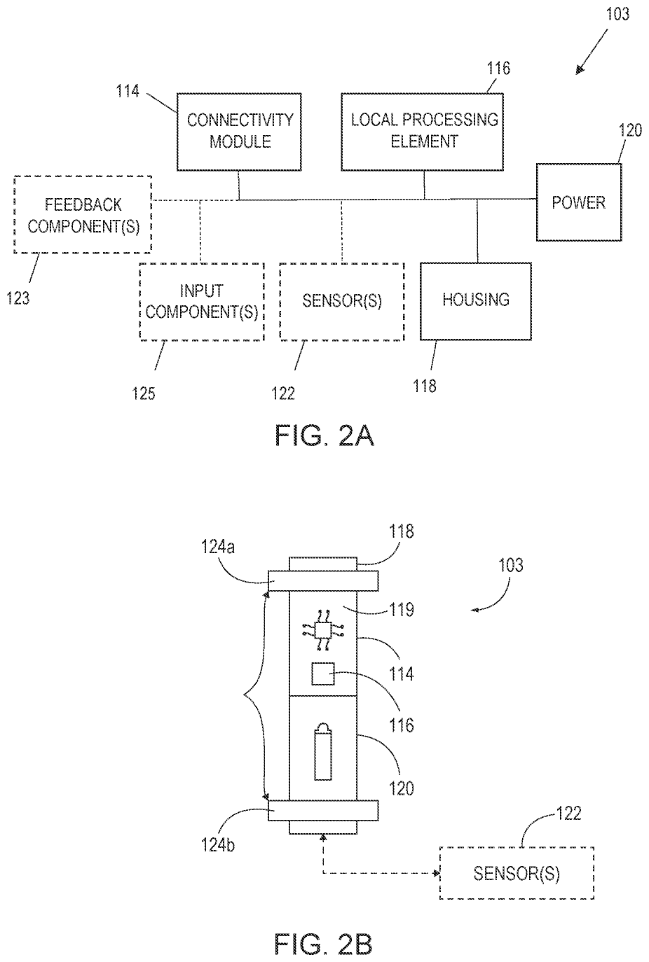

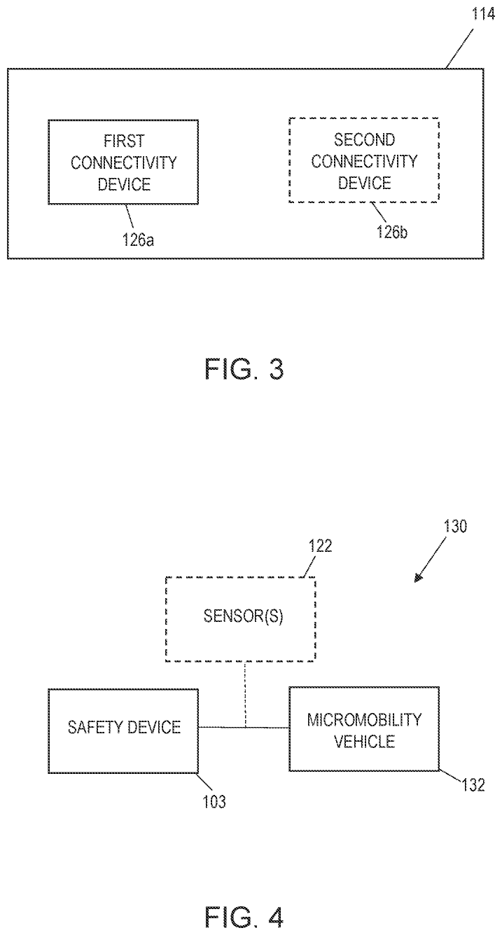

The safety device 102 may be any safety device described herein, e.g., as described with respect to FIGS. 2A-B and 21A-23B. As shown in FIGS. 2A-B, and discussed in more detail below, the safety device(s) 102 may include a connectivity module 114 and a local processing element 116. In several embodiments, the connectivity module 114 transmits and receives safety-related data to and from other safety device(s) 102 and/or automotive vehicle connectivity device(s) 104. The safety-related data may be transmitted to and received from other safety device(s) 102 and/or automotive vehicle connectivity device(s) 104 that are within a short-distance range. As shown in FIG. 3, the connectivity module 114 may include one or more connectivity devices 126a,b, such as a first connectivity device 126a and a second connectivity device 128a. The one or more connectivity devices 126a,b may include a V2X chipset or modem (e.g., a C-V2X chip), a Wi-Fi modem, a Bluetooth modem (BLE), a cellular modem (e.g., 3G, 4G, 5G, LTE, or the like), Ant+ chipsets, and the like. In some embodiments, the local processing element 116 is omitted and processing of safety-related data is executed by the remote processing element (e.g., server 108). In some embodiments, the safety device 102 may include more than one processing element. In these embodiments, the processing elements may or may not be in communication with one another.

Returning to FIG. 1, in several embodiments, the one or more automotive vehicle connectivity devices 104 in communication with one of the one or more connectivity devices 126a, b include connectivity devices compatible with the one or more connectivity devices 126a,b, such as, for example a V2X chipset or modem (e.g., a C-V2X chip), a Wi-Fi modem, a Bluetooth modem (BLE), a cellular modem (e.g., 3G, 4G, 5G, LTE, or the like), Ant+ chipsets, and the like. In embodiments where the connectivity module 114 includes multiple connectivity devices 126a,b, the connectivity capabilities of the micromobility vehicle 132 or other light mobility vehicle 253 or user (e.g., in cases where the safety device 102 is portable) are expanded, such that the micromobility vehicle 132 or other light mobility vehicle 253 or user is capable of communicating, via the connectivity module 114, with different automotive vehicles having different automotive vehicle connectivity devices 104. For example, by including a C-V2X chip and a cellular modem, the connectivity module 114 can communicate with automotive vehicles that include either a C-V2X chip or cellular modem. In the case where automotive vehicle connectivity devices 104 become streamlined (e.g., if all automotive vehicles become integrated with the same automotive vehicle connectivity device 104, e.g., C-V2X technology), the connectivity module may be simplified to include a single connectivity device 126a, e.g., a C-V2X chip. It is further contemplated that a single hybrid connectivity device may be used that is configured to communicate across various protocols (e.g., with both C-V2X technology and cellular modems). It is further contemplated that the second connectivity device 126b may be separate from the safety device 102 (e.g., a component of an associated user device 106) and coupled to the micromobility vehicle 132.

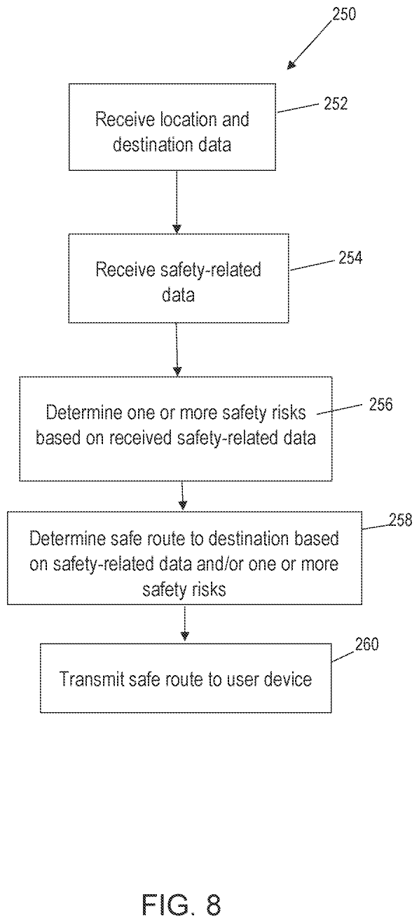

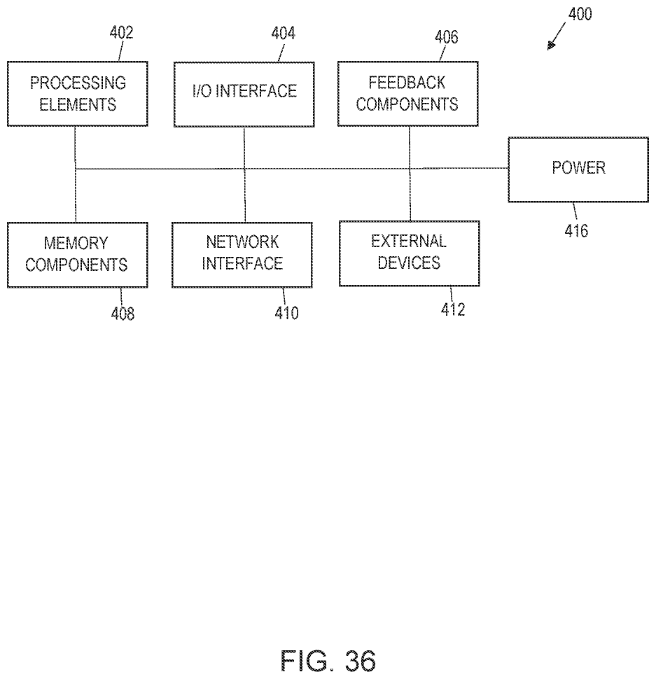

The safety device 102 local processing element 116 may receive safety-related data from the connectivity module 114 and/or from a local sensor (e.g., GPS sensor) and transmit the safety-related data, via the network 110, to the one or more servers 108, e.g., for storing in the database(s) 112. The one or more servers, central processing unit(s), or remote processing element(s) 108 are one or more computing devices that process and execute information. The one or more servers 108 may include their own processing elements, memory components, and the like, and/or may be in communication with one or more external components (e.g., separate memory storage)(an example of computing elements that may be included in the one or more servers 108 is disclosed below with respect to FIG. 36). The one or more servers 108 may include one or more server computers that are interconnected together via the network 110 or separate communication protocol. The one or more servers 108 may host and execute a number of the processes executed by the system 100, e.g., methods 250, 300, 350, 380, 370, 392, 500, 550, 600, 650, and 1050 of FIGS. 8-13, 16-19, and 35, respectively.

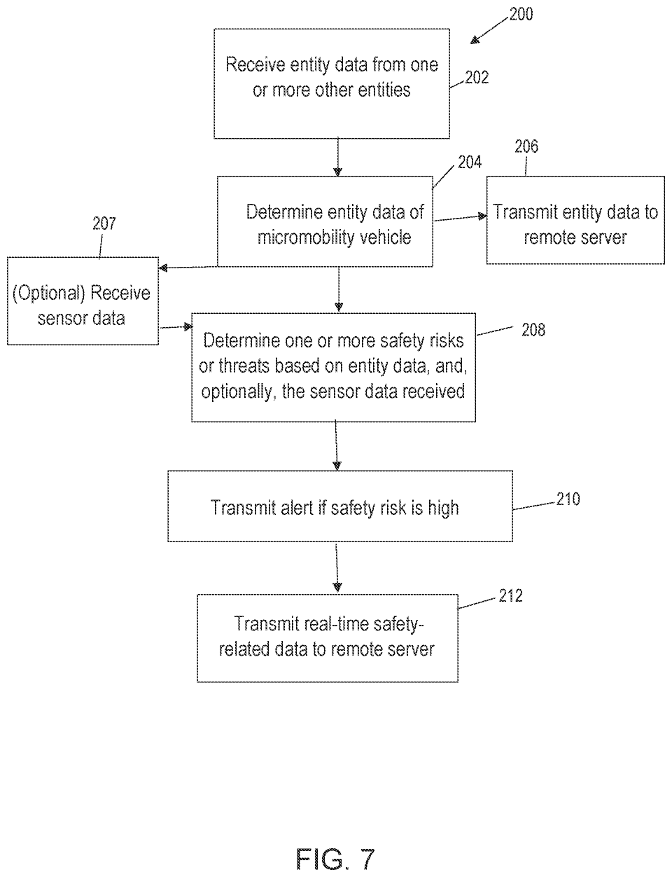

In several embodiments, the safety device local processing element 116 processes safety-related data (e.g., received from one or more other entities and/or one or more local sensors) to determine one or more safety risks or threats. For example, the local processing element 116 may process entity data to determine a proximity, distance, path, trajectory, etc. of other vehicles (e.g., micromobility vehicles, other light mobility vehicles, and/or automotive vehicles) and/or a collision probability with other vehicles. For example, the local processing element 116 may determine a path or trajectory of another vehicle and determine whether it conflicts with a trajectory of an associated vehicle. For example, two or more paths or trajectories may conflict when they are likely to intersect or nearly intersect (e.g., the vehicles are likely to collide or nearly collide). The local processing element 116 may transmit the determined safety risk(s) (e.g., determined proximity, distance, path, trajectory, and/or collision probability) to the one or more servers 108 for storage in the one or more databases 112. The local processing element 116 may transmit an alert to the one or more user devices 106 based on the determined safety risk(s) (e.g., proximity, distance, path, trajectory, and/or determined collision probability), as discussed in more detail below with respect to method 200 of FIG. 7. For example, the local processing element 116 may transmit an alert when a safety risk is within a certain proximity or a high probability value range (e.g., a collision probability reaches a high probability value, e.g., more than 90%).

In several embodiments, the local processing element 116 may transmit the alert to one or more user devices 106. A user device of the one or more user devices 106 may be associated with a particular safety device 102 (referred to herein as an associated user device). For example, a user device 106 may be associated with a safety device 102 by data input into an application on a graphical user interface (GUI) of the associated user device 106 (e.g., via registration of the micromobility vehicle 132). As another example, a user device 106 may be associated with a safety device 102 based on proximity (e.g., the rider of the micromobility vehicle holding the user device 106 or the user device 106 coupled to the same micromobility vehicle as the safety device 102). The one or more user devices 106 may include various types of computing devices, e.g., smart phones, smart displays, tablet computers, desktop computers, laptop computers, set top boxes, gaming devices, wearable devices, ear buds/pods, or the like. The one or more user devices 106 provide output to and receive input from a user (e.g., via a human-machine interface or HMI). The one or more user devices 106 may receive one or more alerts, notifications, or feedback from the one or more servers 108, the one or more sensors 122, and/or from the one or more safety devices 102 indicative of safety-related information (e.g., safety-related data described herein, such as relative positions/locations of other entities and/or collision-related or traffic-related data). The type and number of user devices 106 may vary as desired.

The one or more user devices 106 may include a dedicated user device that is associated with a safety device described herein or functions in a similar manner as a safety device described herein. The dedicated user device may include safety application software described below and may be configured to execute one or more of the methods described herein. In some embodiments, by incorporating a dedicated user device (e.g., instead of a traditional user device such as a smartphone), the safety system 100 can provide more direct and efficient safety output to a user. For example, the dedicated user device may exclude other applications that can interfere with the transmission of safety messages to ensure that safety messages are timely and effectively transmitted to a user. A dedicated user device may provide a higher level of safety and reliability than a smartphone or tablet that integrates other applications and non-safety related data.

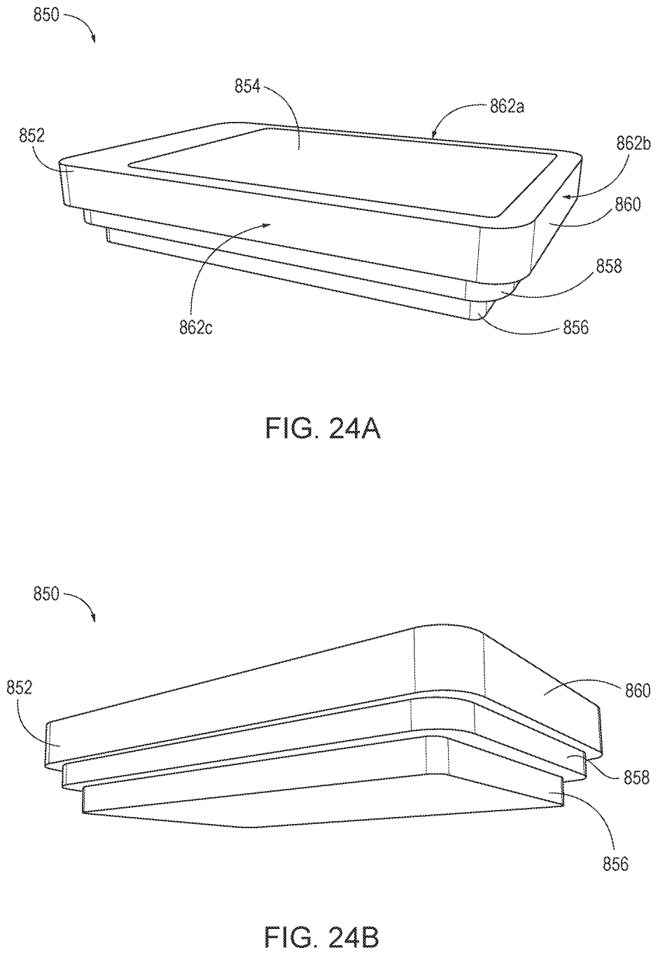

FIGS. 24A-29 show exemplary dedicated user devices and user device hardware architecture. For example, FIGS. 24A-B show images of an exemplary dedicated user device 850. In this embodiment, the user device 850 has a housing 852 and a display 854. The housing 852 has a skin wrapped or tiered structure. For example, each tier or layer of the housing 852 may house different components. As an example, the bottom layer 856 may include a battery, the middle layer 858 may include a printed circuit board (PCB), and the top layer 860 may include the display 854. The display 854 may be a touch display, such as, for example, a resistive touch display (e.g., usable with gloves) or a capacitive touch display, or both. One or more antennas may be positioned within the housing 852. The antennas may be placed in one or more of the depicted antenna areas 862a,b,c. The positioning of the antennas may be selected to reduce interference and conform to the form factor of the user device 850. The housing 852 may be shaped and sized based on the particular use of the user device 850. For example, the size and shape may be varied based on the type of micromobility vehicle or other light mobility vehicle the user device 850 is used with or integrated with. The housing 852 size may be minimized to allow integration of the device by light mobility vehicle manufacturers.

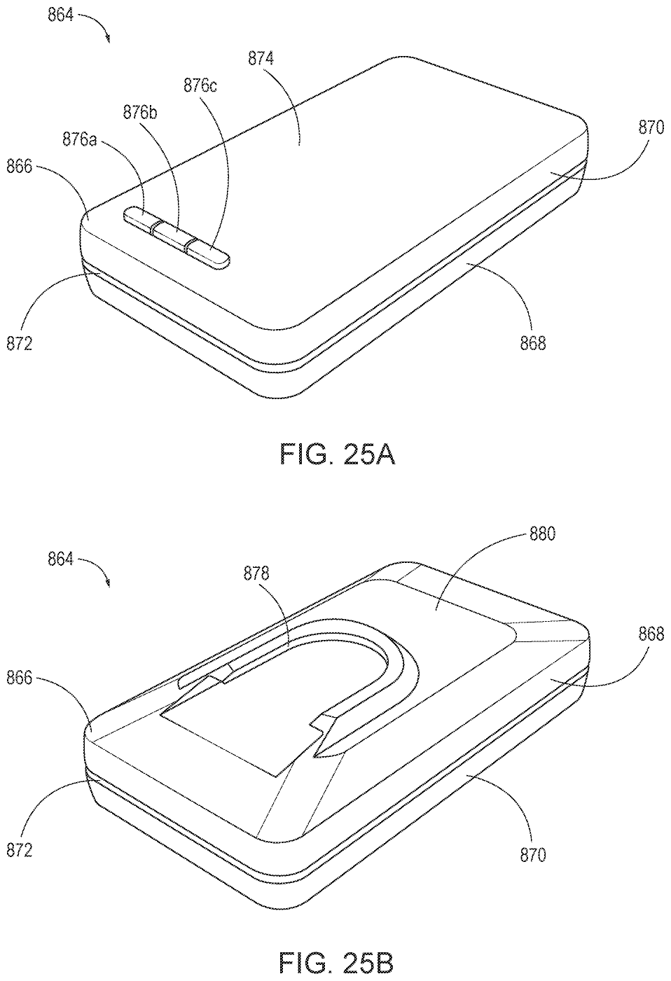

It is contemplated that one or more of the housing 852 layers may be omitted. For example, the bottom layer 856 may be omitted where a battery is omitted from the user device 850. For example, a simpler version may be desirable for use or integration with an electronic bicycle or scooter. FIGS. 25A-C show images of an exemplary dedicated user device 864 that includes a housing 866 that is simplified and without the tiered housing structure. In the depicted example, the housing 866 has a bottom layer 868 and a top layer 870 with a groove 872 in between the layers. The top layer 870 includes a display 874 and buttons. For example, the buttons may include a left arrow button 876a, a power button or select button 876b, and a right arrow button 876c. It is contemplated that the buttons may be omitted. The bottom layer 868 may include a mount interface 878 on a rear surface 880 of the user device 864. For example, as shown, the mount interface 878 is a slot to allow the user device 864 to slide onto a mount on a micromobility vehicle or other light mobility vehicle. Other mount interface shapes and types are contemplated to correspond with varying mounts on micromobility vehicles or other light mobility vehicles. It is also contemplated that the mount interface 878 may be omitted. As shown in FIG. 25C, the user device 864 may include a protective case 882 for the top layer 870 and display 874. For example, the case 882 may surround an outer edge of the top layer 870 and couple with the groove 872 for stability. It is contemplated that the user device 850, 864 may include one or more sensors or feedback components, including, for example, one or more cameras, microphones, lights, speakers, and the like. For example, the user device 850 may be configured for audio/voice control (e.g., via the microphone) to allow for handsfree control.

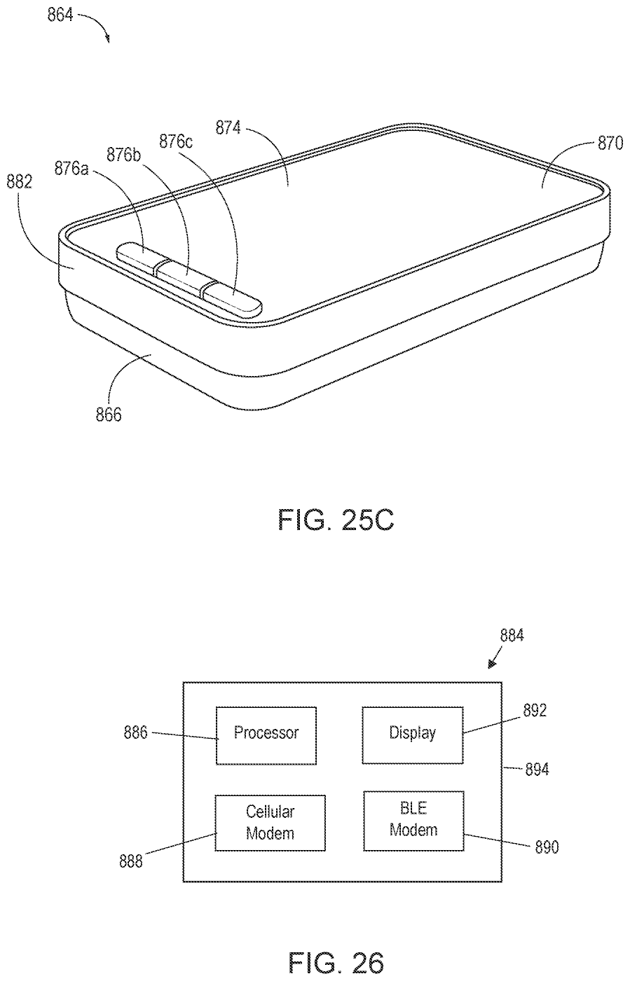

FIG. 26 is a simplified diagram of exemplary dedicated user device hardware architecture 884 of a user device described herein, e.g., of user device 850 or user device 864. As shown, the user device hardware architecture 884 includes a processor 886, a cellular modem 888, a Bluetooth Low Energy (BLE) modem 890, and a display 892. The processor 886 and modems 888, 890 are positioned within a housing 894 that includes the display 892. The processor 886 and modems 888, 890 may be conventional devices and may be selected based on the form factor and desired power capabilities of the user device. An exemplary processor 886 is a Qualcomm® QCS6125 application processor.

The processor 886 may execute local or edge processing for the user device, enabling the user device to aggregate, store, analyze, and learn from safety-related data received (e.g., received by one or more of the modems 888, 890). It is contemplated that the processor 886 may execute the same or similar functions as safety devices described herein (e.g., execute the safety methods described herein). For example, the processor 886 may determine entities within proximity, collision probabilities, threats (e.g., actual and anticipated), road/surface hazards, user actions (e.g., to avoid safety risks), and the like, and transmit notifications and alerts related to the same.

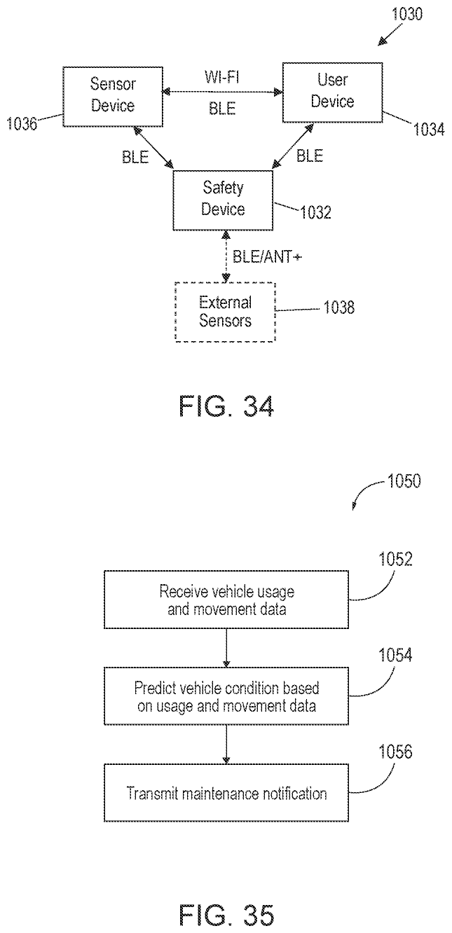

The cellular modem 888 may be an LTE or 5G modem. An exemplary cellular modem 888 is Quectel RG500Q. The cellular modem 888 may enable the user device to transmit and receive information from the one or more servers 108, which may be displayed via the display 892. The cellular modem 888 may enable the user device to communicate with other devices having cellular modems over the network (e.g., vehicles that are not equipped with C-V2X modems). An exemplary BLE modem 890 is a Nordic® nRF52. The BLE modem 890 may enable the user device to communicate with other local devices (e.g., a local sensor device or safety device as described with respect to FIGS. 33 and 34). For example, the BLE modem 890 may enable the user device to communicate with a local or associated safety device, which in turn may communicate with vehicles equipped with C-V2X modems. As such, the user device may be configured to communicate with other vehicle devices that are equipped with different type modems (e.g., a cellular modem or C-V2X modem). The display 892 may provide an HMI to relay information to a user (e.g., based on logic executed by the one or more connected devices).

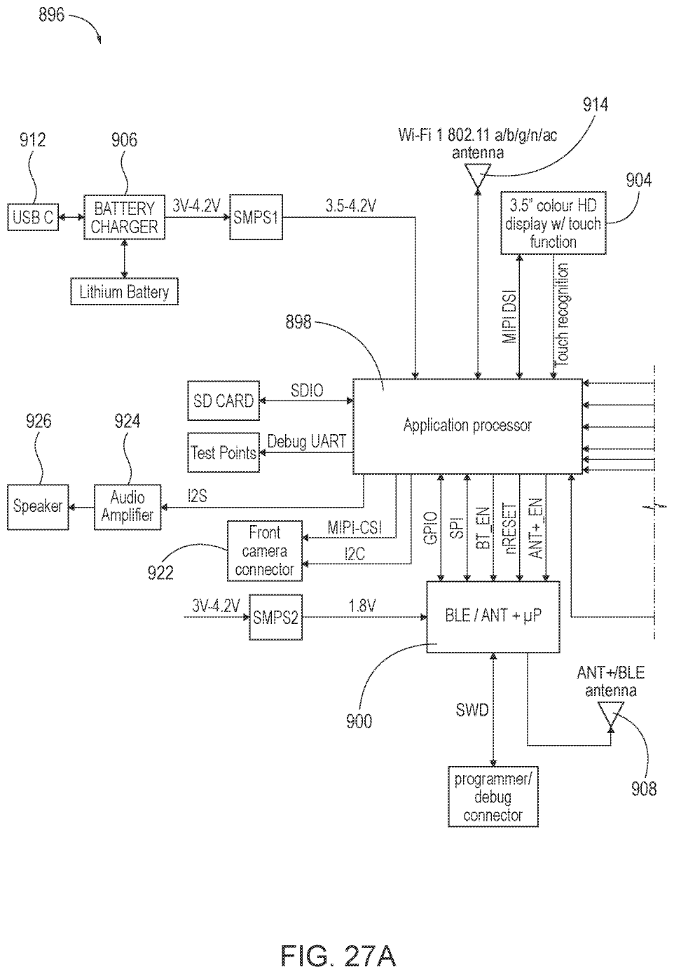

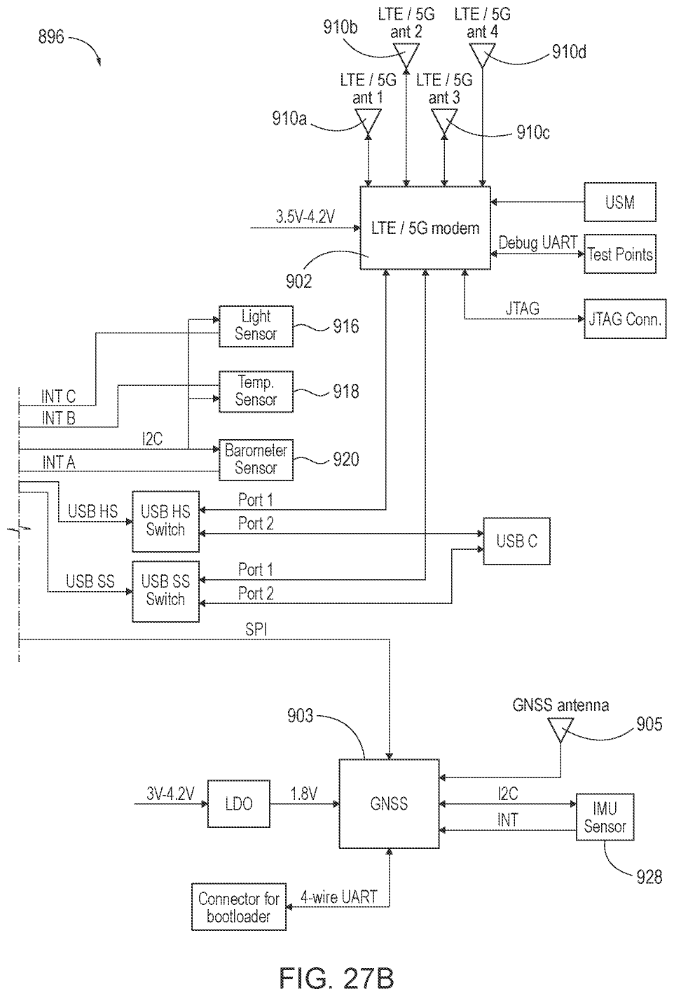

FIGS. 27A-B show a diagram of exemplary dedicated user device hardware architecture 896. FIG. 27B is the right side continuation of the hardware architecture 896 diagram shown in FIG. 27A. As shown, the user device hardware architecture 896 includes an application processor 898, a BLE/ANT+ microprocessor 900, a cellular modem 902 (e.g., LTE/5G), a GNSS receiver 903 (or GPS receiver), a display 904, and a battery 906. As shown, the display 904 may be a 3.5″ color HD touch display. The application processor 898, BLE/ANT+ microprocessor 900, cellular modem 902, and GNSS receiver 903 are coupled to one or more antennas. As shown, the application processor 898 is coupled to a Wi-Fi antenna 914, the BLE/ANT+ microprocessor 900 is coupled to a BLE/ANT+ antenna 908, the cellular modem 902 is coupled to four cellular (LTE/5G) antennas 910a,b,c,d, and the GNSS receiver 903 is coupled to a GNSS antenna 905. In the depicted embodiment, the architecture 896 includes a USB port 912 for charging the battery 906.

The application processor 898 is coupled to one or more sensors. As shown, the application processor 898 is coupled to a light sensor 916, a temperature sensor 918, and a barometer sensor 920. The application processor 898 may be coupled to a front camera of the user device or a front camera connector 922, as shown, that is configured to couple with a camera. The application processor 898 is further coupled to an audio amplifier 924, which is coupled to a speaker 926. The speaker 926 may provide audio feedback from the user device. In some embodiments, a microphone may be included to provide audio input of environmental sounds that may be analyzed and interpreted by the application processor 898 (e.g., to determine type of sound such as children playing, gun shots, braking, etc., and whether the sound is a threat).

The GNSS receiver 903 is coupled to an inertial measurement unit (IMU) sensor 928, which may be configured to measure angular rate, force, magnetic field, and/or orientation. It is contemplated that a GPS receiver or other positioning or navigational device may be included to determine positioning, navigation, timing, and location. The 5G/LTE connectivity may enable online navigation. The data received from the light sensor 916, temperature sensor 918, barometer sensor 920, camera (if included), GNSS receiver 903, and IMU sensor 928 may be safety-related data that is received and analyzed by the application processor 898, as discussed in more detail below with respect to the safety methods.

Returning to FIG. 1, in some embodiments, the safety device(s) 102 may receive safety-related data from the one or more server(s) 108. The one or more server(s) 108 may collect and/or store safety-related data from one or more safety devices 102, sensors 122, automotive vehicle connectivity device(s) 104, user device(s) 106, and database(s) 112 (e.g., third-party databases as discussed in more detail below). In some embodiments, the one or more server(s) 108 may transmit, via the network 110, the safety-related data to the safety device(s) 102, e.g., to the local processing element 116.

The one or more server(s) 108 may include remote processing element(s) configured to process safety-related data. In some embodiments, the remote processing element(s) can determine a relative distance of other entities (e.g., micromobility vehicles, other light mobility vehicles, automotive vehicles, and other user devices (e.g., held by pedestrians)) to a safety device(s) 102, and transmit entity data to the safety device(s) 102 and/or to the one or more user devices 106 (e.g., an associated user device) when the other entities are within a long-distance range. In some embodiments, the remote processing element(s) may determine safety-related data or safety risk data. For example, the remote processing element(s) may determine a collision probability based on entity data received from the safety device(s) 102 and other received entity data (e.g., from automotive vehicle connectivity device(s) 104, user device(s) 106, third-party applications or database(s) 112) and transmit the collision probability to the safety device(s) 102 or the one or more user devices 106. The safety device 102 may factor the entity data or the remotely-determined collision probability received from the remote processing element(s) into the locally determined collision probability.

The one or more databases 112 are configured to store information related to the systems and methods described herein. The one or more databases 112 may include one or more internal databases storing data collected or determined by the system, such as, for example, safety-related data, safety risk or action data, trend data, and the like. As discussed, safety-related data may include, for example, entity data, vehicle data, safety device data, user data, environmental data, sensor data, collision-related data, traffic data, road/surface condition data, and the like, as discussed in more detail below.

The one or more databases 112 may include third-party databases, such as for example, those linked to third-party applications that collect entity data, such as fitness wearables (e.g., Fitbit, Halo, Apple, etc.), training applications (e.g., Under Armor, Strava, TrainingPeaks, etc.), navigational applications (e.g., Apple Maps, Waze, etc.), cycling applications (e.g., Ride GPS, Bike2Peak, etc.), and the like, and/or third-party databases storing safety-related data, such as data related to the environment (e.g., air quality index, heat index, topography, altitude, humidity, temperature, visibility, etc.), weather, traffic, accidents, traffic intersections or signs, laws or ordinances, and the like. For example, road/surface data, collision data, road construction data, or the like may be received from a Department of Transportation database. As another example, traffic data and intersection data may be received from an Iteris database. As yet another example, map and location data, including elevation data, may be received from a Mapbox database or API.

In some embodiments, the system 100 may include one or more sensors 122. The sensor data collected by the one or more sensors 122 may be included in the safety-related data described herein. For example, the one or more sensors 122 may collect data related to position, motion, speed, pressure, contact, environment, weather, object detection, and the like. For example, the one or more sensors 122 may include one or more accelerometers, position sensors (e.g., GPS, GNSS, or the like), motion detectors, haptic sensors, gyroscopes, heading sensors, cameras, infrared sensors, microphones, radars, light sensors, light detection and radars (LIDAR), speed sensors, pressure sensors (e.g., piezoresistive sensor, barometers, etc.), power or energy sensors, thermal sensors, biometric sensors (e.g., heart rate sensors, etc.), odor or air quality sensors (e.g., an electronic nose), and the like. It is contemplated that the one or more sensors may be separate or included in the same sensor device. For example, the one or more sensors may be part of an inertial measurement unit (IMU), which may be configured to measure angular rate, force, magnetic field, and/or orientation. For example, an IMU includes an accelerometer and gyroscope and may also include a magnetometer. It is contemplated that the system 100 may have multiple of the same sensors 122. For example, the system 100 may include multiple cameras for sensing objects (and their proximity, location, motion, acceleration, and/or deceleration, etc.) from multiple angles. For example, a micromobility vehicle may have a front-facing camera and rear-facing camera and/or a user may have a helmet camera or other body camera. It is contemplated that the one or more sensors 122 may include third-party sensors used by third-party systems that are in communication with the system 100 (e.g., Iteris infrastructure sensors, traffic/intersection cameras, car cameras, etc.).

As shown in FIG. 2A, the one or more sensors 122 may be integrated with the safety device 103. It is also contemplated that the one or more sensors 122 are separate from the safety device 103. For example, FIG. 4A is a simplified block diagram of a safety micromobility vehicle 130 with the one or more sensors 122 coupled to or in communication with the micromobility vehicle 132 and in communication with the safety device 103. The one or more sensors 122 may be coupled to one or more parts or systems of the micromobility vehicle 132, such as, for example, a wheel, frame, handlebar/hand grip, seat, camera, light, drive system, gear shift system, brake system, or the like. As one example, the safety micromobility vehicle 130 may be a bicycle with a speed sensor coupled to a wheel of the bicycle for detecting speed of the bicycle. As another example, FIG. 4B is a simplified block diagram of a safety light mobility vehicle 251 with the one or more sensors 122 coupled to or in communication with the light mobility vehicle 253 and in communication with the safety device 103 coupled to the light mobility vehicle 253.

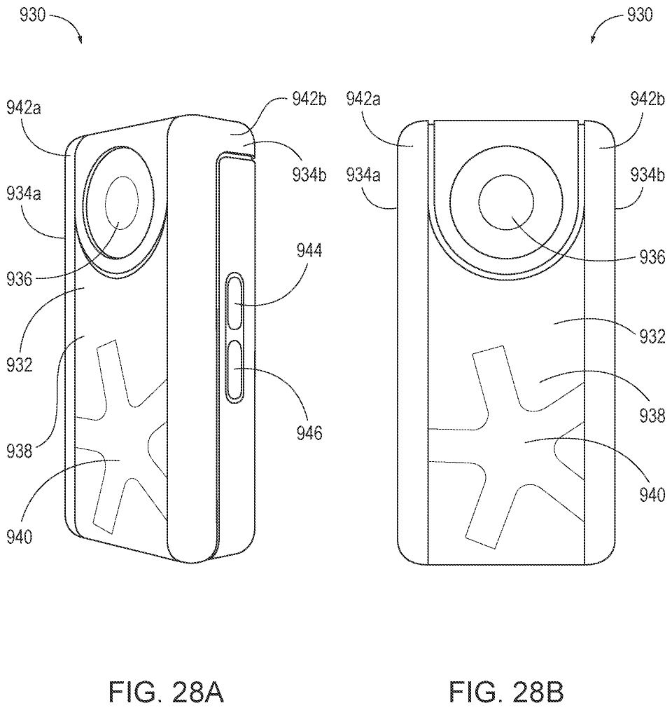

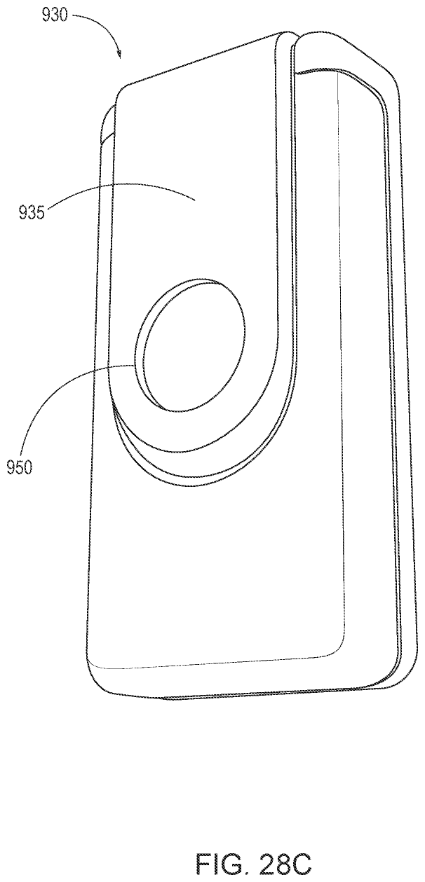

The one or more sensors 122 may be part of a sensor device that is separate from the safety device 103. FIGS. 28A-31 show exemplary sensor devices and sensor device hardware architecture. FIGS. 28A-C show images of an exemplary sensor device 930. The sensor device 930 includes a rear surface 932, side surfaces 934a,b, and a front surface 935. The rear surface 932 may include a camera 936, a reflector 938, and a rear light 940. The side surfaces 934a,b may include side lights 942a,b. As shown, the side surface 934b also includes an ON/OFF button 944 for powering the sensor device 930 on or off and a power port 946 (e.g., USB port) having a port cover 948. The front surface 935 may include a mount interface 950, e.g., to mount the sensor device 930 to a micromobility vehicle or other light mobility vehicle. For example, the mounting interface 950 may be a recess, slot, clip, or the like. The sensor device 930 depicted has a rectangular form factor, but other shapes are contemplated based on the desired positioning of the sensor device 930 on a micromobility vehicle or other light mobility vehicle. It is contemplated that one or more of the camera 936, reflector 938, and light 940 may be omitted from the sensor device 930.

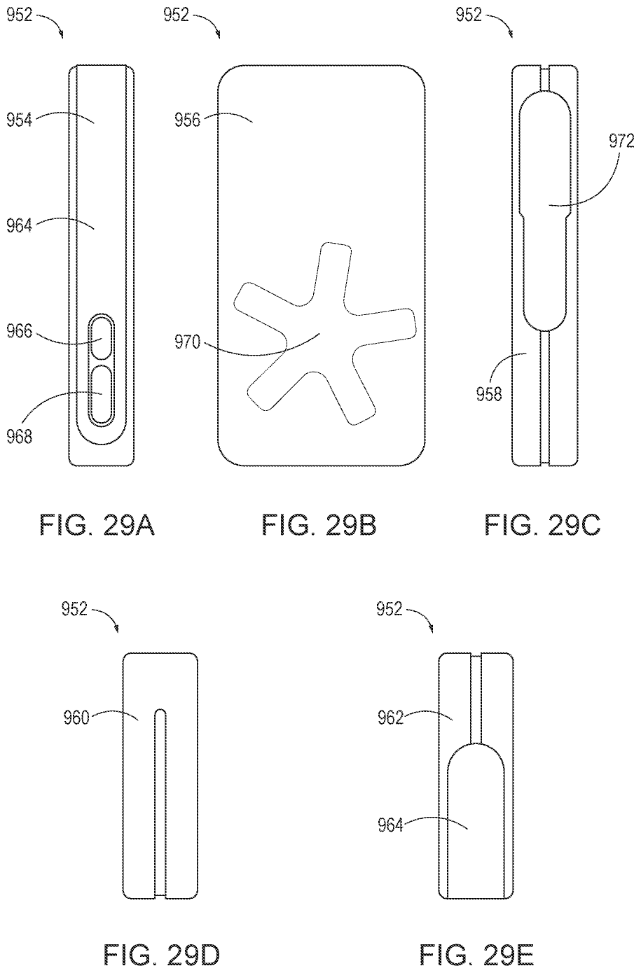

For example, FIGS. 29A-E show images of another exemplary sensor device 952 that has a different form factor, e.g., to fit with a bicycle, and omits a camera. As shown, the sensor device 952 has a rear surface 954, a side surface 956 (the other side surface not shown is a mirror image), a front surface 958, a bottom surface 960, and a top surface 962. The rear surface 954 may include a reflective surface 964, an ON/OFF button 966, and a power port 968 (e.g., USB port). It is contemplated that the reflective surface 964 may include a light (e.g., LED lights). The side surface 956 may include a reflector 970 and/or light. The front surface 958 may include a mount interface 972, e.g., to mount the sensor device 952 to a micromobility vehicle or other light mobility vehicle. As shown, the mount interface 972 is a slot or recess on the front surface 958. The top surface 962 may include a portion of reflective surface 964 or another reflector and/or light.

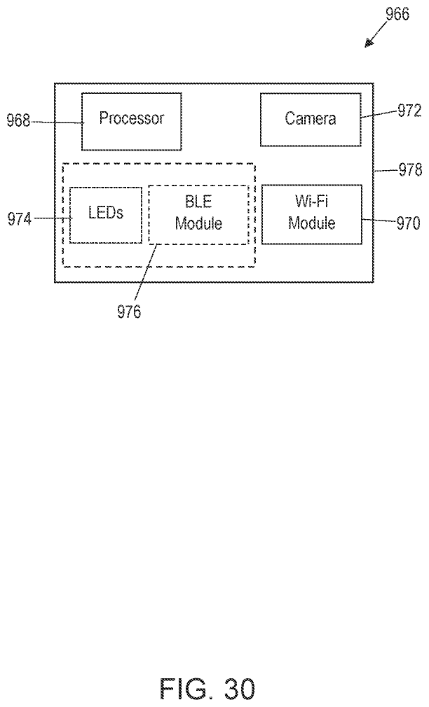

FIG. 30 is a simplified diagram of exemplary sensor device hardware architecture 966 of a sensor device described herein, e.g., of sensor device 930 or sensor device 952. As shown, the sensor device hardware architecture 966 includes a processor 968, a Wi-Fi modem 970, and a camera 972. The sensor device hardware architecture 966 may include LEDs 974 and a BLE modem 976 (and include or omit the camera 972). As shown, the processor 968 and Wi-Fi modem 970 are positioned within a housing 978 that includes the camera 972. The processor 968 and modems 970, 976 may be conventional devices and may be selected based on the form factor and desired power capabilities of the sensor device. The processor 968 may execute local or edge processing for the sensor device, enabling the sensor device to aggregate, store, analyze, and learn from safety-related data received (e.g., received by via the camera 972). For example, the processor 968 may be configured to execute an image processing algorithm to analyze and categorize object data (e.g., to determine hazards or threats). An exemplary processor 968 may be a DNN application processor, which includes object detection and classification capabilities.

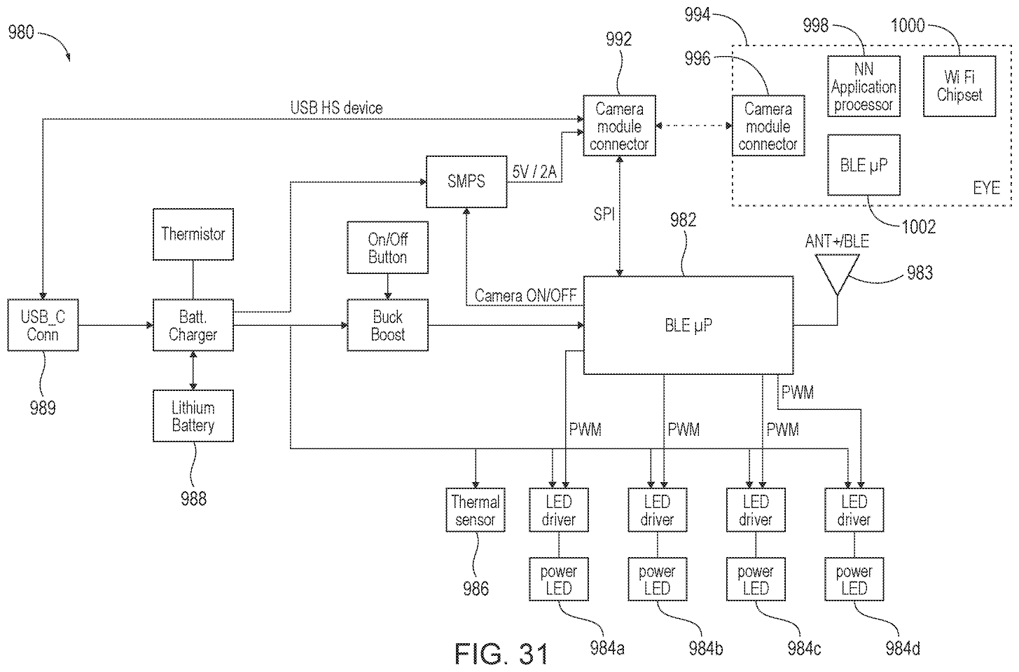

FIG. 31 is a diagram of exemplary sensor device hardware architecture 980. As shown, the sensor device hardware architecture 980 includes a BLE microprocessor 982, a plurality of LEDs 984a,b,c,d, a thermal sensor 986, and a battery 988. The BLE microprocessor 982 may be coupled to an ANT+/BLE antenna 983. In the depicted embodiment, the architecture 980 includes a USB port 989 for charging the battery 988. The sensor device hardware architecture 980 may include a camera module connector 992. The camera module connector 992 may couple with a camera module 994 via a second camera module connector 996. The camera module 994 may include an application processor 998, a Wi-Fi chipset 1000, and a camera BLE microprocessor 1002.

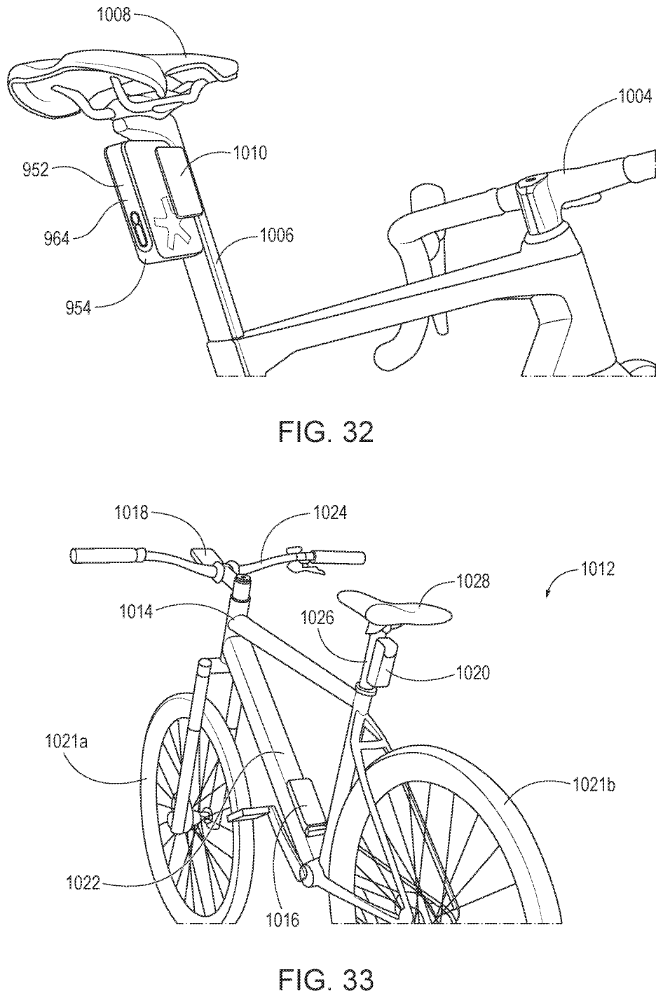

A sensor device described herein may be coupled to a micromobility vehicle or other light mobility vehicle and in communication with a user device described herein, e.g., a dedicated user device 850, 864. FIG. 32 shows an image of an exemplary positioning of the sensor device 952 on a bicycle 1004. As shown, the sensor device 952 is positioned on a seat post 1006 of the bicycle 1004 underneath the seat 1008. The mount interface 972 of the sensor device 952 is coupled to a mount 1010 on the seat post 1006 such that the rear surface 954 and reflective surface 964 are rear-facing away from the bicycle 1004 to alert oncoming entities of the cyclist. In embodiments where the rear surface 954 includes a light, the light may be varied (e.g., by intensity or frequency of flashing) to alert an oncoming entity. For example, the light may flash more frequently or brighter as an entity gets closer to the bicycle 1004. As another example, the light may flash on the left side to indicate the bicycle 1004 is turning left or flash on the right to indicate a right turn (e.g., based on user input or a pre-determined route). The lights may also flash as an anti-theft mechanism. It is contemplated that the sensor device 930 may be mounted on the bicycle 1004 in a similar manner with the camera 936 rear-facing away from the bicycle 1004. In these embodiments, the camera 936 may capture image data behind the bicycle 1004 and transmit feedback (e.g., streaming video) or an alert to a user device (e.g., user device 850, 864).

A sensor device described herein may implement machine learning, including object detection, classification, and distance estimation, hazard generation and signaling, and sensor data fusion. A disclosed sensor device may implement video streaming and recording (e.g., 5 seconds loop recordings). The sensor device may detect objects within a particular distance range, such as, for example, within 100 m, 90 m, 80 m, 70 m, 60 m, 50 m, or the like, depending on the camera that is integrated with the device. The camera may be any conventional camera, such as, for example, a monocular camera. The sensor device may classify an object detected within a particular distance. For example, the sensor device may classify an object as a particular type of entity, e.g., a truck, bicycle, bus, pedestrian, or the like. The sensor device may detect, classify, and estimate the distance of objects with greater than 70% accuracy. In some embodiments, the sensor device may determine a hazard is present and initiate the camera to start streaming video, which is transmitted to the user device (or to a safety device having feedback components). The sensor device may transmit object data or hazard data to a connected user device 106 or to the one or more servers 108 or to a safety device 102 over the network 110.

The sensor device may have a large field of view (FOV) to enable vision of the surroundings around a user. For example, the sensor device may have a FOV of 110 degrees, enabling a user to see behind them. The sensor device may include image stabilization to ensure the image recorded is visible and stable (e.g., despite movement of the micromobility vehicle or other light mobility vehicle).

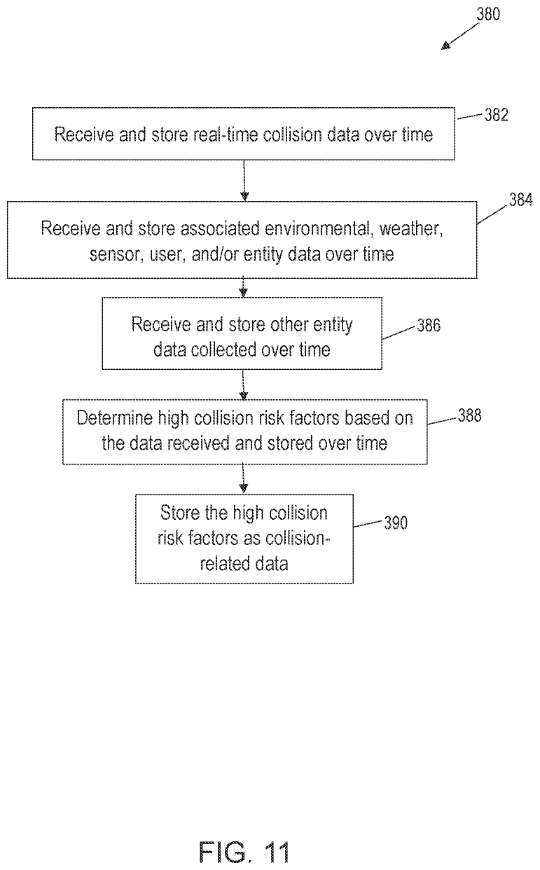

The one or more sensors 122 may transmit sensor data to the safety device(s) 102, e.g., to the local processing element 116, and/or to the server(s) 108, e.g., to the remote processing element. In some embodiments, the local processing element 116 may factor data received from the one or more sensors 122 into the determined the collision probability or other determined safety risks. In some embodiments, the one or more sensors 122 may transmit collected data to the one or more servers 108, via the network 110, which can be stored in the one or more databases 112. In these embodiments, the one or more servers 108 may factor sensor data received from the one or more sensors 122 into safety-related data or safety risk data determined and/or analyzed by the one or more servers 108. For example, the one or more servers 108 may factor sensor data into the remotely-determined collision probability. In some embodiments, the one or more servers 108 receive sensor data along with real-time collision data and store the sensor data associated with the real-time collision data, as discussed in more detail with respect to method 380 of FIG. 11.

In some embodiments, the one or more sensors 122 may receive or determine alert signals based on the safety-related data. For example, a light may flash based on safety-data received to alert a user of an oncoming hazard. The one or more sensors 122 may have integrated artificial intelligence and generate a signal or transmit data when a particular event or circumstance is present. As an example, an AI-integrated light may interpret safety-related data as indicative of a hazard or dangerous condition and flash to alert a user. As another example, an AI-integrated microphone may interpret a sound as dangerous and transmit an alert.

In several embodiments, the system 100 includes a system architecture that autonomously transitions between different communication protocols based on context or certain conditions being present to provide more robust, accurate, and timely safety-related data. For example, the system 100 may switch between different communication protocols based on the distance between entities. For example, when a light mobility vehicle is within a short-distance range to another vehicle, safety-related data (e.g., entity data) may be transmitted via a safety device 102 (e.g., a C-V2X chip), and when the light mobility vehicle is outside the short-distance range (e.g., within a long-distance range) relative to another vehicle, safety-related data (e.g., entity data) may be transmitted via a server 108 (e.g., over a cellular network, such as 3G, 4G, 5G, or the like). The safety-related data (e.g., entity data) may be received from one or more sensors 122 (e.g., a GPS sensor) in communication with the safety device 102 and/or server 108 and/or determined by the system (e.g., a relative position may be calculated based on data received from a camera, e.g., within a short distance, e.g., less than 50 m). For example, a GPS sensor may be coupled to the light mobility vehicle and may transmit location data to a safety device 102 coupled to the light mobility vehicle and/or to the server 108. The safety device 102 may transmit the location data to another safety device 102 within a short-distance range (e.g., via a C-V2X chip) or to the server 108 to transmit to another entity within a long-distance range (e.g., over a cellular network).

In several embodiments, the system architecture normalizes entity data collected from the safety device 102 and the other sensor(s) 122 to recognize the entity data as coming from a single user. In this manner, the system 100 can correlate entity data related to vehicles within a short-distance range and entity data related to vehicles within a long-distance range to provide a comprehensive position landscape of other vehicles relative to a user.

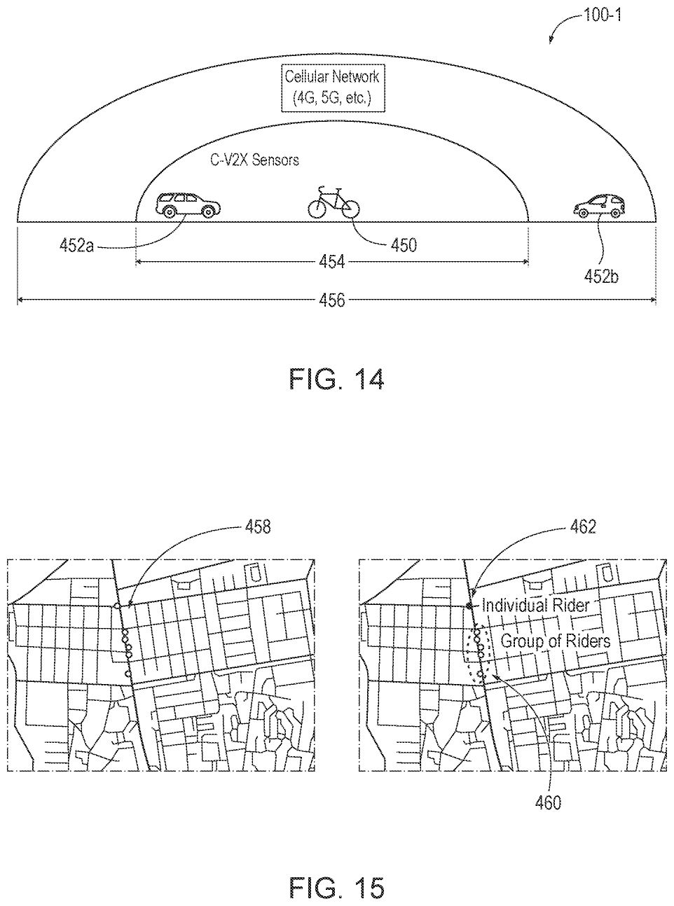

FIG. 14 shows an illustration of an exemplary safety system 100-1 that employs such system architecture. As shown, the system 100-1 includes different communication protocol that operate within different distances relative to a smart bicycle 450. As shown, data is transmitted and received via C-V2X sensors within a short-distance range 454, and data is transmitted and received via a cellular network (e.g., 4G or 5G) within a long-distance range 456. In the depicted example, a smart bicycle 450 includes a C-V2X chip and a GPS sensor. The GPS sensor calculates the position of the smart bicycle 450 and sends this entity data to the C-V2X chip, which operates within a short-distance range 454 to transmit the entity data collected from the GPS sensor and receive entity data from another vehicle (e.g., from a vehicle connectivity device) within the short distance-range 454, such as the first vehicle 452a. When a vehicle is outside the short-distance range 454 and within a long-distance range 456, such as the second vehicle 452b, entity data is no longer received and transmitted via the C-V2X chip, rather, entity data (e.g., as determined by a GPS sensor associated with the second vehicle 452b) is received by the smart bicycle 450 via a cellular network (e.g., 5G network). When the second vehicle 452b comes within the short-distance range 454 relative to the smart bicycle 450, the smart bicycle 450 can detect the relative location of the second vehicle 452b based on the information received via the C-V2X chip. By using the C-V2X chip to detect vehicles within the short-distance range 454, latency in data exchange between the vehicles is reduced such that real-time collisions can be avoided as the vehicles move closer to one another.

Latency in data exchange that results from exchange of data via the one or more servers 108 or cloud may also be mitigated by additional data inputs received from the one or more sensors 122. For example, sound data may be received from a sensor (e.g., microphone) that can be analyzed by the safety device or user device processor to determine proximity of objects. Additionally or separately, visual data may be received from a sensor (e.g., a camera) that can be analyzed (e.g., by a sensor device disclosed herein) to determine proximity of objects. This sensor data may be aggregated with the entity data received by a C-V2X modem of the safety device to determine object proximity with greater accuracy. The aggregated data may be transmitted to a user device to provide feedback to a user with reduced latency.

FIG. 33 shows an image of an exemplary micromobility vehicle (MV) safety system 1012 integrated with a bicycle 1014. The MV safety system 1012 may be part of safety system 100. As shown, the MV safety system 1012 includes a safety device 1016, a user device 1018, and a sensor device 1020. The safety device 1016, user device 1018, and sensor device 1020 may be any of the various devices described herein, for example, safety device 800, user device 850 or 864, and sensor device 930 or 952. In the depicted embodiment, the safety device 1016 is positioned near the base of the bicycle 1014 between the wheels 1021a,b, the user device 1018 is positioned on a front end of the bicycle 1014, and the sensor device 1020 is positioned on a rear end of the bicycle 1014. Specifically, the safety device 1020 is positioned on the down tube 1022, the user device 1018 is positioned on the handlebars 1024, and the sensor device 1020 is positioned on the seat post 1026 below the seat 1028. It is contemplated that one or more of the safety device 1020, user device 1018, and sensor device 1020 may be omitted from the MV safety system 1012. In some embodiments, e.g., where the safety device 1020 is omitted, the user device 1018 may be configured to execute the same logic as safety devices described herein. For example, the user device 1018 may transmit and receive safety-related data (e.g., BSM such as position, speed, heading, etc.) to and from other system 100 devices (e.g., one or more user devices 106 or automotive vehicle connectivity devices 104) via network 110. The user device 1018 may execute one or more of the methods described herein to determine whether the safety-related data (e.g., BSM) received is indicative of a safety risk or threat.

As discussed above, the safety device 1016, user device 1018, and sensor device 1020 may include one or more sensors. For example, the user device 1018 may include a camera that is front-facing on the bicycle 1014 and the sensor device 1020 may include a camera that is rear-facing on the bicycle 1014, providing improved visibility to the micromobility vehicle (e.g., for object detection and risk/threat assessment around the micromobility vehicle).

FIG. 34 is a simplified block diagram of a safety system 1030 that can be integrated with a micromobility vehicle or other light mobility vehicle. As shown, the safety system 1030 includes a safety device 1032, a user device 1034, and a sensor device 1036. The safety device 1032, user device 1034, and sensor device 1036 may be any of the various devices described herein, for example, safety device 800, user device 850 or 864, and sensor device 930 or 952. As shown, the safety device 1032 may be in communication with one or more external sensors 1038 (e.g., a camera, light, etc.). As shown, the safety device 1032 communicates with the user device 1034 and with the sensor device 1036 via BLE and/or Wi-Fi. In embodiments where external sensors 1038 are included, the safety device 1032 may communicate with the external sensors 1038 via BLE/ANT+. The sensor device 1036 may communicate with the user device 1034 via Wi-Fi and/or BLE. The safety system 1030 is intended for illustrative purposes and other communication protocols are contemplated between the various devices.

In several embodiments, the user device 1034 receives feedback from the safety device 1032 and sensor device 1036 related to safety risks or threats. For example, the sensor device 1036 may transmit streaming video data to the user device 1034. For example, sensor device 930 may be mounted on a bicycle such that the camera 936 is rear-facing and captures video of the environment behind the bicyclist. As discussed above, the sensor device 930 may process the image data and determine whether an object is a threat. If the sensor device 930 determines the object is a threat, the sensor device 930 may transmit an alert to the user device 1034. The sensor device 930 may transmit the threat data (e.g., the type of threat and location) to the cloud for storage. The cloud or remote processing element may map the threat (e.g., type and location) to a map interface and transmit the mapped threat to other user devices 106 in the system 100.

The user device 1034 may receive user input to determine additional threats, which can help the safety system 1030 improve machine learning algorithms. For example, the user device 1034 may allow a user to select an option to capture image data where the user detects a threat. For example, the user may view a pothole or other road hazard on the incoming streaming video input and select a button on the user device 1034 to capture the image data and report it as a safety risk or threat. The user device 1034 may transmit the image data to the cloud for additional processing and storage. For example, the cloud or remote processing element may store the image data with location and/or time data as a safety risk or threat.

The user device 1034 may track the user's location (e.g., via GNSS 903 depicted in FIG. 27) and transmit location data to the cloud or server. The cloud may transmit relevant safety-related data to the user device 1034 based on the user's location. For example, the user device 1034 may receive an alert from the remote processing element based on the user's location matching a location associated with a known safety risk (e.g., based on location data stored in association with the safety risk or threat).

The user device 1034 may also receive feedback from the sensor device 1036. For example, the user device 1034 may receive an alert based on the sensor device 1036 detecting an entity in close proximity (e.g., based on an exchange of data between C-V2X modems).

It is contemplated that one or more of the system 100 components may provide feedback to a user, e.g., alerts of safety risks and/or safe actions, including, for example, collision probability or proximity, distance, path, etc. of other vehicles, as described in more detail below with respect to safety devices. For example, the feedback may be haptic, visual, audible, or the like. For example, feedback may be transmitted to a user by one or more of a user device of the one or more user devices 106, a safety device of the one or more safety devices 102, and a sensor of the one or more sensors 122. It is contemplated that the feedback may be transmitted by a separate feedback device in communication with the components of system 100. For example, feedback may be transmitted by a separate haptic device (e.g., in the handlebars, seat, helmet, etc.), a sound device/speaker, ear buds/headphones, smartwatch, and the like.

In several embodiments, the system 100 is designed to be functionally safe. Functional safety is highly standardized in the automotive industry (e.g., with standard ISO26262), but not in the micromobility industry. The system 100 may be configured to provide functional safety, reliable operation, and performance and status updates for micromobility vehicles or other light mobility vehicles. For example, the system 100 may provide a user alert indicative of a fault or degradation in system performance. In several embodiments, by incorporating the safety software described herein on dedicated safety devices and/or user devices, safety systems described herein avoid problems of existing smartphone applications that can fail due to other installed applications and programs. Safety systems described herein may be controlled and shielded from unexpected failure.

### Safety Devices

FIGS. 2A-B and 21A-23B show exemplary safety devices of the one or more safety devices 102 and exemplary safety device hardware architecture that can be used with the system 100. FIGS. 2A-B show a simplified diagram and image of an exemplary safety device 103. As shown, the safety device 103 may include a connectivity module 114, a local processing element 116, a housing 118, and a power source 120. In some embodiments, the safety device 103 may include one or more sensors 122, as shown in FIG. 2A, or the safety device 103 may be in communication with one or more external sensors 122, as shown in FIGS. 2B and 4.

As discussed above and shown in FIG. 3, the connectivity module 114 may include one or more connectivity devices 126a,b, such as a first connectivity device 126a and second connectivity device 126b. The connectivity devices 126a,b may include one or more of a V2X chipset or modem (e.g., C-V2X chip), Wi-Fi modem, Bluetooth (BLE) modem, Cellular modem (e.g., 5G), Ant+ chipset, and the like. As discussed in more detail above, the connectivity module 114 may receive and transmit safety-related data (e.g., entity data) to other connectivity devices within the network 110, such as other safety devices 102 and/or automotive vehicle connectivity devices 104. For example, the connectivity module 114 or devices 126a,b may receive and transmit Basic Safety Messages (BSM) that include entity data, such as an entity's position, speed, and heading. In embodiments where the connectivity module 114 includes a C-V2X chip, the C-V2X chip may use a GPS and IMU to determine position and speed of the entity, respectively. In some embodiments, one or more of the connectivity devices 126a,b may be separate from the safety device 103, and included with a separate component of the light mobility vehicle, such as, for example, a camera, light, display, frame component, and the like. For example, a display and/or rear camera attached to a bicycle may include a cellular modem, and the safety device 103 may include a C-V2X chip.

As discussed above, the local processing element 116 may be in communication with the connectivity module 114 and may receive safety-related data (e.g., entity data) from the connectivity module 114 and/or a sensor (e.g., GPS). For example, entity data may include data related to one or more of location, speed, acceleration, deceleration, heading, distance, time, entity type, and the like of the safety device 103, one or more other safety devices 102, and/or one or more automotive vehicle connectivity devices 104. For example, the local processing element 116 may receive the BSM received by the connectivity module 114 (e.g., position and speed of another entity). The local processing element 116 may determine safety-related data. For example, in embodiments with a C-V2X chip, the local processing element 116 may determine heading based on position and speed determined by the C-V2X chip. The heading may be transmitted with the position and speed by the C-V2X chip as a BSM to a C-V2X chip of another entity. The local processing element 116 may execute one or more of the methods described herein (e.g., the methods described below with respect to FIGS. 7-13, 16-19, and 35). For example, the local processing element 116 may determine certain actions or scenarios based on the safety-related data received. For example, the local processing element 116 may determine a risk scenario as defined in SAE J2945/J3161 based on the BSM communication, including, for example, blind spot warning, intersection movement assist, and the like. The local processing element 116 may be software on a chip (SOC) and may include a C-V2X stack and/or intelligent transport system (ITS) stack and safety application software described herein.

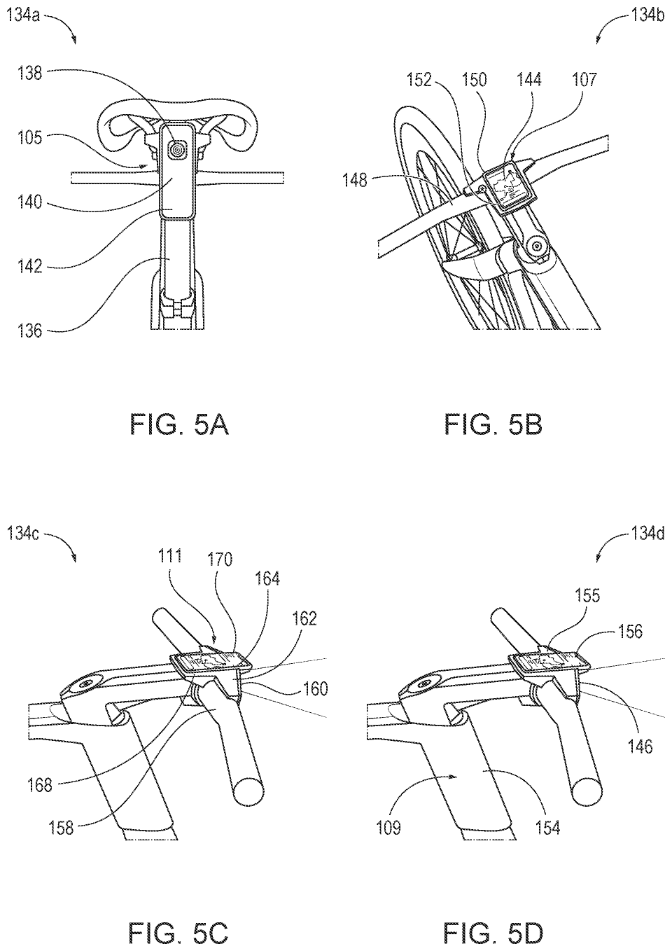

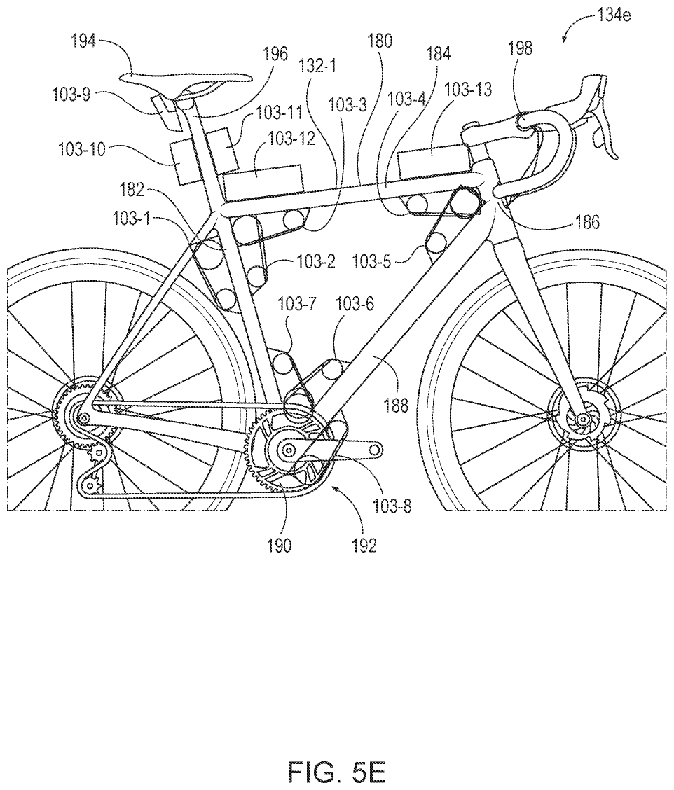

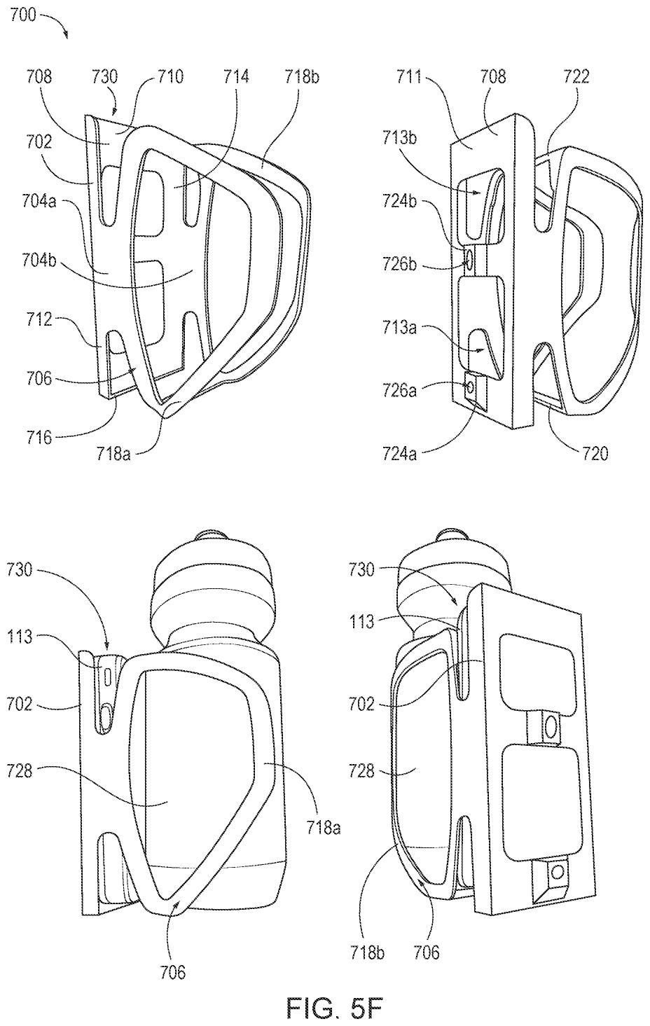

The safety device 103 may include a housing 118 that contains the connectivity module 114 and the local processing element 116. The housing 118 may couple the safety device 103 to the micromobility vehicle 132 (FIGS. 4A, 5A) or to a light mobility vehicle 253 (FIG. 4B). For example, the housing 118 may be coupled to a component or system of the micromobility vehicle 132 or light mobility vehicle 253, e.g., contained within a component or system (e.g., inside a seat post of a bicycle) or coupled to an outer surface of the micromobility vehicle 132 (e.g., an outer surface of the bicycle seat post) or light mobility vehicle 253. It is contemplated that the safety device 103 may be a fixed feature of or removable from a micromobility vehicle 132 or light mobility vehicle 253. In some embodiments, the housing 118 is omitted and the various components of the safety device 103 are integrated with a micromobility vehicle or other light mobility vehicle.

The housing 118 may have a form factor that is compatible with a form factor of a component or system of the micromobility vehicle or other light mobility vehicle to couple to the component or system. For example, the exemplary safety device 103 shown in FIG. 2B has a cylindrical form factor. This cylindrical form factor may be compatible with a cylindrical micromobility vehicle component, such as, for example, a seat tube (e.g., a seat tube 136 for a safety bicycle 134a shown in FIG. 5A), frame, handlebar, handlebar tube (e.g., on an electric scooter), and the like. It is also contemplated that the housing 118 may have a form factor compatible with other micromobility vehicle components, e.g., a light (e.g., light 146 depicted in FIG. 5C), camera (e.g., camera 138 depicted in FIG. 5A), deck (e.g., on an electric scooter), water bottle holder (e.g., the water bottle holder 700 depicted in FIG. 5F), or systems, e.g., automatic gear shift, to couple with such components or systems. As one example, the housing 118 may have a rectangular and/or relatively flat or thin form factor compatible with a form factor of a light, deck, or water bottle holder (e.g., as depicted in FIG. 5F). It is contemplated that the housing 118 may be coupled on an external surface of a micromobility vehicle or other light mobility vehicle and the safety device 103 may be coupled to a system via a cable/wire or a communication means (e.g., Wi-Fi, BLE, etc.).

In one embodiment, the housing 118 includes a cylindrical form factor enabling the safety device 103 to fit inside a seat tube of a bicycle. By including the safety device 103 in the seat tube, the safety device 103 can easily be installed and removed, and accessed for charging or repair. In another embodiment, the housing 118 includes a rectangular form factor enabling the safety device 103 to fit inside a safety device compartment of a water bottle holder, as described in more detail below with respect to FIG. 5F.

As shown in FIG. 2B, the housing 118 may include one or more rings around an outer surface 119 of the housing 118 to protect the safety device 103 from wear or damage. In the example depicted, the housing includes two grommets 124a,b coupled to the outer surface 119 of the housing 118 near either end of the housing 118. The grommets 124a,b may be made of metal, plastic, or rubber. The diameter of the grommets 124a,b may be sized to be compatible with the component to which the safety device 103 will be coupled (e.g., inserted into). As one example, the diameter of the grommets 124a,b may be between 27 mm and 32 mm (e.g., 27.2 mm or less, 30.9 mm or less, or 31.6 mm or less) to fit the diameter of a bicycle seat post.

The housing 118 may be made of a durable material capable of limiting damage and wear. For example, the housing 118 may be made of metal (e.g., steel, iron, carbon, and the like), rubber, and/or a durable plastic (e.g., acrylonitrile butadiene styrene (ABS), polycarbonate, PVC, PPSU, UHMW, and the like). In several embodiments, the housing 118 is made of a waterproof and/or dustproof material. For example, where the housing 118 is coupled to an outer surface of the micromobility vehicle 132 or other light mobility vehicle 253, a waterproof and/or dustproof material prevents damage from various environmental factors, such as rain, sleet, snow, or hail, and prolongs the life of the safety device 103.

The safety device 103 may include a power source 120 coupled to the connectivity module 114 and the local processing element 116 to provide power for their operation. For example, the power source 120 may be any conventional power source, such as a battery, solar power source (e.g., cell), kinetic power source, or other portable power source. The power source 120 may be contained within the housing 118 (e.g., a battery) or coupled to an outer surface 119 of the housing 118 (e.g., a solar power source). In some embodiments, the power source 120 may be omitted. In some embodiments, the power source 120 is a component of a micromobility vehicle or other light mobility vehicle, e.g., the power source 120 is a battery of the light mobility vehicle (e.g., a battery that powers an electric motor).

The one or more sensors 122 may include one or more of GPS, beacon, accelerometer, motion detector, camera, microphone, light sensor, heading sensor, radar, or other sensor capable of detecting a state or condition of the light mobility vehicle 253 (e.g., location, position, motion, speed, acceleration, deceleration, heading, nearby objects, etc.) and/or environmental factors (e.g., moisture, humidity, pressure, temperature, wind, precipitation, etc.). In several embodiments, a camera (or multiple cameras) provides a 360 degree view of the surroundings around the user. The one or more sensors 122 may be coupled to the housing 118, e.g., contained within the housing 118 or coupled to an outer surface 119 of the housing 118. In the exemplary safety device 105 depicted in FIG. 5A, a rear facing camera 138 is coupled to an outer surface 140 of the housing 142. In this example, the camera 138 may detect motion or objects behind the cyclist that the cyclist would not otherwise be made aware of.

In some embodiments, as shown in FIGS. 4A-B, the one or more sensors 122 may be coupled to one or more components of the micromobility vehicle 132 or light mobility vehicle 253 and in communication with the safety device 103. In the exemplary micromobility vehicle shown in FIG. 5D, a light 146 may include a light sensor that is separate from the exemplary collision detection device 109 contained in the head tube 154. In this example, the light sensor can detect when light conditions are poor (e.g., getting dark, fogging, etc.), and, in some embodiments, is configured to turn the light on when light conditions are poor (depending on user preferences).

The local processing element 116 may receive sensor data from the one or more sensors, such as, for example, data on location/position, motion, speed, acceleration, deceleration, rotation, heading, nearby objects, light conditions, moisture, humidity, pressure, temperature, wind, precipitation, and the like. The local processing element 116 may aggregate the sensor data and other safety-related data (e.g., entity data) collected to determine one or more safety risk factors (e.g., a collision probability), as discussed in more detail below with respect to method 200 of FIG. 7. As discussed above, the sensor data may be transmitted, via the network 110 to the one or more servers 108 and stored in the one or more databases 112 or used by the one or more servers 108 in aggregating, analyzing, determining, and/or storing safety-related data (e.g., calculating a collision probability).

Returning to FIG. 2A, in some embodiments, the safety device 103 includes one or more feedback components 123 for providing feedback to a user, e.g., alerts of safety risks and/or safe actions, including, for example, collision probability or proximity, distance, path, etc. of other vehicles. The one or more feedback components 123 may provide feedback to the user of the safety device 103 or to other users. The one or more feedback components 123 may include components configured to provide visual, haptic, and/or audible feedback. For example, the one or more feedback components 123 may include one or more of a display/GUI, a light/LED, a haptic device, a sound device/speaker, and the like. However, it is contemplated that the feedback components 123 may be omitted from the safety device 103, e.g., separate components in communication with the safety device 103 (e.g., a light in communication with the safety device 103, a display on a user device, third-party devices such as ear buds or smartwatches, haptic feedback elements integrated into a micromobility vehicle component such as handlebars, seat, helmet, etc.). For example, a portable safety device 103 may include a display for providing feedback to a user, e.g., to be used with a vehicle that is without connectivity capabilities. As another example, a portable safety device 103 may be in communication with a smart display in a vehicle and may provide additional connectivity to the vehicle. For example, the vehicle may already have C-V2X technology integrated and the safety device 103 may improve visibility of safety hazards by providing additional safety-related data from the cloud (and aggregating the remote safety-related data with the local data).

In some embodiments, the safety device 103 includes one or more input components 125 that enable a user to provide input to or to control the safety device 103. For example, the one or more input components 125 may include one or more of a display/GUI, a microphone, buttons, switches, remote controls, and the like. For example, the display may be a capacitive or resistive touch screen, or may include both capacitive and resistive elements. As an example, a resistive touch screen may allow the display to be used with a glove.

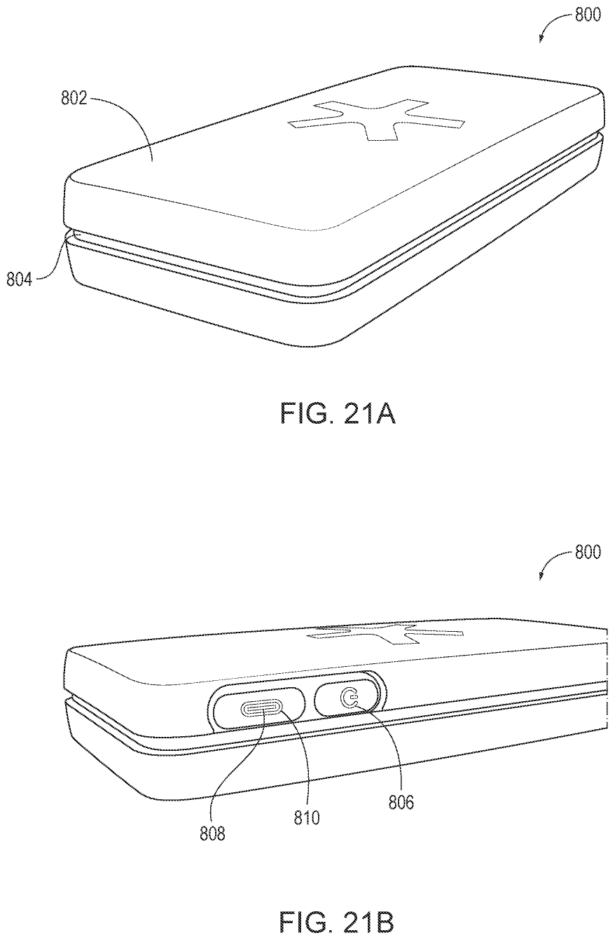

FIGS. 21A-23B will now be described in more detail. FIGS. 21A-B show images of an exemplary safety device 800. As shown, the safety device 800 includes a housing 802, a light 804, an ON/OFF button 806, and a power input 808. The housing 802 has a rectangular-shaped form factor. The light 804 is recessed in the housing 802. As shown, the light 804 is recessed around the sides of the housing 802. For example, the light 804 may be an LED strip. As discussed in more detail below, the light 804 may be selectively turned on and off and varied in intensity or frequency of flashing to transmit an alert and message to a user (e.g., indicative of a threat). The light 804 may also function as an anti-theft mechanism. For example, the light 804 may be turned on or flash with a certain intensity and frequency when the micromobility vehicle is moved. It is contemplated that the light 804 positioning may be varied and that the light 804 may be omitted. As shown, the ON/OFF button 806 is positioned on a side of the housing 802 allowing the safety device 800 to be turned on or off, e.g., to conserve power or disconnect the safety device 800 (and user) from other entities. The power input 808 may be positioned on a side of the housing 802. The power input 808 may be configured to power a battery positioned inside the housing 802. The power input 808 may be a USB port. It is contemplated that the USB port may also be used to extract data from the safety device 800 (e.g., for servicing or collecting stored data locally). As shown, the power input 808 has a cover 810 to protect the power input 808 from debris and damage.

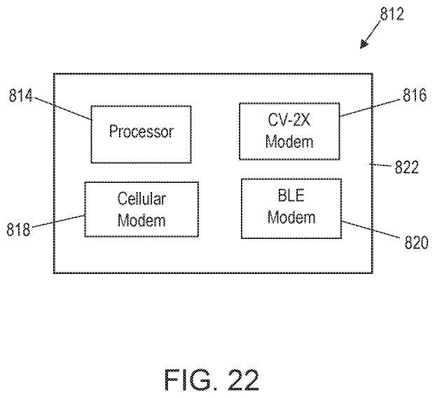

FIG. 22 is a simplified diagram of exemplary safety device hardware architecture 812 of a safety device described herein, e.g., of safety device 103 or safety device 800. As shown, the safety device hardware architecture 812 includes a processor 814, a C-V2X modem 816, a cellular modem 818, and a Bluetooth Low Energy (BLE) modem 820. The processor 814 and modems 816, 818, 820 are positioned within a housing 822. The processor 814 and modems 816, 818, 820 may be conventional devices and may be selected based on the form factor and desired power capabilities of the safety device. An exemplary processor 814 is a Qualcomm® SA2150P application processor. As discussed in more detail below, the processor 814 may execute local or edge processing for the safety device, enabling the safety device to aggregate, store, analyze, and learn from safety-related data received (e.g., received by one or more of the modems 816, 818, 820). An exemplary C-V2X modem 816 may be Quectel C-V2X AG15 or Qualcomm® C-V2X 9150. The C-V2X modem 816 may communicate with other C-V2X modems within a short distance (e.g., to transmit and receive position data approximately 10 times per second). An exemplary cellular modem 818 may be an LTE or 4G modem. As an example, the cellular modem 818 may be Quectel EG95 or BG95. The cellular modem 818 may enable the safety device to transmit and receive information from the one or more servers 108, which may be used by the processor 814. An exemplary BLE modem 820 is a Nordic® nRF52. The BLE modem 820 may enable the safety device to communicate with other local devices (e.g., a local sensor device or user device as described with respect to FIGS. 33 and 34).

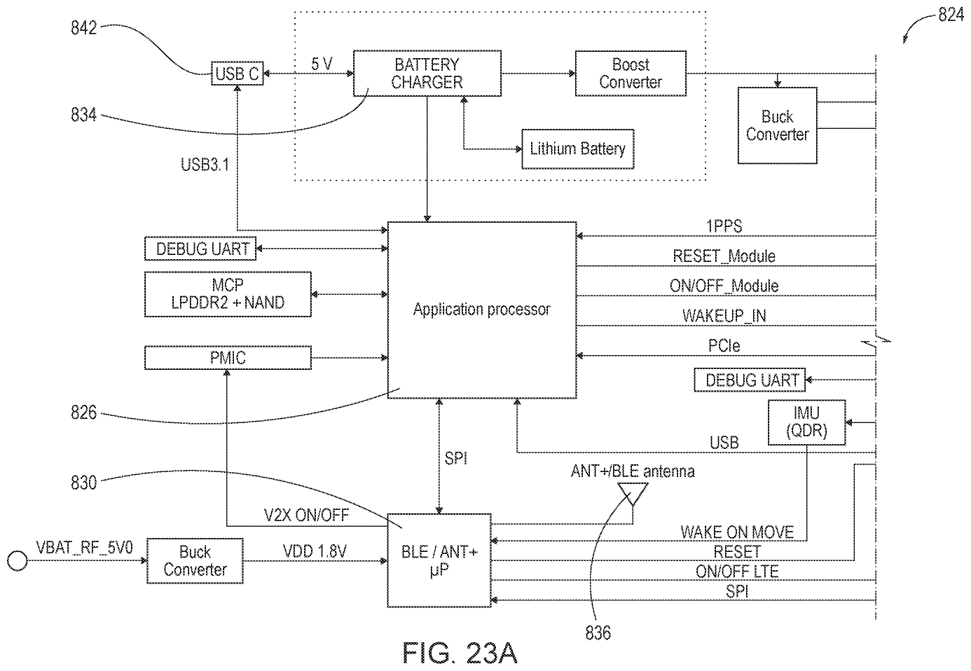

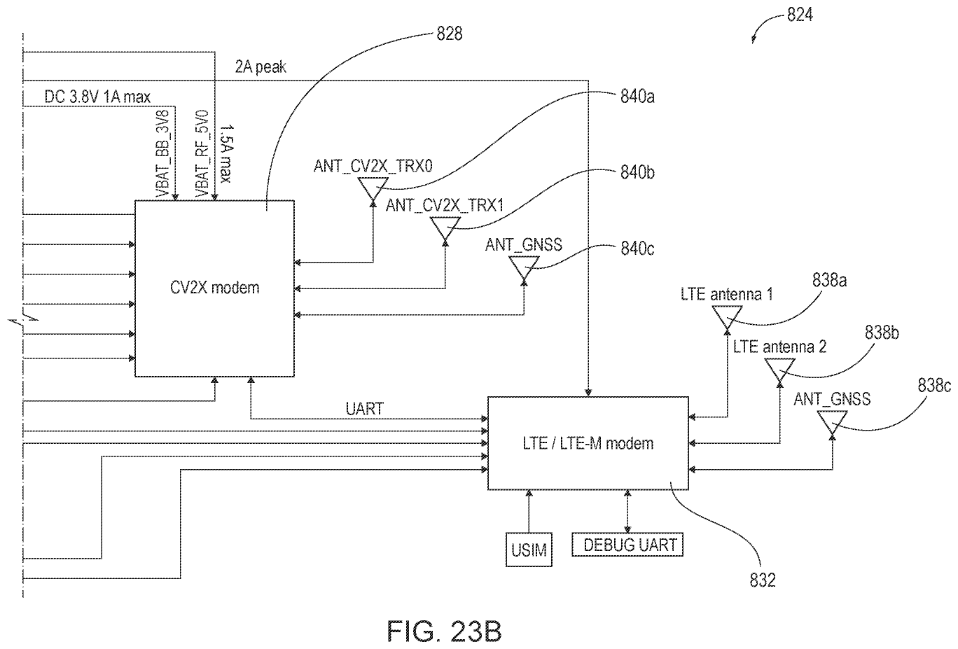

FIGS. 23A-B show a diagram of exemplary safety device hardware architecture 824. FIG. 23B is the right side continuation of the hardware architecture 824 diagram shown in FIG. 23A. As shown, the safety device hardware architecture 824 includes an application processor 826, a C-V2X modem 828, a BLE/ANT+ microprocessor 830, and a cellular modem 832 (e.g., LTE/LTE-M), and a battery 834. The C-V2X modem 828, BLE/ANT+ microprocessor 830, and cellular modem 832 are coupled to one or more antennas. The antennas may be located in an area of the safety device that is selected to reduce interference and conform to the form factor of the safety device. As shown, the BLE/ANT+ microprocessor 830 is coupled to a BLE/ANT+ antenna 836, the cellular modem 832 is coupled to three cellular (LTE) antennas 838a,b,c, and the C-V2X modem 828 is coupled to three C-V2X antennas 840a,b,c. One or more antennas may be positioned within the housing 852. In the depicted embodiment, the architecture 824 includes a USB port 842 for charging the battery 834. It is contemplated that the safety device hardware architecture 824 may include one or more sensors 122 (e.g., a GPS, camera, light, microphone, IMU, etc.).

FIGS. 5A-F will now be described in more detail. FIGS. 5A-F show exemplary safety device positioning relative to micromobility vehicles and their components. Specifically, the micromobility vehicles depicted in FIGS. 5A-E are safety bicycles 134a-e that incorporate a safety device 105, 107, 108, 111, 103-1-8. FIG. 5A shows a safety bicycle 134a having a safety device 105 coupled to the rear of the safety bicycle 134a, specifically to an outer surface of the seat post 136. In the depicted example, the safety device 105 includes a waterproof housing 142 with a camera 138 coupled to an outer surface 140 for detecting motion and objects behind the safety bicycle 134a.

In the example depicted in FIG. 5B, the safety bicycle 134b includes a safety device 107 coupled to a top surface of handlebars 148. In this example, the safety device 107 includes a display 144 (e.g., a feedback component 123) on the outer surface 150 of its housing 152; however, it is contemplated that a smart display may be a separate component (e.g., a user device 106 positioned on the handlebars) in communication with a safety device that is positioned elsewhere on the micromobility vehicle. It is contemplated that the safety device 107 may be a fixed feature or removable from the safety bicycle 134b.

In the example depicted in FIG. 5C, the safety bicycle 134c includes a safety device 111 coupled to a top surface of handlebars 158. In this example, the safety device 111 includes a light 160 (e.g., a feedback component 123) on a front surface of the housing 162. It is contemplated that the light may include a light sensor as discussed above. In the depicted example, the housing 160 includes a recession 164 on a top surface 168 configured to receive a smartphone 170 (e.g., a type of user device 106).

In the example shown in FIG. 5D, the safety bicycle 134d includes a safety device 109 that is contained within a head tube 154. In this example, the safety device 109 is in communication with a light 146 that is a separate component from the safety device 109. The light may include a light sensor as discussed above that is in communication with the safety device 109 processing element. In the example shown, the safety bicycle 134d includes a holder 155 for a smartphone 156 that is in communication with the safety device 109. While FIGS. 5C and 5D show a smartphone 170, 156, respectively, it is contemplated that the smartphones 170, 156 may be replaced by dedicated user devices described herein.

FIG. 5E shows exemplary locations for a safety device 103 on a micromobility vehicle 132-1, in this example, a safety bicycle 134e. As shown, a safety device 103-1-7 may be positioned on a frame 180 of the safety bicycle 134e, such as, for example, safety device 103-1 positioned on a rear surface of the seat tube 182, safety device 103-2 positioned on a front surface of the seat tube 182 and partially on a lower surface of the top tube 184, safety device 103-3 positioned on a lower surface of the top tube 184 and partially on a front surface of the seat tube 182, safety device 103-4 positioned on a lower surface of the top tube 184 and partially on the head tube 186, safety device 103-5 positioned on the down tube 188 proximate the head tube 186, safety device 103-6 positioned on the down tube 188 proximate the chain ring 190, safety device 103-7 positioned on a front surface of the seat tube 182 proximate the chain ring 190, safety device 103-9 positioned under the seat 194, safety device 103-10 positioned on a rear surface of the seat post 196, safety device 103-11 positioned on a front surface of the seat post 196, safety device 103-12 positioned on a top surface of the top tube 184 near the seat post 196, or safety device 103-13 positioned on a top surface of the top tube 184 near the handlebars 198. As another example, a safety device 103-8 may be coupled to a gear system 192 of the safety bicycle 134e. The positions shown in FIG. 5E are meant as illustrative examples and other positioning of a safety device 103 relative to a micromobility vehicle 132 is contemplated.

It is contemplated that a safety device described herein may be positioned adjacent to or coupled to a water bottle holder of a micromobility vehicle. For example, a disclosed safety device may include a housing with a form factor that is compatible with a form factor of a water bottle holder configured to couple to the micromobility vehicle. FIG. 5F shows a series of images depicting an exemplary water bottle holder or cage 700 configured to couple to a micromobility vehicle and receive a safety device 113. In the depicted embodiment, the water bottle holder 700 includes a base 702, arms 704a,b, and a holder 706. The base 702 is shaped to house or hold the safety device 113. In the depicted embodiment, the safety device 113 has a rectangular shape or form factor and the base 702 has a corresponding rectangular shape or form factor to fit the safety device 113; however, other shapes or form factors of the base 702 are contemplated to correspond with a different shaped safety device. The base 702 may include a base rear wall 708 having a front surface 710 and a rear surface 711, a base left sidewall 712, a base right sidewall 714, and a base bottom wall 716. The base rear wall 708 may define rear wall apertures 713a,b therethrough. The left arm 704a and right arm 704b may extend from the base left sidewall 712 and base right sidewall 714, respectively. The base 702 and arms 704a,b may form a safety device pocket or compartment 730.

As shown, the arms 704a,b space the holder 706 apart from the base 702. The holder 706 may include a left wing 718a and a right wing 718b that are connected by a lower support 720 and upper support 722. The left wing 718a and right wing 718b may curve towards one another and may be shaped to hold water bottle. The left and right arms 704a,b and left and right wings 718a,b may be flexibly coupled to the base 702 such that they can be moved apart to accommodate different sized safety devices and/or water bottles. While the depicted example shows a specific holder configuration, it is contemplated that a safety device compartment may be integrated into any conventional water bottle holder to receive the safety device, where the safety device compartment separates the safety device from the water bottle. As such, it is contemplated that a single component may be attached to a micromobility vehicle (e.g., a bicycle or scooter) that holds both a water bottle and a disclosed safety device.

In the depicted embodiment, the base 702 includes mounting features 724a,b to secure the base 702 and water bottle holder 700 to a micromobility vehicle, such as a bicycle. For example, the water bottle holder 700 may be coupled to the frame of a bicycle or scooter. As shown, the mounting features 724a,b may protrude from the base 702. In the depicted embodiment, the mounting features 724a,b protrude from the rear surface 711 of the base rear wall 708. In the depicted embodiment, a first mounting feature 724a is positioned below the first rear wall aperture 713a and a second mounting feature 724b is positioned between the first rear wall aperture 713a and second rear wall aperture 713b; however, it is contemplated that the mounting features 724a,b may be positioned in other locations on the base rear wall 708 and the number of mounting features 724a,b may vary. The mounting features 724a,b may include mounting apertures 726a,b for receiving fasteners (e.g., screws, nails, bolts, etc.) to fasten the base 702 and water bottle holder 700 to a micromobility vehicle. It is contemplated that the mounting features 724a,b may be omitted and the water bottle holder 700 may be coupled to the micromobility vehicle by other means, such as, for example, by bands or straps that surround a frame of the micromobility vehicle.

As shown, a safety device 113 may be positioned within the base 702 between the arms 704a,b. The safety device 113 may be partially received between the base rear wall 708, base left sidewall 712, base right sidewall 714, and base bottom wall 716. The safety device 113 may be adjacent to the front surface 710 of the base rear wall 708. The safety device 113 may be held in place by the arms 704a,b. For example, the arms 704a,b may be moved apart or separated to receive the safety device 113 and returned to resting position. In resting position, the arms 704a,b may seat biased against the safety device 113 to hold it in place. It is contemplated that the base bottom wall 716 may partially or fully support the safety device 113.

As shown, a water bottle 728 may be positioned within the holder 706. For example, the wings 718a,b may be moved apart or separated to receive the water bottle 728 and returned to resting position. In resting position, the wings 718a,b may seat biased against the water bottle 728 to hold it in place. It is contemplated that the lower support 720 may partially or fully support the water bottle 728. The water bottle 728 may be separated from the safety device 113 by the lower support 720 and upper support 722. As shown, the safety device 113 may be received within the safety device pocket or compartment 730 that is separate from the holder 706 and water bottle 728. It is contemplated that the safety device pocket or compartment 730 may receive a user device 106 discussed herein (e.g., as opposed to the safety device 113).

In several embodiments, a safety device described herein has risk detection (e.g., based on determined safety risks), crash detection (e.g., based on determined collision probabilities), emergency recognition (e.g., based on user data such as heart rate or sensor data such as IMU data), beaconing, and anti-theft features.

### Safety Application

The one or more user devices 106 or safety devices 102 may include a safety application configured to communicate with various components in the system 100 of FIG. 1. In several embodiments, the safety application may receive safety-related data from one or more data sources. For example, the safety application may receive safety-related data from one or more of the one or more safety devices (e.g., local processing element 116), the one or more sensors 122, the one or more servers 108, the one or more user devices 106, user input through a GUI, and the one or more databases 112. The safety application may include an open application programming interface to facilitate interoperability and information exchange between various components of the system 100. The safety application may transmit data to various components of the system 100, including, for example, the one or more safety devices (e.g., local processing element 116), other safety applications on other user devices 106, the one or more servers 108, and/or the one or more databases 112.

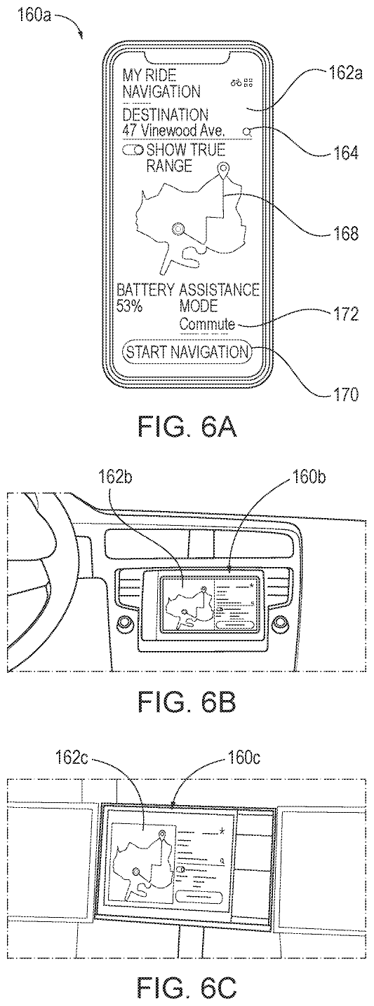

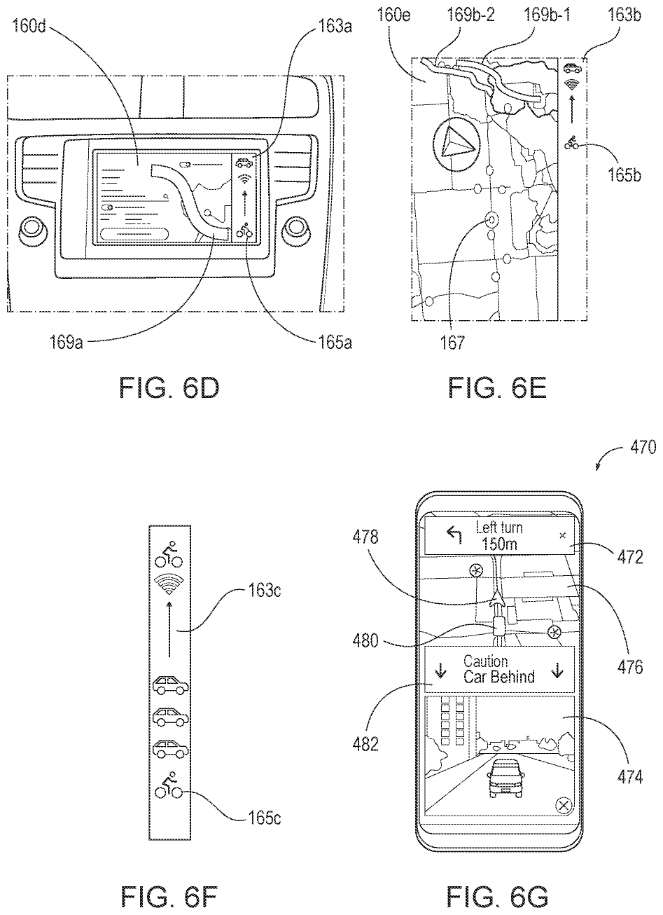

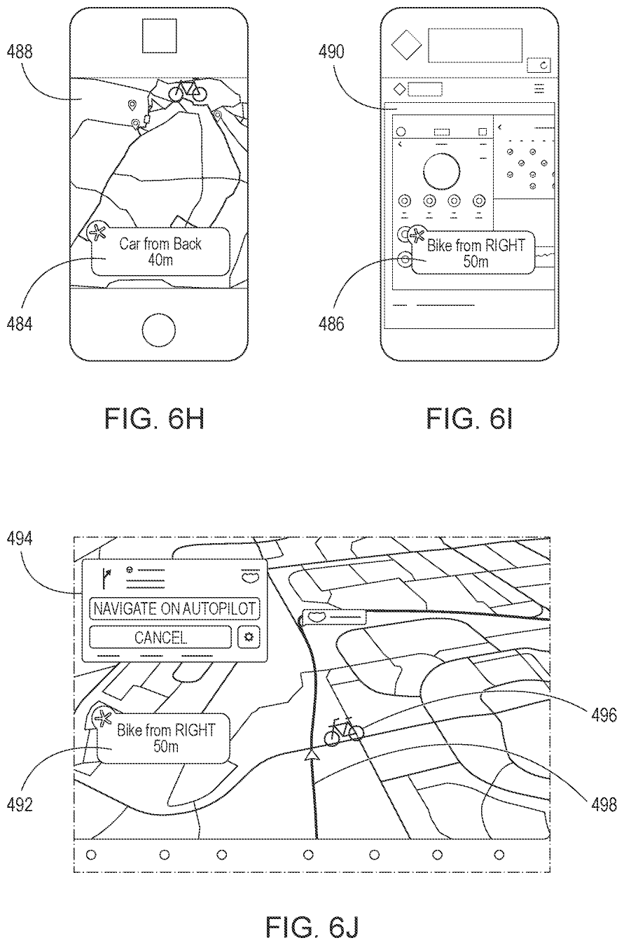

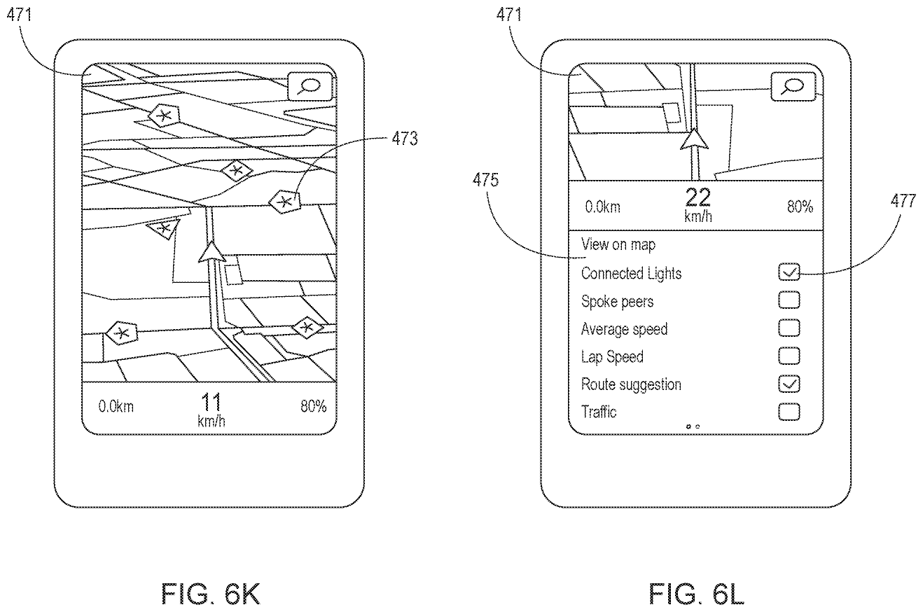

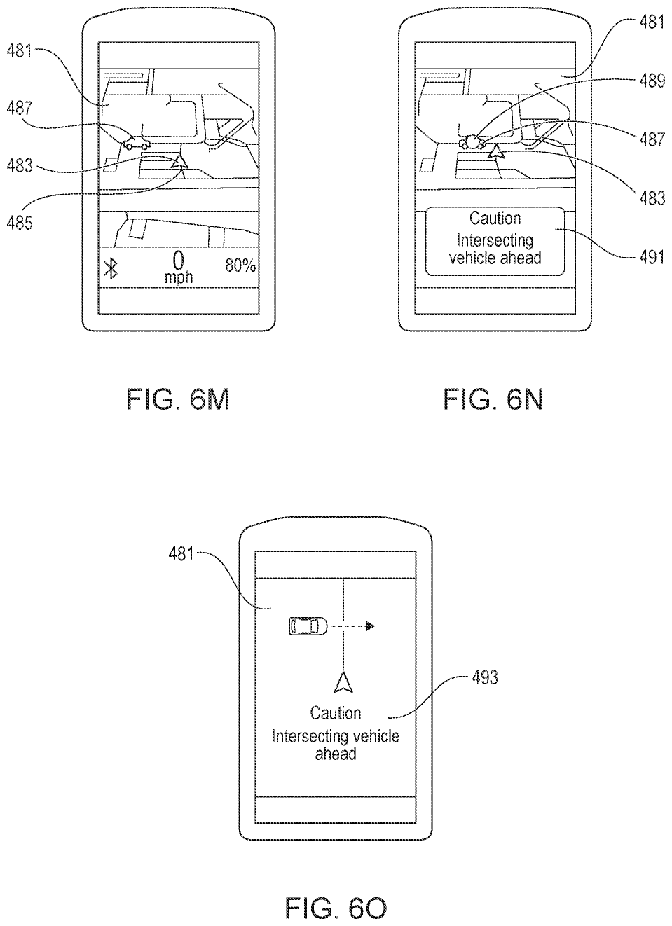

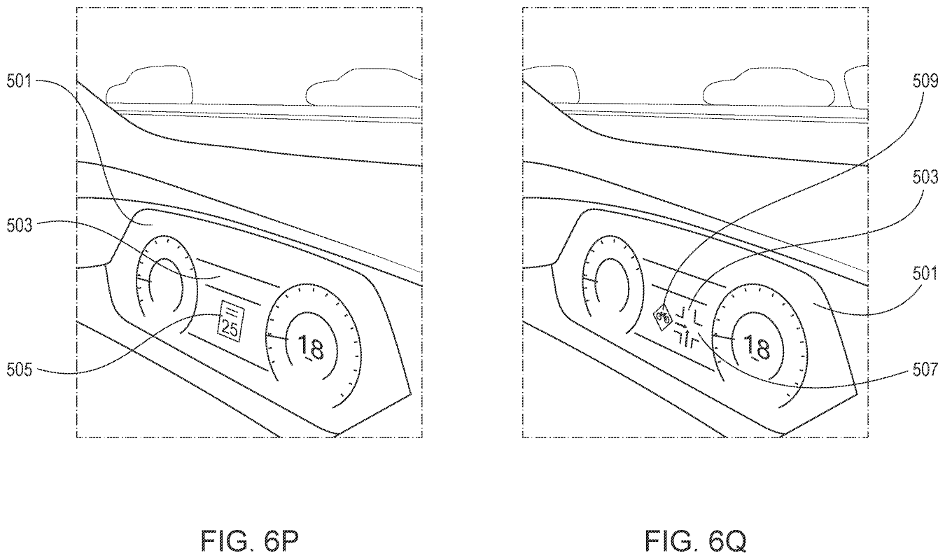

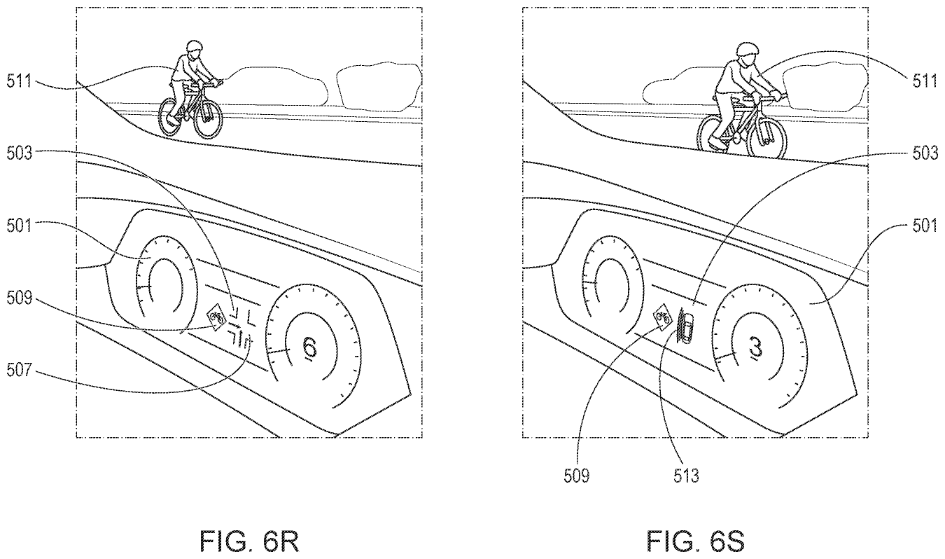

FIGS. 6A-C show exemplary user devices 160a-c including GUIs 162a-c for displaying the safety application. For example, FIG. 6A shows a GUI 162a on a smartphone 160a, FIG. 6B shows a GUI 162b on a car display 160b, and FIG. 6C shows a GUI 162c on a computer 160c.

As shown in FIG. 6A, the application may receive user destination input 164, and, based on safety-related data received (e.g., from the one or more servers 108), provide a suggested initial route 168 to the destination. The one or more servers 108, or remote processing unit, may determine a safe route based on the location of the user device 160a, the destination input 164, and safety-related data (e.g., collision-related data, traffic-related data, entity data, and the like), and transmit the safe route to the safety application on the user device 160a, as discussed in more detail below with respect to method 250 of FIG. 8.

The application may further receive a “start navigation” signal when the “start navigation” button 170 is selected on the GUI 162a. When the application receives the start navigation signal, the application may transmit the route 168 to the local processing element 116 and/or to the one or more servers 108. The one or more servers 108 may store the route 168, along with timestamp information as to when the route was received, in the one or more databases 112. The system may have stored, e.g., in the one or more databases 112, prior routes used by the user, and may compare the received route 186 to the prior routes to identify the type of route. For example, if several routes start from the same location, the one or more servers 108 may determine that location is the user's home. If several routes go to and from the same destination Monday-Friday and are around work start and end hours (e.g., 8 AM-10 AM and 4 PM-6 PM), the one or more servers 108 may determine the route is a work commute. The one or more servers 108 may transmit the route identity to the safety application for display to the user. As shown in FIG. 6A, the GUI shows the selected route 168 is a commute 172.

In some embodiments, the safety application may include additional display features that provide consolidated, useful information to a user, e.g., displaying information on approaching entities (e.g., which type of entity is approaching, a number of entities within a short-distance range, an approximate distance, speed, direction, etc. of one or more entities, and the like). For example, FIGS. 6D-F show safety information bars 163a-c that can be displayed on a GUI of an associated user device that integrates the safety application, such as GUIs 160d-e shown in FIGS. 6D-E. As used in the description of FIGS. 6D-F, an associated user device is a user device that displays the safety application on a GUI. As shown, the safety information bars 163a-c are displayed next to a map displayed on the GUI 160d-e and provide certain consolidated information to a user. The map may be part of the safety application or a map from a third-party application (e.g., a fitness or navigation application). It is also contemplated that the safety information bars 163a-c may be displayed when a third-party application is open on the user device, e.g., while the third-party application is displaying fitness or other collected data. In this manner, a user may view other applications and still receive important data (e.g., safety-related data) from the safety application, such as, for example, data on approaching entities.

As shown, the safety information bar 163a-c includes icons 165a-c, respectively, that represent the entity associated with the associated user device and approaching entities. For example, FIG. 6D shows a car icon 165a at the top. The car icon 165a represents the entity associated with the associated user device. The bicycle icon 165a below with the arrow pointing towards the car icon 165a shows a bicycle is approaching the car. In the example shown in FIG. 6F, the safety information bar 163c shows several entities approaching a cyclist, as represented by the bicycle and car icons 165c.

The icons 165a-c may include different graphics, colors, patterns, etc. to show different entity types and/or different entity traits (e.g., an entity with connectivity capabilities via a safety device, an entity with connectivity capabilities via a safety application on a user device, a dumb entity, etc.). As shown, different entity types are represented by different shaped icons 165a-c (e.g., a bicycle icon for a bicycle and a car icon for a car), and the different entity traits for the car icons 165c in FIG. 6F is depicted by different colored icons 165c. It is contemplated that the icons 165c may be arranged based on relative distance to the associated user device, with the closest icon 165c to the arrow being the closest entity.

As shown in FIG. 6E, the icons 165b in the safety information bar 163b may correspond to map icons 167 that represent entities on the map. For example, the bar icons 165b may have a similar identifier as the map icons 167 to easily identify corresponding icons 165b, 167. For example, the bar icons 165b and map icons 167 may have the same color, pattern, or the like. For example, the bike icon 165b may be blue and may correspond to a map icon 167 that is a blue dot on the map, and the car icon 163b may be yellow and may correspond to a map icon 167 that is a yellow dot on the map. In this manner, the safety information bar 163b provides consolidated information related to the map of entities.

The GUI 160d-e may also display other entity routes 169a, b-1, b-2. For example, an other entity route 169a,b-1 may be a planned route of a cyclist within a certain distance range to the associated user device. For example, the planned route may be stored as data within a safety application or third-party application on a user device associated with the other entity, and such data may be shared, via the server, with the safety application on the associated user device and displayed on the GUI 160d-e. Numerous other entity routes may be displayed, such as first route 169b-1 and second route 169b-2, and may be differentiated based on color, pattern, etc., representing different entity types. For example, the first route 169b-1 may be a blue line representing a cyclist route and the second route 169b-2 may be a red line representing a car route. By displaying other entity routes, the safety application helps users better avoid collisions with the other entities.

The application may receive various user input. For example, the application may receive account or registration information from a user when the application is downloaded on the user device. The application may also notify a user to input information after a near or actual collision, e.g., as determined by the system according to method 200 of FIG. 7. The application may receive various user data, vehicle data (e.g., micromobility vehicle or light mobility vehicle data), safety device data, and safety-related data input by a user. User data may include, for example, user height, weight, gender, age, rider experience (e.g., how many years riding), clothing color (e.g., input after a near or actual collision), health, fitness level or goals, and the like. Vehicle data may include, for example, make, model, color, size specifications, condition, type (e.g., road bike vs. mountain bike vs. hybrid bike, electric scooter, electric skateboard, car, etc.), and the like. Safety device data (or device data) may include data identifying the safety device, such as an identification number. Such data may be input manually by a user via the GUI or by scanning a code, such as a QR code, bar code, or the like on the light mobility vehicle and/or safety device. The user data and light mobility vehicle data may be transmitted to the server 108 for storage in the one or more databases 112.

In some embodiments, the safety application may receive data from other third-party applications (e.g., navigational applications), databases, or devices (e.g., fitness wearables) associated with the user device (e.g., downloaded or open on the user device or registered with the user device) and integrate such data with the user input and any other data received (e.g., from safety devices and/or the server). Third-party application, database, or device data may include, for example, additional location-based data, user health data (e.g., heart rate, BMI, activity level, etc.), planned or saved routes, speed, user activities schedules, weather data, environmental data (e.g., AQI, heat index, etc.), road/surface condition data (e.g., elevation, road type, etc.), and the like. It is contemplated that if a third-party application is open on a user device when an alert is received by the safety application (e.g., indicating a safety risk, e.g., a high probability of collision with another vehicle or a real-time collision or high-risk collision area on the user's route) that the safety application may override the third-party application to display the alert to the user on the user device.

In some embodiments, the safety application may receive sensor data directly or indirectly (e.g., via the server 108 or safety device 102) from one or more sensors 122. For example, FIG. 6G shows an exemplary safety application GUI 472 of a user device 470 displaying sensor data from a sensor (in this example, a camera) via a safety application. For example, the safety application may be used by a bicyclist having a rear camera coupled to his or her bicycle (e.g., camera 138 of FIG. 5A). In the example depicted, the camera detected another vehicle approaching and transmitted a live video stream 474 of the approaching vehicle. As shown, the live video stream 474 is displayed on the safety application GUI 472. In the depicted example, the live video stream 474 is overlayed over a map 476 showing a user icon 478 representing the location of the user device user (e.g., bicyclist) and an approaching vehicle icon 480 representing the location of the approaching vehicle.

In some embodiments, the safety application may generate and display an alert based on the safety-related data received. For example, FIG. 6G shows an alert notification 482 generated and displayed based on sensor data received. In the depicted example, the alert notification 482 indicates a vehicle is approaching based on data received from a camera. As shown, the alert notification 482 is overlayed on the map 476 displayed on the safety application GUI 472. It is contemplated that an alert notification (e.g., alert notification 482) may be overlayed on a third-party application interface that is open and displayed on the GUI.

FIGS. 6H-J show images of exemplary third-party application interfaces displayed on a GUI that receive and display data from a safety application disclosed herein. For example, FIGS. 6H-I show alert notifications 484, 486 transmitted from a safety application that are displayed on GUIs 488, 490 of third-party fitness applications. The alert notifications 484, 486 indicate that a car is approaching from behind the user 40 m away and that a bike is approaching the user from the right 50 m away, respectively. As another example, FIG. 6J shows an alert notification 492 from a safety application that is displayed on a GUI 494 of a third-party navigational application (in this example, a map interface). In this example, the safety application also overlays an entity icon 496 on the map interface 494 that indicates the location of another entity, the direction the other entity is traveling, and the type of entity. As shown, a bicycle icon 496 is displayed on the map interface 494 coming from a direction to the right of the user's route 498. In this example, the alert notification 492 indicates that a bicycle is approaching the user from the right 50 m away.

In several embodiments, the user device 106 is directly associated with a light mobility vehicle and/or safety device (e.g., both are used by the same user). For example, the user device may be associated with a light mobility vehicle or safety device based on user input. For example, the application may register a light mobility vehicle or safety device associated with the user. As discussed above, the application may receive direct user input of light mobility vehicle data or device data or a scanned code (e.g., QR code) containing the light mobility vehicle data or device data. As another example, the user device 106 may detect a light mobility vehicle or safety device in proximity (e.g., via communication with a safety device 102) and associate with the light mobility vehicle or safety device. When associated with a light mobility vehicle or safety device, the associated user device 106 may receive data from the associated safety device 102, such as alerts of nearby entities.

In some embodiments, it is contemplated that the user device 106 may be independent of a light mobility vehicle, for example, used by a pedestrian (e.g., smartphone) or driver (e.g., smartphone or car display). In embodiments where the application is integrated with a display in an automotive vehicle, the application may communicate with an automotive vehicle connectivity device 104 (e.g., a C-V2X chip), e.g., to receive alerts of nearby entities.

The application may provide, via the GUI, a comprehensive landscape of safety-related information, e.g., entities and objects positioning (e.g., based on entity data and data aggregated from third-party navigational applications), road/surface conditions, danger areas (e.g., due to high traffic, construction, crime, etc.), weather, and the like. In this manner, the data provided to a user through the application is unique and an improvement over other navigational applications in that it provides a much more comprehensive landscape of safety-related information.

FIG. 6K shows an exemplary safety application interface 471 displayed on a GUI. As shown, the safety application interface 471 displays different entity icons 473 for different types of entities that are within a particular proximity to the user. In the depicted example, the entity icons 473 vary by shape to represent different entities. For example, a hexagon may represent a car, a square may represent a bicycle, and a triangle may represent a pedestrian. Other icons are contemplated to represent different entities (e.g., a bicycle-shaped icon for a bicycle and a car-shaped icon for a car).

In some embodiments, safety application features may be turned on or off based on user preferences. As shown in FIG. 6L, a settings interface 475 may display one or more selections 477 to select different features to display on the safety application interface 471. In the depicted example, a user can select certain features by touching a selection that, when selected, displays a check mark. In this example, safety application features that can be turned on or off include connected lights (e.g., to alert other users of your presence, as discussed with respect to the safety device), other application users' data and/or location, average speed, lap speed, route suggestions (e.g., suggestions for alternate routes based on hazards, traffic, collisions, etc.), and traffic conditions (e.g., areas of congestion or high likelihood of congestion based on time of day).

FIGS. 6M-O show a sequence of images of an exemplary safety application interface displaying varying data on an approaching entity based on the entity's position relative to the user. As shown in FIG. 6M, the safety application interface 481 displays a user icon 483 on map interface 485 and an entity icon 487 showing an entity that is in proximity to the user, e.g., based on input received from a safety device described herein. As the safety device receives entity data from the entity, the safety device may determine when the entity becomes a threat, e.g., there is a high collision risk with the entity based on the entity's trajectory (e.g., speed, heading, proximity, acceleration, etc.). The user device displaying the safety application interface 481 may receive this threat information and display it on the safety application interface 481 as an icon, an alert message, or the like. As shown in FIG. 6N, as the entity becomes a threat (e.g., there is a high collision risk or the entity is getting closer), the safety application interface 481 displays a threat alert icon 489. In this example, the threat alert icon 489 is a red dot overlaying the entity icon 487. The safety application interface 481 also displays an alert message 491 (e.g., “Caution intersecting vehicle ahead”). In the depicted example, as the threat becomes greater (e.g., based on the proximity of the entity to the user or the user approaching an estimated collision point), the safety application interface 481 displays a more prominent alert. As shown in FIG. 6O, the entire safety application interface 481 displays a red message 493 that says “Caution: Intersecting vehicle ahead.” The alert may include an audio or haptic alert. For example, the user device displaying the safety application may play a sound or vibrate when the alert is displayed.

FIGS. 6P-S show a sequence of images of a car display 501 displaying an exemplary safety application interface 503 that displays varying data on an approaching entity based on the entity's position relative to the driver. FIG. 6P shows the safety application interface 503 on the car display 501 displaying relevant road information to a driver. In the depicted example, the safety application interface 503 displays traffic signs, specifically, the relevant speed limit sign 505. When a threat is detected (e.g., an entity is in proximity that has a high collision probability with the driver based on each entity's direction, heading, speed, acceleration, etc.), the safety application interface 503 displays relevant information related to the threat. The threat may be detected based on data received from a C-V2X chip or cellular modem installed in the car or based on data received by a safety application installed in the car or on a user device in communication with the car computer.

As shown in FIG. 6Q, the safety application interface 503 displays threat information as an intersection icon 507 showing an entity icon 509 and its position relative to the intersection and to the driver. As shown, the entity is approaching the intersection from the left of the driver. As shown, the entity icon 509 and threat are displayed on the safety application interface 503 before the entity is visible to the driver. As shown in FIG. 6R, the safety application interface 503 continues to display the entity icon 509 as the driver approaches the entity 511 (in this case, a cyclist). In the depicted example, as the threat becomes greater (e.g., based on the proximity of the entity 511 to the driver or the driver approaching an estimated collision point), the safety application interface 503 displays a more prominent alert. As shown in FIG. 6S, the safety application interface 503 displays the entity icon 509 in a different color (in this example, orange) and displays a proximity or collision icon 513. As discussed above with respect to FIGS. 6M-O, the alert may include an audio or haptic alert. For example, the car computer may play a sound or vibrate a component of the vehicle (e.g., the steering wheel) when the alert is displayed.

In some embodiments, a safety device disclosed herein may be omitted and the logic executed by safety devices described herein may be included in a chip or SIM card or other simplified hardware architecture that can be integrated into a vehicle for operation with the vehicle's integrated hardware and software. For example, a safety application may be installed on a car computer to execute the safety methods described below.

### Safety Methods

The various methods described below with respect to FIGS. 7-13, 16-19, and 35 may be implemented by the system 100 of FIG. 1 (e.g., by the server 108, safety device 102, user device 106, and/or other system 100 components). In some embodiments, the various disclosed methods can be integrated with functionality of the safety application described above. In several embodiments, the methods described below may be executed while a third-party application is running (e.g., on a display of a user device or safety device described herein). It is contemplated that when an alert is transmitted (e.g., related to a high or imminent safety risk), the alert may override the third-party application (e.g., the alert is displayed instead of the third-party application or is overlayed on top of the displayed third-party application interface). Safety systems and methods described herein may seamlessly switch between third-party applications and safety risk alerts or warnings. In this manner, safety may be guaranteed without interference of third-party applications. Third-party application interference may also be reduced where the methods described below are executed by a dedicated user device or safety device described herein, which have limited or no additional third-party applications installed. Because the safety devices, systems, and methods described herein may limit third-party application interference, such devices, systems, and methods may achieve higher safety standards than current safety systems. For example, current third-party applications that provide some safety messages and are installed on smartphones are typically affected by other third-party software that is also installed on the same device.

FIG. 7 is a flow chart illustrating a method for preventing conflicts or real-time collisions (or near collisions) with micromobility vehicles or other entities (e.g., other light mobility vehicles) based on safety-related data, specifically, entity data from surrounding or nearby entities. The method 200 begins with operation 202 and entity data is received from one or more other entities by a local processing element 116 of a safety device 103 coupled to a micromobility vehicle or other light mobility vehicle. As discussed, an entity may be a light mobility vehicle, automotive vehicle, or user device (e.g., carried by a pedestrian). The entity data may be initially received by a connectivity module 114 of the safety device 102 and transferred to the local processing element 116. As one example, the connectivity module 114 may include a C-V2X chip and/or cellular modem that receives entity data from a C-V2X chip or cellular modem, respectively, of another entity (e.g., an automotive vehicle). The entity data may include one or more of location, speed, acceleration, deceleration, heading, distance, time, and the like, of the other entity.

After operation 202, the method 200 may proceed to operation 204 and entity data of the light mobility vehicle is determined. In some embodiments, the local processing element 116 may receive entity data from the connectivity module 114. Additionally or separately, the entity data may be received by the local processing element 116 as part of sensor data received from one or more sensors 122 in communication with the local processing element 116. For example, sensor data received may include entity data, e.g., location, speed, heading, acceleration, etc. As one example, sensor data may include location data received from a GPS. As another example, sensor data may include acceleration data and/or orientation data received from an accelerometer, gyroscope, and/or IMU.

After operation 204, the method 200 may proceed to operation 206 and the entity data of the light mobility vehicle and that received from the one or more other entities is transmitted to a remote server 108. The server 108 may have various uses for the entity data. As one example, the server 108 may aggregate the entity data received with other safety-related data received from other entities and third-party databases to create a comprehensive landscape of safety-related information (including entity locations), which can be transmitted to the various entities, via the network. As another example, the server 108 may store the entity data in the one or more databases 112. For example, the server 108 may analyze entity data collected over time to determine trends, such as common routes, types of routes (e.g., commute), and the like. In a similar manner, the server 108 may analyze entity data collected from numerous entities over time to determine trends, such as popular bike routes, high traffic times and/or locations, and the like.

In some embodiments, the server 108 uses entity data received from an entity to vary the entity location landscape transmitted to a user device 106 associated with the entity. For example, the server 108 may transmit a location landscape of entities that are within a particular landscape distance range, e.g., 3, 4, 5, 100 miles, etc. A location landscape shows on a map the locations of other entities relative to the entity that are within the landscape distance range. As the entity moves, the location landscape may change and new entities may appear within the landscape distance range. The server 108 can account for these changes by consistently receiving entity data from the entity, and adjusting the location landscape based on the entity data received. The server 108 may transmit the adjusted location landscape to a user device associated with the entity.

After operation 204, the method 200 may optionally proceed to operation 207 and sensor data is received. The local processing element 116 may receive sensor data from the one or more sensors 122, such as, for example, data on location/position, motion, speed, acceleration, deceleration, heading, nearby objects, light conditions, moisture, humidity, pressure, temperature, wind, precipitation, and the like.

After operation 204 or, optionally, operation 207, the method 200 may proceed to operation 208 and one or more safety risks or threats (e.g., collision probabilities) are determined based on the entity data received, and optionally, on the sensor data received. For example, a collision probability may be determined between two or more entities based on various factors and calculations. As one example, a collision probability may be derived from the intersection of movement vectors of two or more entities. For example, each entity's location, heading, and speed can be taken into account to determine a respective movement vector. The local processing element 116 can determine whether the movement vectors intersect and if so, the location of the point of intersection and the time at which each entity will pass the point of intersection (e.g., based on current speed). A collision point is determined where the time at which each entity passes the point of intersection is the same. The local processing element 116 may also determine a near collision where the time at which each entity passes the point of intersection is within seconds (e.g., less than 20 seconds, less than 10 seconds, or less than 5 seconds) of each other. Where a collision point is determined, the local processing element 116 may determine a high collision probability (e.g., 90%-100%, accounting for some error and possible changes in speed of the entities). Where a near collision is determined, the local processing element 116 may determine a high collision probability (e.g., 75-90%). In this manner, the local processing element 116 can determine whether there is a high collision probability between the light mobility vehicle and the one or more other entities.

In several embodiments, the local processing element 116 may take into account the relative distance between the entities in the calculation of collision probability. For example, the collision probability may decrease the further the entities are from one another, as there is a level of uncertainty regarding the actual path the entity will follow.

In embodiments where sensor data is received at operation 207, the local processing element 116 may adjust the safety risk probability determined based on the entity data to account for the sensor data. For example, collision probability may be increased if the temperature is below a certain threshold (e.g., below 0° C.), e.g., indicating the roads may be icy or slick. As other examples, the collision probability may be higher in high winds, poor light conditions, bad weather (e.g., rain, hail, snow), and the like. As another example, the collision probability may be higher with increased acceleration.

After operation 208, the method 200 may proceed to operation 210 and an alert is transmitted if the safety risk is high. For example, an alert may be transmitted if the determined collision probability is within a high probability value range (e.g., 75-100%). The alert may be indicative of the type of risk, of a risk probability value (e.g., lower end of range—use caution, mid-range—slow down, high end of range—stop), or of a proximity, direction of approach (e.g., from the left, right, front, rear), location, path, or the like (e.g., based on the entity data) of another entity. The alert may vary based on the level of safety risk (e.g., collision risk) and/or estimated timing of encountering the safety risk (e.g., the collision risk) (e.g., an alert for a higher safety risk estimated to occur within a shorter amount of time may be more prominent (e.g., brighter, louder, more frequent, etc.) than an alert for a lower safety risk estimated to occur within a longer period of time).

The alert may be visual, audible, and/or haptic feedback to a user of the light mobility vehicle. In embodiments where the alert includes visual feedback, the alert may be a notification transmitted to an associated user device 106 in communication with the local processing element 116 (e.g., smartphone 156 of FIG. 5D or dedicated user devices 850, 864, 1018, 1034 of FIGS. 24A-25C and 33-34) or to a feedback component 123 of the safety device 103 (e.g., display 144 of FIG. 5B), an illumination or flashing of a light coupled to the safety device 103 (e.g., light 160 of FIG. 5C or light 804 of FIGS. 21A-B) or to another component of the light mobility vehicle and in communication with the processing element 116 (e.g., light 146 of FIG. 5D, light 940 of sensor device 930 of FIGS. 28A-C, or light (e.g., LEDs 974) of sensor device 952 of FIGS. 29A-E and 30), or the like. The notification may alert the user of one or more nearby entities and their locations/directions, to use caution, to slow down, to stop, or the like. The visual cue may vary based on the level of safety/collision risk, proximity of entities, estimated timing of collision/encounter/conflict, or other level of threat risk. For example, a green light may indicate low collision risk, a yellow light may indicate a medium collision risk and a warning to use caution or slow down, and a red light may indicate high risk and to stop. As another example, light intensity or flashing frequency may be altered based on a perceived threat. For example, as an entity approaches a user, the frequency of flashing or light intensity may increase as the entity gets closer to the user.

In embodiments where the alert includes audible feedback, the alert may be a beep, alarm, or other sound emitted from the safety device 103 (e.g., from the feedback component 123), a user device 106, or other sound device in communication with the local processing element 116. For example, the safety device 103 may transmit audible feedback to one or more sound devices within a particular range (e.g., via Bluetooth). As one example, the safety device 103 may send an audible alert to Bluetooth headphones within proximity. As another example, the sound may be transmitted through a piezoelectric Bluetooth speaker in communication with the safety device 103, such that the sound is transmitted via the user's bones without interfering with the ability of the user to hear other surrounding sounds. For example, the sound device may be integrated with the user's helmet.

The sound may be varied according to type, level and location of the safety risk, for example, according to the collision probability, proximity of another vehicle, direction of another vehicle (e.g., the sound could come from different directions, e.g., a speaker on the left or right of the light mobility vehicle), and the like. For example, a slow sound tempo and/or low pitch/volume sound may be indicative of a lower collision probability or a vehicle nearby but not too close (e.g., indicating to use caution), while a fast tempo and/or high pitch/volume sound may be indicative of a higher collision probability or a vehicle that is too close (e.g., indicating to slow down or stop). In some embodiments, the safety device 103 may analyze user data to determine an appropriate sound level. For example, the safety device 103 may adjust the sound level or pitch based on the user's hearing (e.g., a higher level or pitch for a user with poor hearing).

In embodiments where the alert includes haptic feedback, the alert may be a vibration of the safety device 103, the user device 106, or a component of the light mobility vehicle in communication with the local processing element 116 (e.g., vibration of the handlebars or seat). The vibration may vary in intensity or tempo based on the warning level (e.g., low, medium, or high concern) of the alert or the direction of the risk.

The alert may be varied based on threat level, direction, entity type, and the like. For example, the alert may be transmitted on a side of a user where the threat is coming from. For example, the alert may come from a side of a safety device where the threat is coming from. As an example, a strip of the light 804 on a left side of the safety device 800 depicted in FIGS. 21A-B may be selectively turned on when the threat is coming from the left. As another example, the alert may be transmitted from one of the devices in the system that is closest to the threat. For example, in the system 800 depicted in FIG. 33, the alert may be transmitted by the sensor device 1020 when the threat is coming from behind the bicycle 1014 or from the user device 1018 when the threat is coming from in front of the bicycle 1014.

The timing of the alert may be based on proximity of the threat (e.g., the entity with which there is a high probability of collision), speed/acceleration/deceleration of the entities involved, and the types of entities involved. For example, for a pedestrian (e.g., walking at an average speed of 4.5 km/h or 1.25 m/s, covering over 4 ft. per second) that is likely to be involved in a collision, an alert may be transmitted at least 5 seconds prior to the potential collision to allow time for corrective action (e.g., giving a distance of over 6 m or 7 yards for corrective action). As another example, for a car approaching a bicycle at a relative speed of 100 km/h (covering about 138 m in 5 seconds), an alert may be transmitted at least 10 seconds prior to the potential collision to allow time for corrective action (e.g., giving a distance of nearly 280 m or over 300 yards for corrective action).

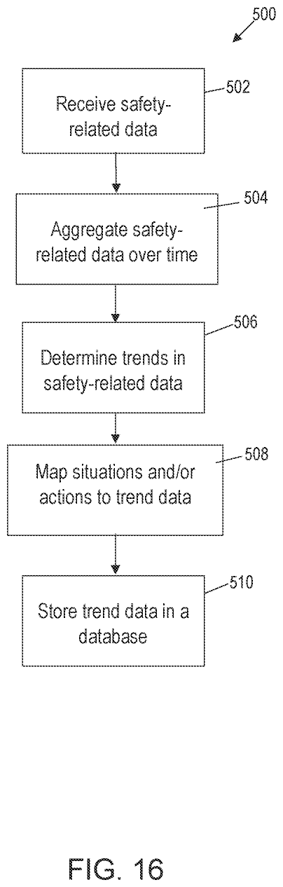

After operation 210, the method 200 may proceed to operation 212 and real-time safety-related data (e.g., collision data) is transmitted to the server 108. For example, the server 108 may store the real-time safety-related data in the one or more databases 112. The server 108 may aggregate and analyze the real-time safety-related data stored over time as trend data (e.g., as discussed in more detail with respect to method 500 of FIG. 16). The safety-related data may include location and time data. As an example, real-time collision data may be indicative of an actual or near collision and its associated location and/or time. The real-time collision data may include one or more of the collision probabilities that are within the high probability value range, the entity data of the one or more entities having the high collision probability with the light mobility vehicle, the entity data of the light mobility vehicle, the predicted point of intersection or collision point location, and the predicted or actual time of the light mobility vehicle and one or more entities passing the point of intersection or collision point.

FIG. 8 is a flow chart illustrating a method for determining a safe route. The method 250 begins with operation 252 and the server 108 receives location and destination data. For example, the server 108 may receive the location and destination data from a safety application on a user device 106 (e.g., via user input), as discussed above.

After method 252, the method 250 may proceed to operation 254 and safety-related data is received. The safety-related data may include data related to one or more entities, surroundings, circumstances, environment, settings, events, and/or occurrences in a particular location or area and/or at a particular time or time range, as discussed in more detail below with respect to FIG. 16. For example, safety-related data may include data related to one or more objects or entities (e.g., proximity, location, motion, etc.), time, collisions and collision risk, road/surface conditions or hazards, traffic or congestion, weather, environment, traffic intersections, traffic lights, traffic signs, laws or ordinances, criminal activity, user data, vehicle data, and the like.

As an example, safety-related data may include real-time collision data. The real-time collision data may be indicative of an actual or near collision and its associated location. As another example, safety-related data may include high collision risk areas determined based on real-time collision data received over time. The real-time collision data may include data on a high probability collision and its associated location. The server 108 may collect real-time collision data from various entities, aggregate the real-time collision data to determine high risk collision areas (e.g., based on numerous high probability collisions in the same or proximate location), and store the real-time collision data collected and high-risk collision areas determined in the one or more databases 112 as collision-related data.

Safety-related data may be received from one or more entities (e.g., entity data received from one or more safety devices and/or automotive vehicle connectivity devices), one or more sensors, one or more system databases, and/or third-party databases or applications. For example, entity data may be received from one or more of a local processing element 116 of a safety device 103, an automotive vehicle connectivity device 104, a safety application on a user device, and/or a third-party database or third-party application on a user device. The third-party databases or applications may collect and/or store entity data from associated users. For example, the third-party databases or applications may include data from fitness wearables (e.g., Fitbit, Halo, Apple, etc.), training applications (e.g., Under Armor, Strava, TrainingPeaks, etc.), cycling applications (e.g., Ride GPS, Bike2Peak, etc.), navigational applications (e.g., Waze, Google Maps, Apple Maps, etc.), and the like.

After operation 254, the method 250 may proceed to operation 256 and one or more safety risks are determined based on the received safety-related data. The one or more safety risks may include collision probability; road/surface hazards or obstacles; objects within a proximity; areas with construction, high traffic, one or more collisions, high collision risk, high crime rates, or the like; changes in road/surface conditions (e.g., road grade changes); and the like. As one example, one or more real-time collision probabilities may be determined based on received entity data. The one or more real-time collision probabilities may be determined in the same manner as the collision probability determined in operation 208 of method 200 of FIG. 7.

After operation 256, the method 250 may proceed to operation 258 and a safe route to the destination is determined based on the received location and destination data and safety-related data and/or determined one or more safety risks. For example, a safe route may be determined based on received entity data and collision-related data (e.g., real-time collision probabilities, high risk collision areas, and real-time collision data). As one example, the safe route may be created to avoid one or more of the determined safety risks (e.g., high traffic areas, areas with numerous pedestrians or micromobility vehicles, high risk collision areas, areas with high real-time collision probabilities, areas with real-time collisions, and the like).

After operation 258, the method 250 may proceed to operation 260 and the safe route is transmitted to the user device. For example, the safe route may be displayed through a safety application on a GUI of a user device (e.g., FIGS. 6A-G).

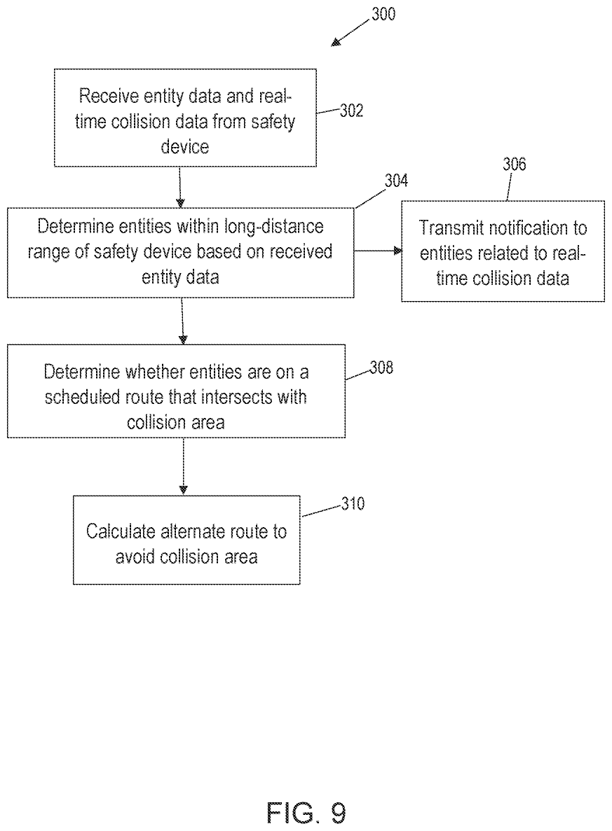

FIG. 9 is a flow chart illustrating a method for adjusting routes based on real-time collision data. The method 300 begins with operation 302 and entity data and real-time collision data are received by a server 108 from a safety device 103. The real-time collision data received is similar to that discussed with respect to FIG. 7.

After operation 302, the method 300 may proceed to operation 304 and entities within a long-distance range of the safety device 103 are determined based on the received entity data. The server 108 may compare entity data received from other entities to the entity data received form the safety device 103 to determine entities that are within a long-distance range, e.g., within 5 miles.

After operation 304, the method may proceed to operation 306 and a notification is transmitted to the entities within the long-distance range related to the real-time collision data. For example, the notification may be a message or graphic providing information on the location of a near or actual collision (e.g., collision area) that is sent to a safety application, e.g., as described above, on a user device 106. As one example, the graphic may be a red dot, a crash symbol, or other icon that appears on a map on a GUI of a user device 106 (e.g., the GUI 162a of the smartphone 160a shown in FIG. 6A).

After operation 304, the method may proceed to operation 308 and the server 108 determines whether entities are on a scheduled route that intersects with the collision area. For example, the server 108 may have generated and/or stored routes for the entities, e.g., as discussed in more detail above with respect to the safety application. The collision area may be the location of the near or actual collision or may include an area around the location, e.g., a few blocks, less than 0.5 miles, etc. (e.g., an area where traffic could build up due to the collision).

After operation 308, the method 300 may proceed to operation 310 and an alternate route is calculated to avoid the collision area for the entities that are on an intersecting route. For example, the alternate route may change the course by a block or two or change the entire course. The alternate route may take into account time and provide the quickest way around the collision area. While method 300 is described above as being performed by the server 108, it is also contemplated that method 300 may be performed by a local processing element of a safety device, e.g., where the server 108 transmits collision-related data (e.g., high risk collision areas) and entity data (e.g., high traffic areas) to the local processing element. It is contemplated that method 300 may be executed based on other safety-related data, e.g., to determine an alternate route based on other safety risks (e.g., traffic areas, high crime area based on time of day, areas with high VRU traffic, construction areas, poor road/surface conditions, road/surface obstacles, and the like).

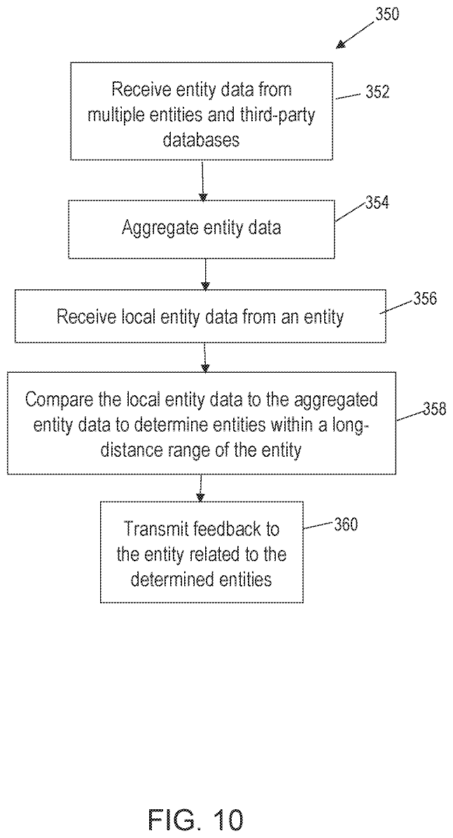

FIG. 10 is a flow chart illustrating a method of providing comprehensive entity data. The method 350 begins with operation 352 and entity data is received from multiple entities and third-party databases. As discussed, entity data may be received by the server 108 from one or more safety devices 103 (e.g., coupled to one or more micromobility vehicles 132 or other light mobility vehicles 253 or portable hand-held devices), one or more automotive vehicle connectivity devices 104, and one or more user devices 106 (e.g., via a safety application). The server 108 may also receive entity data from third-party databases that store data collected from associated third-party applications (e.g., data from fitness wearables, fitness applications, navigational applications, etc.).

After operation 352, the method may proceed to operation 354 and the entity data is aggregated. As one example, the data may be aggregated to coordinate entities in a similar location (e.g., within a long-distance range), of the same type (e.g., cyclists, pedestrians, cars), and the like. The data may also be aggregated based on timing information (e.g., data with the same timestamp). The aggregated entity data may create a location landscape of the various entities.

After operation 354, the method 300 may proceed to operation 356 and local entity data is received from an entity. The local entity data may be received from a safety device 103 (e.g., of a micromobility vehicle 132 or other light mobility vehicle 253), an automotive vehicle connectivity device 104, or a user device 106 (e.g., via a safety application).

After operation 356, the method 300 may proceed to operation 358 and the local entity data is compared to the aggregated entity data to determine one or more entities within a long-distance range of the entity. For example, the server 108 may determine the coordinates of the one or more entities based on the entity data and the coordinates of the entity based on the local entity data, and determine if the distance between the coordinates is within the long-distance range.

After operation 358, the method 350 may proceed to operation 360 and feedback is transmitted to the entity related to the entities that are within the long-distance range. The feedback may be transmitted to a GUI of a user device 106 associated (e.g., in communication with) the entity, and may show the locations of the entities within the long-distance range. For example, the feedback may be transmitted to a safety application on a user device. In the example shown in FIG. 6A, the safety application may display the entities within the long-distance range on the map displayed on the GUI 162a on the smartphone 160a.

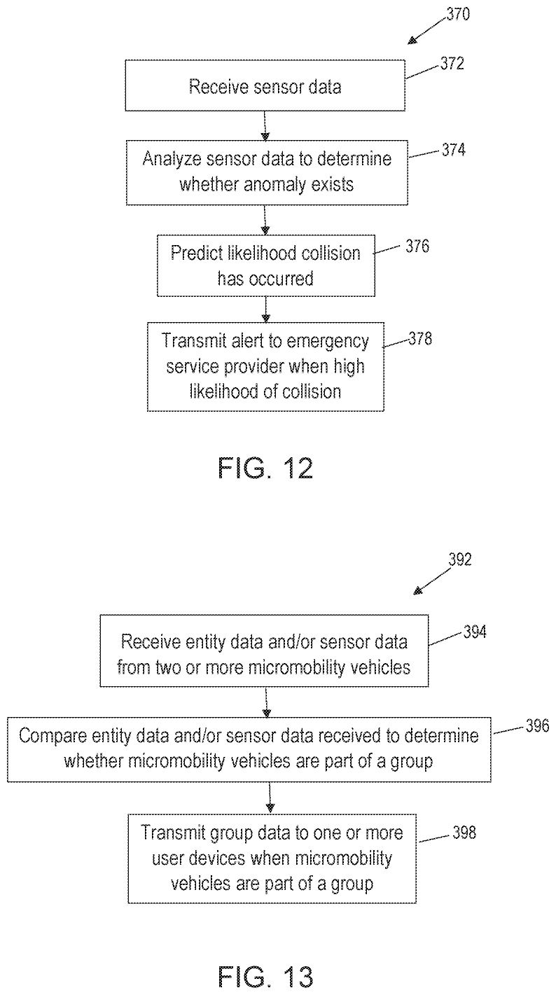

FIG. 11 is a flow chart illustrating a method of generating comprehensive collision-related data. The method 380 begins with operation 382 and real-time collision data is received and stored over time. As discussed above, real-time collision data may be indicative of a near or actual collision and include data on its associated location and time. Real-time collision data may be received from safety devices over time. In some embodiments, real-time collision data may be determined based on anomalies in sensor data, as discussed in more detail below with respect to method 370 of FIG. 12.

After operation 382, the method may proceed to operation 384 and user, entity (e.g., micromobility vehicle), environmental, and/or sensor data associated with the real-time collision data may be received over time. As discussed, a user device may be associated with a safety device. When real-time collision data is received from the safety device, user data and/or entity data from an associated user device may be determined. User data may include, for example, user height, weight, gender, age, rider experience (e.g., how many years riding), clothing color, and the like. Entity data may include, for example, type/identity (e.g., type of micromobility vehicle such as road bike, mountain bike, hybrid bike, electric scooter, electric skateboard, etc., type of automotive vehicle such as car, truck, bus, etc., or pedestrian), make, model, color, size specifications, and the like. The user data and/or entity data may have been previously stored by the system 100 or may be retrieved from local storage on the user device. In some embodiments, the server 108 may transmit a notification to a user to input information after receiving the real-time collision data. For example, the user may be prompted by the application to input clothing color. For example, darker clothing may be linked to higher risk of collision.

As discussed above, one or more sensors 122 may be in communication with a safety device and collect sensor data. The sensor data may be received along with the real-time collision data and the two data sets may be stored in association with each other. It is also contemplated that environmental and/or weather data (e.g., precipitation, humidity, temperature, wind, air quality, and the like) may be received from one or more external databases. For example, the server 108 may retrieve environmental and/or weather data when real-time collision data is received and store the environmental and/or weather data in association with the real-time collision data.

After operation 384, the method 380 may proceed to operation 386 and other entity data is received and stored over time. As discussed above with respect to operation 206 of method 200 of FIG. 7, the server 108 may receive entity data from one or more of a safety device, one or more automotive vehicle connectivity devices 104, one or more user devices 106, and one or more third-party databases or applications. The server 108 may associate received other entity data with the entity type (e.g., bicycle, car, pedestrian).

After operation 386, the method 380 may proceed to operation 388 and high collision risk factors are determined based on the data received and stored over time. For example, the server 108 may determine high-risk collision areas based on trends of location and time in the real-time collision data received over time. As another example, the server 108 may determine high traffic areas based on trends of location and time in the other entity data received over time. The server 108 may determine high traffic areas based on type of entity, e.g., high bicycle traffic areas, high pedestrian traffic areas, high car traffic areas, and the like. As another example, the server 108 may determine high collision risk factors based on trends in the environmental, sensor, user, and/or light mobility vehicle data related to the real-time collision data. For example, the server 108 may determine trends in lighting conditions (e.g., poor), precipitation (e.g., heavy), colored clothing or light mobility vehicles (e.g., dark), user size (e.g., large), light on/off, temperature (e.g., freezing), and the like that are linked to real-time collision data collected over time.

After operation 388, the method may proceed to operation 390 and the high collision risk factors are stored in one or more databases 112 as collision-related data.

FIG. 12 is a flow chart illustrating a method for providing real-time road collision or accident alerts to emergency providers. The method 370 begins with operation 372 and sensor data is received, e.g., by a local processing element (e.g., on a safety device 102 or a user device 106) or a remote processing element (e.g., a server 108). Sensor data may be received from one or more sensors, e.g., the one or more sensors 122 coupled to micromobility vehicle 132, as shown in FIG. 4A, or the one or more sensors 122 coupled to light mobility vehicle 253, as shown in FIG. 4B. As discussed above, the one or more sensors may include an accelerometer, GPS sensor, gyroscope, and the like. The sensor data may include, for example, data related to location/position, motion, speed, acceleration, deceleration, rotation, orientation/heading, nearby objects, and the like.

After operation 372, the method 370 may proceed to operation 374 and the sensor data is analyzed to determine whether one or more anomalies exist. For example, an anomaly in the sensor data may include sudden or unexpected changes in the data (e.g., a rapid deceleration) or abnormal data (e.g., a sideways orientation when the sensor data normally indicates an upright orientation when the micromobility vehicle is in use).

After operation 374, the method 370 may proceed to operation 376 and the system predicts a likelihood that a collision or accident has occurred. For example, the system may associate certain anomalies in the sensor data with a high likelihood of collision. For example, a sideways orientation of a normally upright sensor may be indicative of a high likelihood of collision or accident. As another example, a certain rate of deceleration (e.g., 60 mph to 0 mph in 5 seconds) may be indicative of a high likelihood of collision. In some embodiments, the system may aggregate data from multiple sensors, take into account the number of anomalies, and weigh each anomaly to determine whether the aggregated data is indicative of a high likelihood of collision.

After operation 376, the method 370 may proceed to operation 378 and an alert is transmitted to an emergency service provider when there is a high likelihood of collision or accident. For example, the alert may be a message sent to 911 to send an ambulance to the location of the collision.

FIG. 13 is a flow chart illustrating a method for identifying groups of micromobility vehicles. The method 392 begins with operation 394 and entity data and/or sensor data is received from two or more micromobility vehicles. For example, the entity data and/or sensor data may be received from safety devices 103 and/or sensors 122 coupled to the two or more micromobility vehicles. The entity data and/or sensor data may include data on velocity, location, proximity to one another, time, and the like.

After operation 394, the method 392 may proceed to operation 396 and the entity data and/or sensor data received is compared to determine whether the micromobility vehicles are part of a group. For example, if the velocity and location of the micromobility vehicles are similar, the micromobility vehicles are within a certain proximity to one another, and the micromobility vehicles remain within proximity for a duration of time, the system may determine the micromobility vehicles are moving as a group. Alternatively, if the velocity and/or location of the micromobility vehicles is substantially different, the micromobility vehicles are not within proximity, and/or the micromobility vehicles do not remain within proximity for a duration of time, the system may determine the micromobility vehicles are moving independently of one another.

After operation 396, the method 392 may proceed to operation 398 and group data is transmitted to one or more user devices when it is determined that the micromobility vehicles are part of a group. The group data may include the number, size, location, relative speed, and the like of the micromobility vehicles in the group. For example, the group data may be transmitted to an application on a user device 106, e.g., the safety application discussed above. As one example, the two or more micromobility vehicles may appear as icons on a map on a GUI, e.g., GUI 162a of smartphone 160a in FIG. 6A. The icons may distinguish a group from an individual, e.g., by shape, color, text, etc. In some embodiments, a safety application may receive user input to avoid the group of micromobility vehicles, and the system may recalculate a route to avoid the group and reach the desired destination, e.g., in a similar manner as the alternate route calculated in operation 310 of FIG. 9. In some embodiments, the group data is transmitted to a remote processor or server and transmitted to other user devices connected through the network.

FIG. 15 shows images illustrating exemplary data points received by the system. For example, the image on the left shows a series of points representative of the location of multiple micromobility vehicles 458. The system may determine based on entity data and/or sensor data received from the micromobility vehicles that the micromobility vehicles are within proximity to one another. In some embodiments, the proximity of the micromobility vehicles triggers the system to proceed with method 392 of FIG. 13 to determine whether the micromobility vehicles are moving as a group. In the depicted example, after executing method 392, the system has determined five of the micromobility vehicles are riding as a group 460 and one of the micromobility vehicles is riding as an individual 462 apart from the group. The system may display the group of riders on a GUI of a user device. For example, the display may be similar to the image on the right, showing a map on a GUI with the micromobility vehicles locations represented by icons and the group 462 identified by a different color than that of the individual rider 462 and/or by a circle around the group icons 460.

FIG. 16 is a flow chart illustrating a method for determining safety-related data trends. The method 500 begins with operation 502 and safety-related data is received. The safety-related data may include data related to one or more entities, surroundings, circumstances, environment, settings, events, and/or occurrences in a particular location or area and/or at a particular time or time range. For example, safety-related data may include data related to location, time, collisions and collision risk, object proximity or location, object motion (e.g., path, speed, movement changes, etc. of other entities), road/surface conditions (e.g., elevation changes, turns, surface type, surface state, etc.), road/surface hazards or obstacles (e.g., potholes, cones, bumps, etc.), traffic or congestion, weather (including weather probabilities and expected times of weather events), environment (e.g., altitude, air quality, heat index, humidity, temperature, visibility, etc.), traffic intersections, traffic lights, traffic signs (e.g., speed limit signs, stop signs, warning signs, etc.), laws or ordinances, criminal activity (including locations and time of day), user data (e.g., biometrics, health, age, weight, height, gender, energy exerted, etc.), vehicle data (e.g., type, size, age, condition, etc.), sensory data (e.g., visual, auditory, olfactory, haptic, etc.), and the like.

Safety-related data may be input by a user and/or received from one or more data sources. For example, a user may input user data, vehicle data, detected road hazard data (e.g., a pothole or object on the road), and the like. As an example, safety-related data may be input by a user via a text box or an input button on the GUI of the safety application and/or a button on a safety device. For example, the safety device may have a quick select button to identify a road/surface hazard or other risk. Such a quick select button may be helpful to quickly identify a road/surface hazard for other users.

As another example, safety-related data may be received from one or more sensors. As one example, one or more of object proximity or location data, road/surface conditions, road/surface hazards or obstacles, object motion, and the like may be received from a camera (e.g., visual data). As yet another example, safety-related data may be received from a system database or a third-party database or API. For example, terrain data, such as elevation changes or road/surface type (e.g., gravel, dirt, pavement, etc.) may be received from a third-party database that collects and stores such data (e.g., Iteris). As another example, air quality data may be received from a third-party data source (e.g., BreezoMeter). As yet another example weather data may be received from a third-party weather application or database. In some embodiments, safety-related data, such as entity data and/or collision data, may be received from a safety device, as described above.

After operation 502, the method 500 may proceed to operation 504 and the safety-related data is aggregated over time. For example, related safety-related data collected may be aggregated. For example, safety-related data may be related based on location, time, user, or type of data. For example, motion data at a particular location may be aggregated. As another example, collision data at a particular location and/or time may be aggregated, in combination with one or more of data related to weather, road/surface conditions, visibility, and the like, at the same location and/or time. As yet another example, traffic and congestion data may be aggregated.

After operation 504, the method 500 may proceed to operation 506 and trends in the safety-related data are determined. For example, the same motion may be determined at a particular location (e.g., a majority of bikers slow down at the same spot, a majority of bikers swerve into the lane away from the shoulder at the same spot, etc.). As another example, a high frequency of collisions or near-collisions may be determined at a particular intersection and time of day. As yet another example, a particular location may have frequent traffic at a particular time on certain days of the week. As yet another example, trends in user data may be determined, such as trends in energy output, body temperature, heart rate, and the like at a particular location based on sex, age, weight, and the like (e.g., climb statistics at a particular hill). As an additional example, trends in heart rate may be determined at a particular location (e.g., trends showing a spike in heart rate indicative of a fear response). As yet another example, trends in vehicle performance may be determined (e.g., to assess optimal functionality or malfunctions).

After operation 506, the method 500 may proceed to operation 508 and situations and/or actions are mapped to the trend data. For example, trend data indicating slowing of vehicles not at an intersection may be indicative of a bump on the road. In this example, “bump on road” may be mapped to the trend data and associated with the location associated with the trend data. Alternatively or additionally, the action of “slow down” may be associated with the location associated with the trend data. As another example, trend data indicating swerving of bikers into a lane in the same location may be indicative of a road hazard (e.g., a pothole). In this example “road hazard” may be mapped to the trend data and the associated location. Alternatively or additionally, the action “move left of shoulder” may be mapped to the trend data and the associated location. As another example, the action “prepare for challenge ahead” may be mapped to trend data that indicates increased user activity at a particular location (e.g., location with elevated heart rates, increased body temperatures, etc.). As an additional example, an area of high danger or accidents may be mapped to the location where trends in heart rate data are indicative of a fear response.

After operation 508, the method 500 may proceed to operation 510 and trend data may be stored in a database. Such data may be useful for understanding a comprehensive landscape of danger zones and safety risks, which can provide guidance to authorities, such as the Department of Transportation, for example, on how to improve the infrastructure and take preventative measures to reduce such risks.

The trend data may be used by the safety system 100 to anticipate certain situations. As an example, if a road hazard is mapped to a particular location and the trend data indicates cyclists swerving into the lane to avoid the road hazard, then the system 100 anticipates that a cyclist approaching that road hazard will swerve into the lane. If a vehicle is approaching the cyclist at a particular distance and speed, the system 100 may determine that the vehicle will pass the cyclist as the cyclist reaches the road hazard and anticipates the cyclist will swerve into the road and collide with the vehicle. In this example, the system 100 may send an alert or notification to the vehicle to slow down or not pass the cyclist.

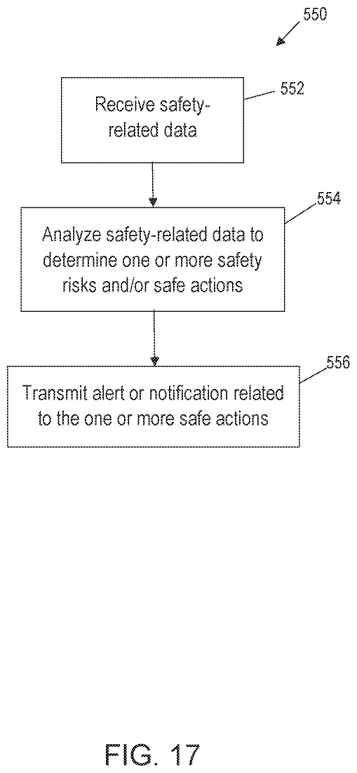

FIG. 17 is a flow chart illustrating a method of providing real-time safety-related solutions. The method 550 begins with operation 552 and safety-related data may be received. As discussed above with respect to FIG. 16, safety-related data may be input by a user and/or received from one or more data sources, including, for example, one or more safety devices, one or more sensors, one or more system or internal databases, and one or more third-party databases. Safety-related data may include trend data received from the system database, e.g., trend data stored at operation 510 of method 500 of FIG. 16. For example, trend data may be related to collisions, traffic, road/surface hazards or obstacles, speed, road/surface conditions, vehicle condition, and the like. For example, the trend data may be indicative of an area with high collision probability (e.g., based on frequent actual or near collisions), an area with a road hazard, or the like. As another example, trend data may have more detailed or complex implications, such as indicating a stretch of road where vehicles of a certain type have an average speed of X mph based on a particular weight or weight range, and the like.

After operation 552, the method 550 may proceed to operation 554 and safety-related data may be analyzed to determine one or more safety risks and/or safe actions. The one or more safety risks may include high collision probabilities or areas with higher risk of danger, such as, for example, areas with construction, road/surface hazards, high traffic, high collision risk, high crime rates, changes in road/surface conditions (e.g., road grade changes), and the like. As one example, the safety-related data may include entity data from two or more entities. The entity data may be analyzed to determine whether the trajectories or paths of the two or more entities are likely to conflict or intersect causing a collision. Based on other relevant safety-related data, the processing element may estimate a trajectory or change in trajectory of one or more of the entities. For example, if there is a pothole on the side of the road, the processing element may predict that a cyclist will swerve into the lane. The processing element may determine that the location where the cyclist is likely to swerve will intersect a car's trajectory and determine a collision risk exists. The processing element may determine a safe action for the car is to not pass the cyclist.

Analyzing the safety-related data may incorporate time of day. For example, construction in an area may occur from 9 AM to 5 PM, so after 5 PM the safety risk may be reduced, and the area may be safe to travel through. As another example, crime in an area may increase after 8 PM, and the system may determine the area is safe prior to 8 PM and at high risk of danger after 8 PM. The system may predict the likelihood of a safety risk based on the presence of one or more variables in the safety-related data received. As one example, the system may predict the road is likely to be slippery in a particular area based on safety-related data related to a rapid change in elevation, a high probability of a microburst of rain, and an unpaved road surface.

The one or more safety risks may be user-specific based on user data received. For example, the system may account for a user's health data to determine the degree of risk to a user. As one example, a user with asthma may be more sensitive to poor air quality and the system may determine based on the air quality index and the user's health that it is not an optimal time for the user to go for a bike ride. The system may determine the safest time of day for a user to travel based on safety-related data (e.g., AQI, heat index, weather, etc.) and user health data.

Certain safety-related data received may be analyzed to determine certain safe actions to reduce, prevent, or avoid danger and harm to oneself or to others. For example, certain safety-related data may be analyzed together to determine one or more safe actions. For example if variables x, y, and z are present, then the system may determine action A should be taken. For example, if the system receives data indicating the type of vehicle is a bicycle, the road ahead is slick, and the road grade is 10%, the system may determine the bicyclist should slow down (either generally or by a certain amount of speed). As another example, if the system receives data that a bicycle is ahead, the road grade 0.2 miles ahead increases by 10%, and the road narrows, the system may determine the driver should wait to pass since the bicyclist's speed will increase with the increased road grade and the narrow road increases the risk of accident. As yet another example, if the system receives data that a bicyclist is next to or approaching a car, and the bicyclist's route is straight and the car's route includes a right turn, the system may determine the driver should wait to turn until the bicyclist passes. Such processes may be automated or autonomous processes that are triggered upon receiving the certain safety-related data (e.g., when particular variables are present).

In several embodiments, the data analyzed is relevant to the context. For example, the system may identify which data received is relevant to a particular context and organize, aggregate, and/or analyze the relevant data. For example, data may be considered relevant based on location and/or time. As one example, if entity data is received from an entity (e.g., from a safety device), the system may determine intersection data is relevant that is in the same location and on the entity's path, and the system may analyze the intersection data to determine whether there are any associated safety risks (e.g., a high collision probability at the intersection). As another example, data may be associated based on similarity in data. For example, ordinance data related to proximity of entities may be associated with proximity data. For example, if the system receives data related to an ordinance that dictates a vehicle must maintain a particular distance from a bicyclist or pedestrian, the system may analyze the ordinance data and proximity data (e.g., entity data) to determine whether a car is too close to a VRU, in violation of the ordinance. For example, if the ordinance dictates that drivers should remain 3 feet from a bicyclist and the car is 2 feet from the bicyclist, the system will determine the car is in violation of the ordinance.

In some embodiments, vehicle condition may be considered when assessing safety risks and/or actions. The vehicle condition may be determined based on stored historical data on past vehicle usage. As an example, if the system determines the brakes are functioning at 75% performance and the road conditions are wet, the system may determine the optimal ride time for safe brake performance is later in the day when the roads are expected to be dry. As another example, the system may determine a vehicle requires maintenance prior to use.

After operation 554, the method 550 may proceed to operation 556 and an alert or notification may be transmitted related to the one or more safety risks and/or safe actions. For example, the alert or notification may relay safety information related to the one or more safety risks. For example, the safety information may include safe routes, dangerous areas (e.g., due to construction, traffic, accidents, road closures, crime, etc.), object proximity (e.g., distance to other vehicles, to VRUs, to sidewalk, to shoulder, etc.), road/surface conditions (e.g., pot holes, shoulder conditions or changes, lane changes, merging lanes, bumps, paved vs. unpaved, incline or decline angle, elevation, etc.), obstacle detection (e.g., broken glass, construction cones, roadkill, or other objects), safety predictions (e.g., road may become slippery based on analysis of safety risk data), time data (e.g., when a weather event is to occur, when to expect traffic, timing until encounter obstacle, etc.), and the like. It is contemplated that the safety information may be mapped onto a map layer of the safety application or a third-party application (e.g., via an API) to provide a location on a map displayed on a GUI of a user device of the safety-related data (e.g., location of elevation change, of predicted weather, of altitude change, of a wet surface, of a high crime area, of a road hazard, and the like).

The alert or notification may be similar to the alert described with respect to operation 210 of method 200. For example, the alert may be visual, haptic, or audible feedback and may be varied based on the type of safety information being relayed and/or the level of risk/danger.

The alert or notification may indicate one or more safe actions. For example, the one or more safe actions may include motion transitions (e.g., pass other vehicle, slow down, accelerate, etc.), time data (e.g., when to pass another vehicle, when to brake, when to accelerate, when traffic light expected to change, etc.), directional references (e.g., look left, look right, turn left, etc.), attention alerts (e.g., to watch out for bump ahead, to pay attention at a particular intersection, e.g., where there is a high collision probability based on collision trend data, etc.), and the like.

It is contemplated that the system may transmit the safety-related data received. For example, if an object is determined to be within proximity to a user based on sensor data received (e.g., from a camera), the system may transmit the sensor data (e.g., the camera image). For example, the system may transmit a camera image or video stream to an application on a user device showing the surrounding environment and any associated safety risks, e.g., as discussed above with respect to FIG. 6G. As another example, sensor data received from a sensor associated with one vehicle may be transmitted to another user device. For example, a camera coupled to a micromobility vehicle of a first user may capture data of certain road/surface conditions or a road/surface hazard or obstacle, which may be transmitted to another user's user device (e.g., as a video image overlayed on a safety application interface of the user device, e.g., as shown in FIG. 6G). As another example, a user may input data regarding an obstacle on the shoulder into a user device, which may be transmitted, along with location data, to other user devices to alert other users of the obstacle. As another example, the system may layer safety-related data received from a third-party database or API onto a map displayed on a safety application interface, as described above. For example, the system may layer elevation data (e.g., received from Mapbox API), collision data, road/surface condition data, obstacle data (e.g., received from other users), and the like, onto the map displayed on the safety application interface. Alternatively, the system may transmit the safety-related data to a third-party application to display on the third-party application interface (e.g., via an API).

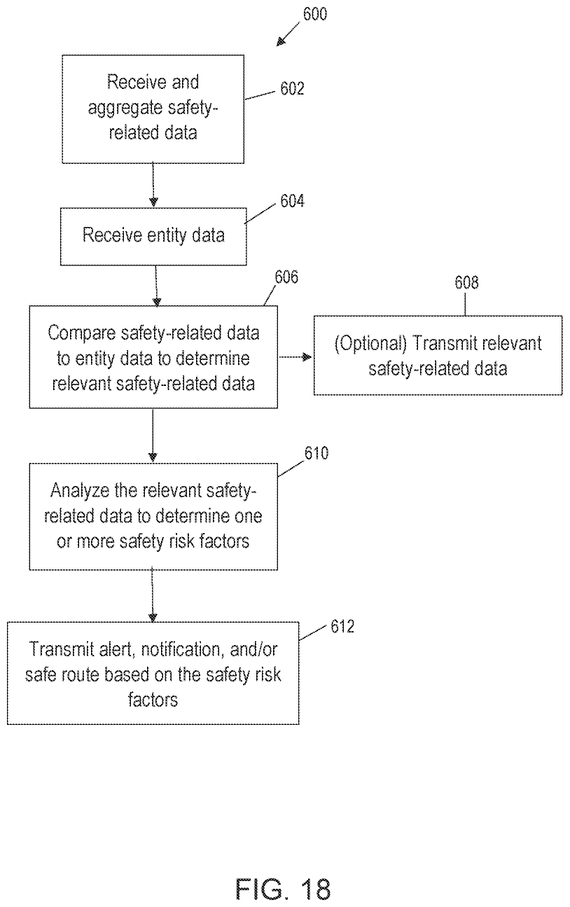

FIG. 18 is a flow chart illustrating a method of leveraging relevant safety-related data from one or more disparate data sources to provide comprehensive movement and travel safety for a user. The method 600 begins with operation 602 and safety-related data is received and aggregated. Safety-related data may be received as discussed above with respect to FIGS. 16 and 17.

After operation 602, the method 600 proceeds to operation 604 and entity data may be received. Entity data may be received from a user device or safety device described herein. As discussed, the entity data may be indicative of the entity's type/identity, motion, speed, acceleration, direction, path/route, and the like.

After operation 604, the method 600 may proceed to operation 606 and the safety-related data may be compared to the entity data to determine relevant, related, or applicable safety-related data. The safety-related data may be relevant, related, or applicable to the entity data based on shared characteristics or traits in the data. For example, the safety-related data may be related to the entity data based on associated location data that matches or is proximate to the location of the entity. As an example, safety-related data may be relevant if the location associated with the safety-related data is on or near the entity's route. For example, the location or presence of a road hazard such as a pothole that is located on the entity's scheduled route would be relevant safety-related data.

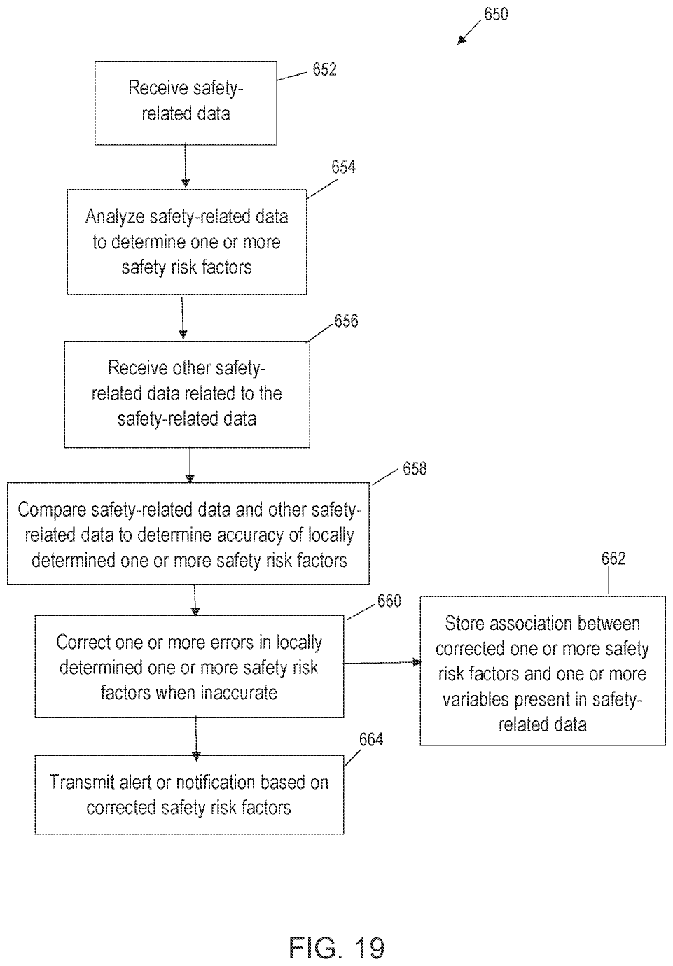

After operation 606, the method 600 may optionally proceed to operation 608 and the relevant safety-related data may be transmitted to the safety device or user device for further processing. For example, the relevant safety-related data may be transmitted to a local processing element of the safety device, and the local processing element may use the relevant safety-related data to determine one or more risk factors and/or correct errors in locally determined risks, as discussed in more detail below with respect to FIG. 19. The local processing element may receive entity data from one or more other entities (e.g., via a connectivity module associated with the safety device) and aggregate the relevant safety-related data with the entity data to determine one or more risk factors.

Alternatively or additionally, after operation 606, the method 600 may proceed to operation 610 and the relevant safety-related data may be analyzed to determine one or more safety risks or risk factors. For example, the analysis of the relevant safety-related data may be similar to that discussed above with respect to operation 554 of method 550. For example, the one or more safety risks may include areas with higher risk of danger (e.g., construction, high traffic, high collision risk, high crime rates, etc.), collision risk, road/surface hazards, changes in road/surface conditions (e.g., road grade changes), bad weather conditions (e.g., rain, sleet, fog, etc.), and the like.

After operation 610, the method 600 may proceed to operation 612 and an alert, notification, and/or safe route may be transmitted based on the safety risk factors. The alert or notification may be similar to the alerts or notifications described with respect to operation 210 of method 200 and operation 556 of method 550. The safe route may be determined in a similar manner as that determined in method 250 of FIG. 8.

FIG. 19 is a flow chart illustrating a method of improving accuracy of locally determined safety risk factors. The method 650 begins with operation 652 and safety-related data may be received by a local processing element. For example, the local processing element may be a component of a safety device or another connectivity device, such as, for example, an automotive vehicle connectivity device. The safety-related data may be received from a safety device (e.g., via CV-2X data) or connectivity device (e.g., via cellular data) or from one or more sensors in communication with the local processing element. For example, the safety-related data may include object data (e.g., entity data), sensor data, and the like.

After operation 652, the method 650 may proceed to operation 654 and the safety-related data may be analyzed to determine one or more safety risk factors. For example, entity data may be analyzed to determine collision risk with one or more other entities or objects. As another example, if sensor data is received, the sensor data may be analyzed to determine whether one or more variables are present that are indicative of one or more safety risks or safety risk factors. For example, image data may be analyzed to determine the type of an oncoming vehicle, e.g., a truck versus a car or bicycle, which may be a variable that factors into collision risk. In this example, the local processing element may determine one or more safety risks are present based on stored prior learned associations between the presence of one or more variables and one or more safety risks.

After operation 654, the method 650 may proceed to operation 656 and other safety-related data may be received that is related to the safety-related data. For example, the other safety-related data may be related to the safety-related data based on similar location data, time data, type of data (e.g., both data sets related to entity type), and the like, as discussed in more detail above. The system may determine data is related in a similar manner as discussed above with respect to method 600 of FIG. 18.

The other safety-related data may be received from one or more disparate or distinct data sources, as discussed in more detail above. For example, the other safety-related data may be received from one or more safety devices, one or more system databases (e.g., trend data collected and stored overtime), one or more third-party databases (e.g., DOT, weather, infrastructure, elevation, crime, etc. databases) or software applications (e.g., fitness or navigational software applications), user devices, and the like.

After operation 656, the method 650 may proceed to operation 658 and the safety-related data and the other safety-related data may be compared to determine the accuracy of the locally determined one or more safety risk factors. The locally determined one or more safety risk factors may be considered inaccurate when they deviate from the other safety-related data. For example, if the local processing element determines a nearby object is a truck based on image analysis of image data (e.g., from a camera), but the other safety-related data received indicates the same object (e.g., in the same location) is a bicycle (e.g., due to entity data received from a safety device coupled to the bicycle that identifies the object as a bicycle), the local processing element may determine the locally determined safety risk factor (i.e., object is a truck) is inaccurate based on the deviation.

After operation 658, the method 650 may proceed to operation 660 and one or more errors in the locally determined one or more safety risks may be corrected when the one or more safety risk factors are inaccurate. In the above example, the local processing element may correct the error in the identity of the object and label the object a bicycle based on the other safety-related data received.

After operation 660, the method 650 may proceed to operation 662 and the corrected one or more safety risk factors may be stored in association with the one or more variables present in the safety-related data. In some embodiments, the new association between the corrected one or more safety risk factors and the one or more variables may replace the prior learned association between the inaccurate one or more safety risk factors and the one or more variables (or the prior association may otherwise be adjusted). In the above example, the local processing element may replace or adjust the prior learned association between the variables present in the safety-related data (e.g., image-related data/nodes) and the identity of a truck with or to an association between the same variables and the identity of a bicycle. In this manner, a safety system disclosed herein, by aggregating disparate types or large amounts of external or other safety-related data, may improve machine learning or artificial intelligence algorithms by correcting inaccuracies in prior learned associations.

After operation 660, the method 650 may proceed to operation 664 and an alert, notification, and/or safe route may be transmitted based on the corrected one or more safety risk factors. The alert or notification may be similar to the alerts or notifications described with respect to operation 210 of method 200 and operation 556 of method 550. The safe route may be determined in a similar manner as that determined in method 250 of FIG. 8.

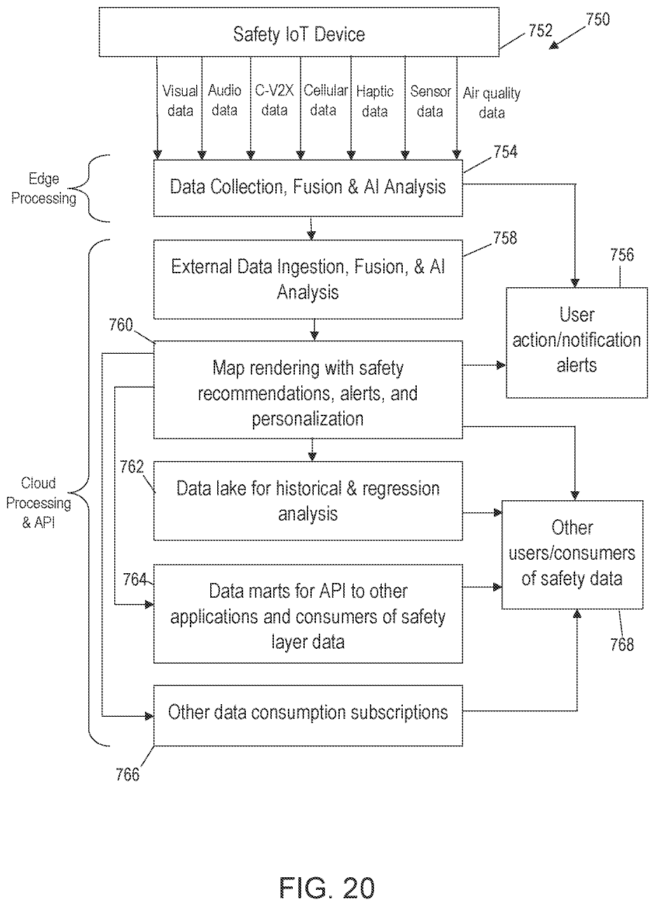

FIG. 20 is a flow chart or diagram showing data flow through a safety system 750. As shown, the safety system 750 includes a safety device 752. The safety device 752 may detect safety-related data. The safety-related data may be sentient-related data, such as visual data, audio data, haptic data, and/or olfactory data (e.g., air quality data). As discussed in more detail above, such data may be collected by one or more sensors associated with the safety device (e.g., camera, microphone, etc.). The safety-related data may include C-V2X data (e.g., entity data or object data), cellular data (e.g., received from a cellular modem), and sensor data. The safety-related data may be processed at the edge (e.g., by a local processing element). For example, a local processing element may execute step 754, and the safety-related data may be collected from the safety device 752, fused or aggregated, and analyzed. For example, the local processing element may apply an artificial intelligence (AI) algorithm to the safety-related data to assess patterns in the data and generate certain associations and/or actions. Such edge processing may be beneficial to produce an immediate action and avoid the latency associated with cloud processing. After step 754, the local processing element may transmit a user action or notification alert based on the data analysis.

The safety-related data or edge-processed safety-related data (e.g., data fused or analyzed by the local processing element) may be transmitted to the cloud for processing (or further processing). For example, the cloud or remote processing element may combine the safety-related data or edge-processed data with other external data that is ingested, fused or aggregated, and analyzed at step 758. External data may include data from third party databases (e.g., navigational applications, Departments of Transportation, weather, and the like), as discussed in more detail above. The remote processing element may apply an AI algorithm to the data (e.g., safety-related data, edge-processed data, aggregated data, or the like) to assess patterns in the data and generate certain associations and/or actions. At step 760, the remote processing element may render the remote processed data for display on a map interface (e.g., of a safety application described herein or a third-party navigational application), including, for example, safety recommendations, alerts, and personalization (e.g., based on user preferences or user data such as age). At step 762, the remote processing element may store the remote processed data in a data lake for historical and regression analysis. At step 764, the remote processing element may store the remote processed data in data marts for API to other applications that utilize safety-related data. At step 766, the remote processed data can be organized, aggregated, stored, or otherwise packaged for consumers and monetization.

At step 768, the various data used and processed by the safety system 750, as described above, may be organized, aggregated, or otherwise packaged for other users and consumers of safety data. For example, such safety-related data may be valuable to a Department of Transportation (e.g., for understanding accidents, intersection safety, traffic patterns, or the like), Parks and Recreation Department (e.g., for trail maintenance), or an insurance company.

By receiving data from various data sources, including, for example, IoT-integrated light mobility vehicles (or VRUs, generally) and third-party applications, systems and methods described herein aggregate unique data otherwise unavailable to a single system that can be utilized to provide real-time, safety-related feedback related to movement and travel safety. The unique combination of data allows disclosed systems and methods to provide more comprehensive safety-related feedback than current systems and methods. As one example, the system may receive input from a safety device of a car's location relative to a micromobility vehicle's location while simultaneously receiving data related to the road conditions ahead, which can be aggregated and analyzed to determine whether the car can safely pass the micromobility vehicle. In several embodiments, disclosed systems and methods leverage larger quantities of data than current systems to provide a more exhaustive landscape of contextual and safety-related information and safety risks. In several embodiments, disclosed systems, devices, and methods connect users to everything, including other users and infrastructure, increasing the scope of contextual and safety awareness.

In some embodiments, safety systems, devices, and methods track safety-related data over time. For example, safety-related data may be tracked over the course of a user's route (e.g., a bike ride). The system may provide the tracked safety-related data to a user device as a safety report. The safety report may include data related to risks avoided (e.g., near collisions or avoided collisions, etc.), safe user behaviors/motions (e.g., optimal speed through intersections, maintaining proper distance from others, etc.), risky user behaviors/motions (e.g., sudden lane transfers, too close to others, etc.), use of safety features (e.g., whether light was used with unsafe visibility conditions, etc.), and the like.

In some embodiments, safety systems, devices, and methods track safety-related data over time and provide user-specific and/or context-specific feedback to optimize user performance. For example, the system may track different variables associated with users turning at the same intersection and determine optimal variables for optimal performance through the turn. For example, the system may determine multiple users fall when turning above a threshold speed and based on a particular weight of the user. In this example, the system may determine an optimal speed for a user based on the user's weight to efficiently make the turn.

In some embodiments, the safety-related data tracked may be specific to the user. For example, the system may track biometrics (e.g., heart rate, temperature, etc.) associated with different movements to determine optimal motion for the user based on desired biometrics (e.g., target heart range). As another example, the system may receive motion data (e.g., from a camera) and determine whether the motion is optimal (e.g., limiting strain on joints, optimizing power output, etc.) based on user data (e.g., user height, weight, sex, health, etc.). For example, the system may determine optimal motion based on health data received from a database (e.g., a medical science journal database). The system may factor in vehicle data (e.g., seat height) and determine vehicle adjustments to optimize performance based on the received motion data.

As an example, the motion data received may show how the user's legs move when pedaling. The system may determine unnecessary strain is being imposed on the user's joints based on the legs over-extending beyond an optimal angle (e.g., based on other data received related to optimal motion for reduced joint stress). In this example, the system may determine the user needs to lower the seat based on the user's legs over-extending. The system may also learn optimal user motion and/or seat positioning based on height from user feedback over time related to comfort level of the ride experience. The system may learn how to correct a user's movement to reduce joint stress and provide feedback to the user.

In some embodiments, safety systems, devices, and methods track safety-related data over time to determine vehicle usage, state, and/or performance. For example, the system may determine the amount of time a bicycle has been in use. The system may track the vehicle's performance over time based on the safety-related data received. For example, the system may determine the vehicle takes more user power to get to a particular speed than required when the vehicle was new. The system may determine the vehicle takes longer to come to a complete stop than similar vehicles (e.g., of same type, model, and year), which may indicate a brake issue. The system may store the vehicle lifecycle data in a system database.

FIG. 35 is a flow chart illustrating a method of tracking vehicle usage to estimate equipment failure, e.g., for predictive maintenance. The method 1050 may begin with operation 1052 and vehicle usage and movement data is received over time. For example, vehicle usage and movement data may be received by a remote processing element from a user device, safety device, and/or sensors described herein. As an example, a disclosed safety device may begin tracking vehicle usage upon activation (e.g., by motion activation or user activation) until the vehicle is no longer in motion or use and the safety device is deactivated or turned off. The safety device may track the number of times and length of time the vehicle is in use. The safety device and/or sensors may track movement, such as bumps, skidding, acceleration, deceleration, sudden stops/hard braking, and the like. After operation 1052, the method 1050 may proceed to operation 1054 and the remote processing element may predict a vehicle condition based on the usage and movement data. For example, the remote processing element may compare the usage data to stored manufacturer data on expected part replacement timeframes based on usage. As another example, the remote processing element may determine trends in prior usage and movement data received to determine typical timeframes for equipment failure or certain movements that increase the risk of equipment failure. After operation 1054, the method 1050 may proceed to operation 1056 and the remote processing element may transmit a maintenance notification (e.g., to a user device). The maintenance notification may provide an estimated time until repair or replacement of parts is needed or a notification that repair or part replacement is needed prior to additional vehicle usage. Such data may be useful to both cyclists, manufacturers, and service providers.

A simplified block structure for computing devices that may be used with the system 100 or integrated into one or more of the system 100 components is shown in FIG. 36. For example, the safety device(s) 102, automotive vehicle connectivity device(s), user device(s) 106, and/or server(s) 108 may include one or more of the components shown in FIG. 36 and be used to execute one or more of the operations disclosed in methods 200, 250, 300, 350, 380, 370, 392, 500, 550, 600, 650, and 1050. With reference to FIG. 36, the computing device 400 may include one or more processing elements 402, an input/output interface 404, feedback components 406, one or more memory components 408, a network interface 410, one or more external devices 412, and a power source 416. Each of the various components may be in communication with one another through one or more busses, wireless means, or the like.

The local processing element 402 is any type of electronic device capable of processing, receiving, and/or transmitting instructions. For example, the local processing element 402 may be a central processing unit, microprocessor, processor, or microcontroller. Additionally, it should be noted that select components of the computing device 400 may be controlled by a first processor and other components may be controlled by a second processor, where the first and second processors may or may not be in communication with each other.

The one or more memory components 408 are used by the computing device 400 to store instructions for the local processing element 402, as well as store data, such as the entity data, third-party database entity data, light mobility vehicle data, user data, environmental data, collision-related data, and the like. The one or more memory components 408 may be, for example, magneto-optical storage, read-only memory, random access memory, erasable programmable memory, flash memory, or a combination of one or more types of memory components.

The one or more feedback components 406 provide visual, haptic, and/or auditory feedback to a user. For example, the one or more feedback components may include a display that provides visual feedback to a user and, optionally, can act as an input element to enable a user to control, manipulate, and calibrate various components of the computing device 400. The display may be a liquid crystal display, plasma display, organic light-emitting diode display, and/or cathode ray tube display. In embodiments where the display is used as an input, the display may include one or more touch or input sensors, such as capacitive touch sensors, resistive grid, or the like. As another example, the one or more feedback components 406 may include a light (e.g., LED), an alarm or alert sound, a vibration, and the like.

The I/O interface 404 allows a user to enter data into the computing device 400, as well as provides an input/output for the computing device 400 to communicate with other devices (e.g., the safety device 102, one or more servers 108, other computers, etc.). The I/O interface 404 can include one or more input buttons or switches, remote controls, touch pads or screens, microphones, and so on. As an example, the I/O interface 404 may be one or both of a capacitive or resistive touchscreen.

The network interface 410 provides communication to and from the computing device 400 to other devices. For example, the network interface 410 allows the one or more servers 108 to communicate with the one or more user devices 106 through the network 110. The network interface 410 includes one or more communication protocols, such as, but not limited to Wi-Fi, Ethernet, Bluetooth, Zigbee, and so on. The network interface 410 may also include one or more hardwired components, such as a Universal Serial Bus (USB) cable, or the like. The configuration of the network interface 410 depends on the types of communication desired and may be modified to communicate via Wi-Fi, Bluetooth, and so on.

The external devices 412 are one or more devices that can be used to provide various inputs to the computing device 400, e.g., mouse, microphone, keyboard, trackpad, or the like. The external devices 412 may be local or remote and may vary as desired.

The power source 416 is used to provide power to the computing device 400, e.g., battery (e.g., graphene/zinc hybrid), solar panel, lithium, kinetic (e.g., energy harvested from a bicycle) or the like. In some embodiments, the power source 416 is rechargeable; for example, contact and contactless recharge capabilities are contemplated. In some embodiments, the power source 416 is a constant power management feed. In other embodiments, the power source 416 is intermittent (e.g., controlled by a power switch or activated by an external signal). The power source 416 may include an auxiliary power source.

While various of the above embodiments and examples depict a safety device coupled to a bicycle, these embodiments and examples are meant to be illustrative of an exemplary use of the safety device with a light mobility vehicle. However, other uses or applications are contemplated as described herein. For example, safety devices, systems, and methods described herein can be applicable to other micromobility vehicles, as described herein, which include, but are not limited to scooters, unicycles, tricycles, quadricycles, electric bicycles, scooters, electric scooters, skateboards, electric skateboards, or the like. As another example, safety devices, systems, and methods described herein can be applicable to other light mobility vehicles, which include, but are not limited to motorcycles, e-motorcycles, two wheelers, three wheelers, four wheelers, ATVs, mopeds, light electric vehicles, and the like. For example, a safety device described herein may couple to a component or system of a light mobility vehicle or may be positioned in a storage compartment of the light mobility vehicle (e.g., under a seat, in side compartments, in a bento box or basket, etc.). The safety device may be in communication with integrated sensors and/or a user interface or HMI of the light mobility vehicle to receive sensor data and transmit feedback to a user. The safety device may transmit data to a user device in communication with the safety device and held by a user of a light mobility vehicle or coupled to the light mobility vehicle (e.g., a dedicated user device described herein).

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated and may include electrical or wireless connection. As such, connection references do not necessarily infer that two elements are directly connected and/or in fixed relation to each other. The exemplary drawings are for purposes of illustration only and the dimensions, positions, order and relative sizes reflected in the drawings attached hereto may vary.

While certain orders of operations are provided for methods disclosed herein, it is contemplated that the operations may be performed in any order and that operations can be omitted, unless specified otherwise.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A safety device for a light mobility vehicle, comprising:
a housing configured to couple to the light mobility vehicle;
a connectivity module positioned within the housing, the connectivity module comprising:
a first connectivity device configured to:
receive first entity data from one or more first compatible connectivity devices compatible with the first connectivity device, wherein the one or more first compatible connectivity devices is associated with one or more first entities, and
transmit outgoing entity data related to the light mobility vehicle to the one or more first compatible connectivity devices; and
a processing element positioned within the housing and in communication with the connectivity module, the processing element configured to:
determine one or more locations of the one or more first compatible connectivity devices relative to the light mobility vehicle and one or more first entity trajectories based on the received first entity data,
determine whether any of the one or more first entity trajectories conflict with a trajectory of the light mobility vehicle based on the received first entity data and the outgoing entity data, and
if a first entity trajectory conflict is determined, then transmit a first alert detectable by a user of the light mobility vehicle that is indicative of the first entity trajectory conflicts.

2. The safety device of claim 1, wherein the connectivity module further comprises a second connectivity device configured to:
receive second entity data from one or more second compatible connectivity devices compatible with the second connectivity device, wherein the one or more second compatible connectivity devices is associated with one or more second entities; and
transmit the outgoing entity data related to the light mobility vehicle to the one or more second compatible connectivity devices;
wherein the processing element is further configured to:
determine one or more locations of the one or more second compatible connectivity devices relative to the light mobility vehicle and one or more second entity trajectories based on the received second entity data,
determine whether any of the one or more second entity trajectories conflict with a trajectory of the light mobility vehicle based on the received second entity data and the outgoing entity data, and
if a second entity trajectory conflict is determined, then transmit a second alert detectable by the user that is indicative of the second entity trajectory conflicts are determined.

3. The safety device of claim 1, wherein the first connectivity device is a V2X chipset.

4. The safety device of claim 1, wherein the first connectivity device is a cellular modem.

5. The safety device of claim 2, wherein the first connectivity device is a C-V2X modem and the second connectivity device is a cellular modem.

6.-15. (canceled)

16. The safety device of claim 1, wherein the first alert is indicative of a direction of the first entity trajectory conflict.

17. (canceled)

18. The safety device of claim 1, wherein the processing element is in communication with a second connectivity device, wherein the processing element is configured to receive safety-related data from one or more disparate data sources via the second connectivity device, and wherein at least one disparate data source of the one or more disparate data sources is outside a communication range of the first connectivity device.

19.-36. (canceled)

37. A method of providing real-time safety solutions for a traveler, comprising:
receiving, by a processing element, safety-related data from one or more data sources, wherein the safety-related data is associated with an area and time and wherein the one or more data sources comprise:
a safety device coupled to a light mobility vehicle, wherein the safety device comprises:
a connectivity device configured to receive entity data from a nearby entity within a short-distance communication range, and
a sensor configured to determine entity data of the light mobility vehicle,
wherein the connectivity device and sensor are in communication with the processing element;
analyzing, by the processing element, the safety-related data to determine one or more safety risks; and
transmitting, by the processing element, an alert or message detectable by the traveler that is related to the one or more safety risks.

38.-60. (canceled)

61. A safety system for a light mobility vehicle user, comprising:
one or more feedback components configured to provide feedback that is detectable by the light mobility vehicle user;
a safety device coupled to a light mobility vehicle and in communication with the one or more feedback components, the safety device comprising:
a first connectivity device configured to transmit first entity data of the light mobility vehicle and receive second entity data from a second entity, and
a local processing element in communication with the first connectivity device and configured to:
receive the first and second entity data,
analyze the first and second entity data to determine whether a first safety risk exists, and
transmit an alert related to the first safety risk to the one or more feedback components when the first safety risk exists; and
a sensor device coupled to the light mobility vehicle and in communication with the one or more feedback components and with the local processing element, the sensor device comprising one or more sensors configured to detect local safety-related data and to transmit the local safety-related data to the one or more feedback components or to the local processing element.

62. The micromobility vehicle-safety system of claim 61, further comprising a dedicated user device is coupled to the light mobility vehicle and in communication with the safety device and the sensor device, wherein the one or more feedback components are coupled to the dedicated user device, and wherein the dedicated user device mitigates interference from other software applications that can interfere with transmission of safety messages.

63. (canceled)

64. The safety system of claim 61, wherein the one or more feedback components comprise a display with capacitive and resistive touch features, and wherein the alert overrides a graphical user interface of a third-party application.

65. (canceled)

66. The safety system of claim 61, wherein the one or more sensors comprise a camera and the safety-related data transmitted to the one or more feedback components is streaming video data of an environment around the light mobility vehicle.

67. The safety system of claim 61, wherein the one or more feedback components comprise a light.

68.-72. (canceled)

73. The method of claim 37, wherein the one or more data sources further comprise one or more disparate data sources, and the one or more disparate data sources comprise at least one disparate data source that is outside the short-distance communication range of the connectivity device.

74. The method of claim 73, wherein the one or more disparate data sources comprise one or more third-party databases storing data related to one or more of weather, road conditions, environment, and traffic.

75. The method of claim 73, wherein analyzing the safety-related data to determine one or more safety risks comprises comparing the entity data received from the nearby entity to the entity data of the light mobility vehicle to determine a first safety risk associated with a first area and a first time, and analyzing safety-related data received from the one or more disparate data sources to determine a second safety risk associated with a second area and a second time, and wherein the method further comprises:
comparing the first safety risk and the second safety risk when the first area is similar to the second area and the first time is similar to the second time to determine accuracy of the first safety risk; and
correcting errors in the analysis of the first safety risk when the first safety risk is inaccurate.

76. The method of claim 37, wherein the safety-related data further comprises user data and wherein the alert is a safe route displayed on a map that avoids the one or more safety risks and is personalized based on the user data.

77. The method of claim 37, further comprising analyzing the safety-related data and the one or more safety risks to determine one or more safe actions, wherein the one or more safe actions relate to the traveler's movement relative to the one or more safety risks, and wherein the alert or message is related to the one or more safe actions.

78. The safety system of claim 61, further comprising a server in communication with the safety device, wherein the server is configured to:
receive the first entity data from the safety device,
receive remote safety-related data from one or more disparate data sources, wherein the remote safety-related data comprises safety-related data outside a short-distance range detectable by the first connectivity device or the one or more sensors;
compare the first entity data to the safety-related data to determine relevant remote safety-related data, and
transmit the relevant remote safety-related data to the safety device, wherein the local processing element is further configured to analyze the relevant remote safety-related data to determine whether a second safety risk exists or to assess the accuracy of the first safety risk determination.

79. The safety system of claim 61, further comprising a server in communication with the safety device and one or more databases in communication with the server, wherein the local processing element is further configured to transmit real-time safety-related data to the server for storage in the one or more databases when a high safety risk exists.

80. The safety system of claim 79, wherein the high safety risk is a high collision probability that is indicative of an actual or near collision and the real-time safety-related data comprises an actual or near collision location and time.

81. The safety system of claim 79, further comprising a user device that is in communication with the server and the safety device, and wherein the server is further configured to:
receive, from an application on the user device, light mobility vehicle data and user data;
receive, from a third-party database, environmental data; and
aggregate the real-time safety-related data, light mobility vehicle data, user data, and environmental data into stored remote safety-related data.

82. The safety system of claim 78, wherein the server is further configured to:
receive real-time safety-related data from one or more safety devices in communication with the server when one or more high safety risks exist;
store real-time safety-related data received over time;
determine one or more high safety risk areas based on trends in the stored real-time safety-related; and
transmit information related to the one or more high safety risk areas to the local processing element or to the one or more feedback components.

83. The safety system of claim 78, wherein the one or more disparate data sources comprise one or more third-party fitness or navigational applications of one or more user devices in communication with the server.

84. The safety system of claim 61, wherein the one or more sensors comprise radar.
